(19) United States
(12) Patent Application Publication
(10) Pub. No.: US 2022/0398538 A1
(43) Pub. Date: Dec. 15, 2022

(54) Systems and Methods for Blockchain-Based Collaborative Content Generation

(71) Applicant: Artema Labs, Inc, Los Angeles, CA (US)

(72) Inventors: Bjorn Markus Jakobsson, Portola Valley, CA (US); Rebecca Anne Fiebrink, London (GB); Sven Stefan Dufva, Stockholm (SE); Sukamol Srikwan Jakobsson, Portola Valley, CA (US)

(73) Assignee: Artema Labs, Inc, Los Angeles, CA (US)

(21) Appl. No.: 17/806,724

(22) Filed: Jun. 13, 2022

Related U.S. Application Data
(60) Provisional application No. 63/309,573, filed on Feb. 13, 2022.
(60) Provisional application No. 63/308,892, filed on Feb. 10, 2022.
(60) Provisional application No. 63/234,105, filed on Aug. 17, 2021.
(60) Provisional application No. 63/210,042, filed on Jun. 13, 2021.

(51) Int. Cl. G06Q 10/10; H04L 9/00; H04L 9/32

(52) U.S. Cl. CPC G06Q 10/101; H04L 9/50; H04L 9/3247; H04L 9/3213; H04L 2209/60

(57) ABSTRACT

Systems and devices to initiate collaborative content generation within an NFT platform are illustrated. One embodiment includes a method for facilitating engagement between content creators. The method receives a request from a first content creator for second content creators to work on a first piece of content. The method processes the request in order to identify one or more potential second content creators suitable for collaborating. The method sends the request to the potential second content creators and receives at least one acceptance. The method receives a second piece of content from the second content creator, wherein the second piece of content comprises a result of work from the second content creator on the first piece of content. The method generates a token comprising the second piece of content, wherein the token can be securely attributed to at least one of the first content creator and the second content creator.

### CROSS-REFERENCE TO RELATED APPLICATIONS

The current application claims the benefit of and priority under 35 U.S.C. § 119(e) to U.S. Provisional Patent Application No. 63/210,042 entitled “Dynamic Distributed Digital Rights Management Enabling Composite Content” filed Jun. 13, 2021, U.S. Provisional Patent Application No. 63/309,573 entitled “Content Origination Control” filed Feb. 13, 2022, U.S. Provisional Patent Application No. 63/234,105 entitled “Collaborative Computing Infrastructure with Applications to Gaming” filed Aug. 17, 2021, U.S. Provisional Patent Application No. 63/308,892 entitled “Collaborative Generation of Non-Fungible Token and Associated Content” filed Feb. 10, 2022, the disclosures of which are hereby incorporated by reference in their entireties for all purposes.

### FIELD OF THE INVENTION

The present invention generally relates to systems and methods for blockchain-based collaborative content generation.

### BACKGROUND

With the development of the Internet, communication and collaboration between individuals has become increasingly commonplace. Content creators have been increasingly enabled to develop collaborative projects with other creators around the world. However, along with such collaborations comes the need to share data, often with unfamiliar and potentially untrustworthy parties.

### SUMMARY OF THE INVENTION

Systems and devices to initiate collaborative content generation within an NFT platform are illustrated. One embodiment includes a method for facilitating engagement between two or more content creators. The method receives, at a collaboration system, a request from a first content creator, where the request is for second content creators to work on a first piece of content. The method processes, at the collaboration system, the request in order to identify a set of one or more potential second content creators suitable for working on the first piece of content. The method sends the received request to the set of potential second content creators. The method receives, at the collaboration system, an acceptance of the request from at least one of the set of potential second content creators. The method receives, at the collaboration system, a second piece of content from the at least one second content creator, wherein the second piece of content comprises a result of work that the at least one second content creator has performed on the first piece of content. The method generates a token comprising the second piece of content, wherein the token can be securely attributed to at least one of the first content creator and the second content creator.

In a further embodiment, the received request from the first content creator includes the first piece of content and information pertaining to the work intended to be performed on the first piece of content.

In another embodiment, processing the request includes filtering the potential second content creators based on at least one requirement indicated by the first content creator, selected from the group consisting of skillset, medium of operation, genre, availability, and budget.

In a further embodiment, the method indicates, to the first content creator, the identified second content creators.

In a still further embodiment, the method indicates the identified second content creators in part by providing a rating associated with the identified second content creators, wherein the rating is associated with previously performed work of the identified second content creators.

In another embodiment, the method indicates the identified second content creators by displaying their schedule and terms of collaboration.

In still another embodiment, the method receives, from the first content creator, a subset of the potential second content creators to be sent the request.

In a further embodiment, when a sufficient number of second content creators accept the request, the method no longer sends the received request to the potential second content creators.

In another embodiment, the method processes payment and closure of the engagement between the first and the second content creator.

In another embodiment, the method authenticates a received piece of content by performing a normalization of a received piece of content using one or more characterizations of the received piece of content, wherein a characterization includes mapping one or more portions of the received piece of content to one or more descriptors. The method also determines digital signatures for the one or more characterizations to identify the creator of the received piece of content.

One embodiment includes a network node for facilitating engagement between two or more content creators. The network node includes: a user interface; memory; and a processor. The processor is configured to receive, from a first content creator, a request for second content creators to work on a first piece of content. The processor processes the request in order to identify potential second content creators suitable for working on the first piece of content. The processor sends the received request to the potential second content creators. The processor receives, from one or more second content creators of the potential second content creators, an acceptance of the request. The processor receives, from the second content creator, a second piece of content, wherein the second content includes a result of the work the one or more second content creators has performed on the first content. The processor forwards the second piece of content to the first content creator.

In a further embodiment, the received request from the first content creator includes the first piece of content and information pertaining to the work intended to be performed on the first piece of content.

In another embodiment, processing the request includes filtering the potential second content creators based on at least one requirement indicated by the first content creator, selected from the group consisting of skillset, medium of operation, genre, availability, and budget.

In a further embodiment, the processor indicates, to the first content creator, the identified second content creators.

In a still further embodiment, the processor indicates the identified second content creators in part by providing a rating associated with the identified second content creators, wherein the rating is associated with previously performed work of the identified second content creators.

In another embodiment, the processor indicates the identified second content creators by displaying their schedule and terms of collaboration.

In still another embodiment, the processor receives, from the first content creator, a subset of the potential second content creators to be sent the request.

In a further embodiment, when a sufficient number of second content creators accept the request, the processor no longer sends the received request to the potential second content creators.

In another embodiment, the processor processes payment and closure of the engagement between the first and the second content creator.

In another embodiment, the processor authenticates a received piece of content by performing a normalization of a received piece of content using one or more characterizations of the received piece of content, wherein a characterization includes mapping one or more portions of the received piece of content to one or more descriptors. The processor also determines digital signatures for the one or more characterizations to identify the creator of the received piece of content.

One embodiment includes a method for checking content originality. The method receives, at a collaboration system, a piece of content from an originator, wherein the originator is a creator of the piece of content and the piece of content is digitally signed with a private key of the originator. The method constructs, at the collaboration system, a graph representation of the received piece of content, wherein the graph representation comprises a characterization of elements of the received piece of content. The method determines, at the collaboration system, a novelty score between the graph representation and graph representations of a set of already existing pieces of content. The method updates, at the collaboration system, a reputation score of the originator associated with a reputation NFT that is associated with a public key of the originator, wherein the reputation score of the originator is based on novelty scores of pieces of content generated by the originator.

In a further embodiment, the method provides the determined novelty score to one or more of the originator, an originator of a set of one or more pieces of content from the set of already existing pieces of content, and a searching entity.

In another embodiment, when the received piece of content is an addition to a piece of already existing content the method receives an indication, from an originator of the piece of already existing content, concerning acceptance of the addition. When the indication is an acceptance, the method increases the reputation score of the originator of the addition. When the indication is a rejection, the method decreases the reputation score of the originator of the addition.

In a further embodiment, the method receives a satisfaction rating for the addition from the originator of the piece of already existing content. The indication influences the satisfaction rating and a degree of change for the reputation score is based on the satisfaction rating.

In another embodiment, determining the novelty score includes determining similarity scores for elements of two or more pieces of content.

In another embodiment originators have unique user profiles generated, wherein a piece of content received from an originator is associated with a unique user profile of the originator.

In a further embodiment, the user profiles of the originators include information pertaining to access permissions for the received piece of content.

In a still further embodiment, an access permission indicates that only users having reputation scores above a specified threshold can access the received piece of content.

In another embodiment, the unique user profile of the originator includes information pertaining to one or more of time constraints of the originator, an activity score that indicates how active the originator is, and a collaborative reputation score that indicates the originator's reputation for contributing to at least one other piece of content.

In still another embodiment, the set of already existing content refers to pieces of content stored in one or more databases, the databases being accessible by a service provider.

One embodiment includes a non-transitory computer-readable medium storing instructions that, when executed by a processor, are configured to cause the processor to perform operations for checking content originality. The processor receives content from an originator, wherein the originator is a creator of content. The processor constructs a graph representation of the received piece of content, wherein the graph representation comprises a characterization of elements of the received piece of content. The processor determines a novelty score between the graph representation and graph representations of a set of already existing pieces of content. The process updates a reputation score of the originator associated with a reputation NFT that is associated with a public key of the originator, wherein the reputation score of the originator is based on novelty scores of pieces of content generated by the originator.

In a further embodiment, the processor provides the determined novelty score to one or more of the originator, an originator of at least one piece of content from the set of already existing content, and a searching entity.

In another embodiment, when the received piece of content is an addition to a piece of already existing content the processor receives an indication, from an originator of the piece of already existing content, concerning acceptance of the addition. When the indication is an acceptance, the processor increases the reputation score of the originator of the addition. When the indication is a rejection, the processor decreases the reputation score of the originator of the addition.

In a further embodiment, the processor receives a satisfaction rating for the addition from the originator of the piece of already existing content. The indication influences the satisfaction rating and a degree of change for the reputation score is based on the satisfaction rating.

In another embodiment, determining the novelty score includes determining similarity scores for elements of two or more pieces of content, wherein the novelty score is influenced by the similarity scores.

In another embodiment originators have unique user profiles generated, wherein a piece of content received from an originator is associated with a unique user profile of the originator.

In a further embodiment, the unique user profile of the originator includes information pertaining to access permissions for the received piece of content.

In a still further embodiment, an access permission indicates that only users having reputation scores above a specified threshold can access the received piece of content.

In another embodiment, the unique user profile of the originator includes information pertaining to one or more of time constraints of the originator, an activity score that indicates how active the originator is, and a collaborative reputation score that indicates the originator's reputation for contributing to other pieces of content.

In still another embodiment, piece of already existing content refers to pieces of content stored in one or more databases, the databases being accessible by a service provider.

One embodiment includes a system for collaborative software development. The system includes a platform, and a configuration engine that takes as input the platform and a developer selection. The platform includes: a first set of executable elements; a first set of digital arts descriptors; and a first set of constraints. The configuration engine derives a second set of constraint from the first set of constraints. The configuration engine derives a second set of digital arts descriptors from the first set of digital arts descriptors. The configuration engine derives a second set of executable elements, wherein the second set of executable elements is derived from at least one of the first set of executable elements and the second set of digital arts descriptors. The configuration engine generates an executable token including the second set of executable elements, wherein the executable token comprises executable bytecode and is based on the platform and the developer selection. The configuration engine executes the executable token. When the second set of constraints are satisfied, the configuration engine renders the second set of digital arts descriptors.

In another embodiment, the sets of executable elements include one or more executable elements and include scripts.

In another embodiment, the sets of constraints each include one or more constraints and each constraint of a set of constraints concerns at least one of royalty policies, terms, usage restrictions, and reporting requirements.

In another embodiment, digital art descriptors include at least one of imagery, videos, and sound effects.

In another embodiment, executing the second set of executable elements causes a log entry to be generated, and the log entry includes data identifying statistics related to the execution of the executable token.

In a further embodiment, the statistics reference at least one of a number of executions, a duration of executions, a user request, a state associated with the second set of executable elements, and a list of pre-determined events.

In another embodiment, executing the second set of executable elements causes a piece of promotional content to be rendered.

In still another embodiment executing the second set of executable elements causes a payment to be performed.

In still yet another embodiment, the executable token includes a second platform.

In still another embodiment, the developer selection determines the second set of executable elements and the second set of constraints.

One embodiment includes a method for collaborative software development. The method receives, at a collaboration system, a platform and a developer selection. The platform includes a first set of executable elements; a first set of digital arts descriptors; and a first set of constraints. The method derives a second set of constraints from the first set of constraints. The method derives a second set of digital arts descriptors from the first set of digital arts descriptors. The method derives a second set of executable elements, wherein the second set of executable elements is derived from at least one of the first set of executable elements and the second set of digital arts descriptors. The method generates, at the collaboration system, an executable token comprising the second set of executable elements, wherein the executable token comprises executable bytecode and is based on the platform and the developer selection. The method executes the executable token. When the second set of constraints are satisfied, the method renders the second set of digital arts descriptors.

In another embodiment, the sets of executable elements include one or more executable elements and include scripts.

In another embodiment, the sets of constraints each include one or more constraints and each constraint of a set of constraints concerns at least one of royalty policies, terms, usage restrictions, and reporting requirements.

In another embodiment, digital art descriptors include at least one of imagery, videos, and sound effects.

In another embodiment, executing the second set of executable elements causes a log entry to be generated, and the log entry includes data identifying statistics related to the execution of the executable token.

In a further embodiment, the statistics reference at least one of a number of executions, a duration of executions, a user request, a state associated with the second set of executable elements, and a list of pre-determined events.

In another embodiment, executing the second set of executable elements causes a piece of promotional content to be rendered.

In still another embodiment executing the second set of executable elements causes a payment to be performed.

In still yet another embodiment, the executable token includes a second platform.

In still another embodiment, the developer selection determines the second set of executable elements and the second set of constraints.

One embodiment includes a system for managing content. The system includes a content processor and a presentation entity. The content processor receives a first container that includes a first piece of content and a first policy governing the first piece of content, and a second container includes a second piece of content and a second policy governing the second piece of content. The content processor receives a user input signal. The content processor evaluates the first policy on the second piece of content. The content processor evaluates the second policy on the first piece of content. Conditional on the evaluations of the policies, the content processor generates a third piece of content from the first piece of content and the second piece of content. The third piece of content is based at least in part on the user input signal; and the personalization parameter associated with a user profile accessed by the content processor. The content processor transmits the third piece of content to a presentation entity. The presentation entity displays the third piece of content.

In another embodiment, at least one of the first piece of content and the second piece of content includes an executable script.

In another embodiment at least one of the first piece of content and the second piece of content includes proprietary data.

In yet another embodiment, at least one of the first piece of content and the second piece of content includes encrypted data that is decrypted by a digital rights management entity associated with the content processor.

In yet another embodiment, at least one of the first piece of content and the second piece of content includes an NFT.

In still yet another embodiment, at least one of the first piece of content and the second piece of content includes voice data.

In still yet another embodiment, at least one of the first piece of content and the second piece of content includes graphical data.

In still another embodiment, at least one of the first policy and the second policy determines compatibility of the first piece of content and the second piece of content.

In still yet another embodiment, at least one of the first policy and the second policy includes a digital rights policy describing allowed usage terms.

In another embodiment, the user input signal includes at least one of an implicit input and an explicit input.

In still another embodiment, the personalization parameter is modified by the content processor.

In still another embodiment the personalization parameter is transmitted over a network connection to a repository for personalization parameters.

In still yet another embodiment, at least one of the first piece of content and the second piece of content corresponds to piece of commercial content.

In still yet another embodiment a selection of the piece of commercial content is performed based on at least one user input.

In another embodiment, the selection of the piece of commercial content is performed based on at least one sensor input associated with a user device.

In a further embodiment, wherein the selection of the piece of commercial content is performed based on at least one entry of an event log.

One embodiment includes a method for managing content. The method receives, at a collaboration system, a first container that includes a first piece of content and a first policy governing the first piece of content, and a second container includes a second piece of content and a second policy governing the second piece of content. The method receives a user input signal. The method evaluates, at the collaboration system, the first policy on the second piece of content. The method evaluates, at the collaboration system, the second policy on the first piece of content. Conditional on the evaluations of the policies, the method generates a third piece of content from the first piece of content and the second piece of content. The third piece of content is based at least in part on the user input signal; and the personalization parameter associated with a user profile accessed by the method. The method displays the third piece of content.

In another embodiment, at least one of the first piece of content and the second piece of content includes an executable script.

In another embodiment at least one of the first piece of content and the second piece of content includes proprietary data.

In yet another embodiment, at least one of the first piece of content and the second piece of content includes encrypted data that is decrypted by a digital rights management entity.

In yet another embodiment, at least one of the first piece of content and the second piece of content includes an NFT.

In still yet another embodiment, at least one of the first piece of content and the second piece of content includes voice data.

In still yet another embodiment, at least one of the first piece of content and the second piece of content includes graphical data.

In still another embodiment, at least one of the first policy and the second policy determines compatibility of the first piece of content and the second piece of content.

In still yet another embodiment, at least one of the first policy and the second policy includes a digital rights policy describing allowed usage terms.

In another embodiment, the user input signal includes at least one of an implicit input and an explicit input.

In still another embodiment, the personalization parameter is modified by a processor.

In still another embodiment the method transmits the personalization parameter over a network connection to a repository for personalization parameters.

In still yet another embodiment, at least one of the first piece of content and the second piece of content corresponds to a piece of commercial content.

In still yet another embodiment a selection of the piece of commercial content is performed based on at least one user input.

In another embodiment, the selection of the piece of commercial content is performed based on at least one sensor input associated with a user device.

In a further embodiment, wherein the selection of the piece of commercial content is performed based on at least one entry of an event log.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 is a conceptual diagram of an NFT platform in accordance with an embodiment of the invention.

FIG. 2 is a network architecture diagram of an NFT platform in accordance with an embodiment of the invention.

FIG. 3 is a conceptual diagram of a permissioned blockchain in accordance with an embodiment of the invention.

FIG. 4 is a conceptual diagram of a permissionless blockchain in accordance with an embodiment of the invention.

FIGS. 5A-5B are diagrams of a dual blockchain in accordance with a number of embodiments of the invention.

FIG. 6 conceptually illustrates a process followed by a Proof of Work consensus mechanism in accordance with a number of embodiments of the invention.

FIG. 7 conceptually illustrates a process followed by a Proof of Space consensus mechanism in accordance with several embodiment of the invention.

FIG. 8 illustrates a dual proof consensus mechanism configuration in accordance with several embodiment of the invention.

FIG. 9 illustrates a process followed by a Trusted Execution Environment-based consensus mechanism in accordance with some embodiments of the invention

FIGS. 10-12 depicts various devices that can be utilized alongside an NFT platform in accordance with various embodiments of the invention.

FIG. 13 depicts a media wallet application configuration in accordance with many embodiments of the invention.

FIGS. 14A-14C depicts user interfaces of various media wallet applications in accordance with a number of embodiments of the invention.

FIG. 15 illustrates an NFT configuration in accordance with many embodiments of the invention.

FIG. 16 conceptually illustrates a process followed by two content creators engaged in collaboration in accordance with some embodiments of the invention.

FIGS. 17A-17C conceptually illustrates processes for reviewing the originality of collaboratively created content in accordance with numerous embodiments of the invention.

FIG. 18 illustrates a platform configuration implemented in collaborative game development in accordance with various embodiments of the invention.

FIG. 19 illustrates a configuration engine implemented in collaborative game development in accordance with multiple embodiments of the invention.

FIG. 20 illustrates a game construction in accordance with a number of embodiments of the invention.

FIGS. 21A-21C illustrate the combination of Digital Rights Management (DRM) content from two or more content sources in accordance with several embodiments of the invention.

FIG. 22 illustrates the incorporation of a content presentation unit into the dynamic presentation of content in accordance with some embodiments of the invention.

FIG. 23 illustrates a billing configuration implemented alongside the dynamic presentation of content in accordance with various embodiments of the invention.

FIG. 24 illustrates a process followed in the logging of inconsistencies within the billing process in accordance with a number of embodiments of the invention.

FIG. 25 illustrates the use of executable content in accordance with many embodiments of the invention.

FIG. 26 illustrates a personalized content processing unit governed by one or more policies in accordance with many embodiments of the invention.

FIG. 27 conceptually illustrates a process followed in the dynamic presentation of content in accordance with numerous embodiments of the invention.

FIG. 28 illustrates the configuration of a content presentation device in accordance with some embodiments of the invention.

FIGS. 29A-29B conceptually illustrate a process followed in the selection and presentation of content in accordance with various embodiments of the invention.

FIG. 30 illustrates a log configuration associated with the processing of content in accordance with numerous embodiments of the invention.

FIG. 31 illustrates a system of interaction between users and animated characters in accordance with a number of embodiments of the invention.

### DETAILED DESCRIPTION

Systems and methods for blockchain-based collaborative content generation in accordance with various embodiments of the invention are described herein. In some embodiments, collaboration platforms can allow users (e.g., content creators, content originators, content users, etc.) to collaborate on the generation of new content (e.g., application code, multimedia presentations, etc.) using blockchain-based technologies.

In a number of embodiments, content creators can utilize a user interface to collaborate with other content creators. Content of various mediums including, but not limited to NFTs, can be collaboratively developed and modified through outreach over the user interface. Content creators may process searches for collaborators, implement requests for collaboration, and/or develop terms of engagement through external facilitation. Content creators may additionally incorporate identifiers into their work such that future authentication is enabled. Post-collaboration ratings may enable content creators to exclude unreliable creators from their search pools.

In several embodiments, NFT platforms can generate graph-based characterizations of content. Content creators may assess the similarity and/or novelty of their respective creations. Novelty and/or similarity scores can provide a quick and efficient means to assess the innovation of particular creations. Machine learning methods may implement various means of representation and comparison of content. The comparison of content may be performed in a variety of modes including but not limited to, textual, audio, and visual mediums. Reputation for plagiarism may also be represented through reputation scores, providing a feature through which the network of collaborators may be refined.

In accordance with several embodiments of the invention, platforms for collaborative development of content may be implemented. Collaborative development platforms in accordance with various embodiments of the invention can allow users to collaborate on developments while maintaining rights and policies of individual contributors. Platforms may incorporate multiple features directed to collaborative development including but not limited to executable elements, graphical content, and layout templates. Platforms for collaborative development may incorporate various tools targeted to the development of games including, but not limited to, configuration engines. Configuration engines may establish pre-made constructs to incorporate into subsequent games.

Many embodiments of the invention may incorporate techniques for the management of composite content from a plurality of content creators. Containers for the combination of content may include content files and policies for content combination. Consumer consumption of the composite content may be billed according to the proportions of constituent source content. Composite content may be produced from personalized content modified according to feedback from consumers. The selection and presentation of composite content may be governed by policies associated with the constituent content. Executable content may also be combined using techniques in accordance with several embodiments of the invention.

While various aspects of NFT platforms, NFTs, media wallets, blockchain configurations, reporting structures, and maintenance systems are discussed above, NFT platforms and different components that can be utilized within NFT platforms in accordance with various embodiments of the invention are discussed further below.

### NFT Platforms

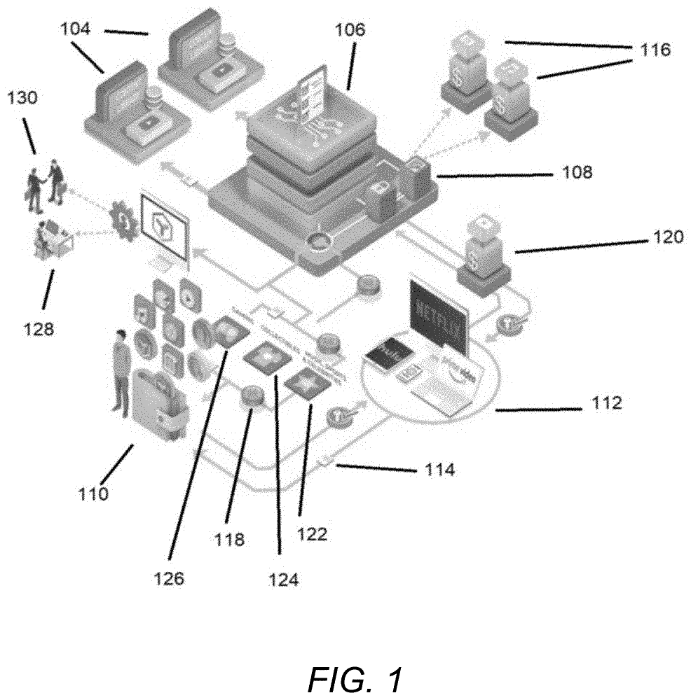

An NFT platform in accordance with an embodiment of the invention is illustrated in FIG. 1. The NFT platform 100 utilizes one or more immutable ledgers (e.g. one or more blockchains) to enable a number of verified content creators 104 to access an NFT registry service to mint NFTs 106 in a variety of forms including (but not limited to) celebrity NFTs 122, character NFTs from games 126, NFTs that are redeemable within games 126, NFTs that contain and/or enable access to collectibles 124, and NFTs that have evolutionary capabilities representative of the change from one NFT state to another NFT state. In a number of embodiments of the invention, NFT platforms may incorporate functionality to allow the collaboration of two or more content creators in generating content. Functionality of this type is discussed further below.

Issuance of NFTs 106 via the NFT platform 100 enables verification of the authenticity of NFTs independently of the content creator 104 by confirming that transactions written to one or more of the immutable ledgers are consistent with the smart contracts 108 underlying the NFTs.

As is discussed further below, content creators 104 can provide the NFTs 106 to users to reward and/or incentivize engagement with particular pieces of content and/or other user behavior including (but not limited to) the sharing of user personal information (e.g. contact information or user ID information on particular services), demographic information, and/or media consumption data with the content creator and/or other entities. In addition, the smart contracts 108 underlying the NFTs can cause payments of residual royalties 116 when users engage in specific transactions involving NFTs (e.g. transfer of ownership of the NFT).

In a number of embodiments, users utilize media wallet applications 110 on their devices to store NFTs 106 distributed using the NFT platform 100. Users can use media wallet applications 110 to obtain and/or transfer NFTs 106. In facilitating the retention or transfer of NFTs 106, media wallet applications may utilize wallet user interfaces that engage in transactional restrictions through either uniform or personalized settings. Media wallet applications 110 in accordance with some embodiments may incorporate NFT filtering systems to avoid unrequested NFT assignment. Methods for increased wallet privacy may also operate through multiple associated wallets with varying capabilities. As can readily be appreciated, NFTs 106 that are implemented using smart contracts 108 having interfaces that comply with open standards are not limited to being stored within media wallets and can be stored in any of a variety of wallet applications as appropriate to the requirements of a given application. Furthermore, a number of embodiments of the invention support movement of NFTs 106 between different immutable ledgers. Processes for moving NFTs between multiple immutable ledgers in accordance with various embodiments of the invention are discussed further below.

In several embodiments, content creators 104 can incentivize users to grant access to media consumption data using offers including (but not limited to) offers of fungible tokens 118 and/or NFTs 106. In this way, the ability of the content creators to mint NFTs enables consumers to engage directly with the content creators and can be utilized to incentivize users to share with content creators' data concerning user interactions with additional content. The permissions granted by individual users may enable the content creators 104 to directly access data written to an immutable ledger. In many embodiments, the permissions granted by individual users enable authorized computing systems to access data within an immutable ledger and content creators 104 can query the authorized computing systems to obtain aggregated information. Numerous other example functions for content creators 104 are possible, some of which are discussed below.

NFT blockchains in accordance with various embodiments of the invention enable issuance of NFTs by verified users. In many embodiments, the verified users can be content creators that are vetted by an administrator of networks that may be responsible for deploying and maintaining the NFT blockchain. Once the NFTs are minted, users can obtain and conduct transactions with the NFTs. In several embodiments, the NFTs may be redeemable for items or services in the real world such as (but not limited to) admission to movie screenings, concerts, and/or merchandise.

As illustrated in FIG. 1, users can install the media wallet application 110 onto their devices and use the media wallet application 110 to purchase fungible tokens. In many embodiments, the fungible tokens can be fully converted into fiat currency and/or other cryptocurrency. In several embodiments, the fungible tokens are implemented using split blockchain models in which the fungible tokens can be issued to multiple blockchains (e.g. Ethereum). As can readily be appreciated, the fungible tokens and/or NFTs utilized within an NFT platform in accordance with various embodiments of the invention are largely dependent upon the requirements of a given application.

In several embodiments, the media wallet application is capable of accessing multiple blockchains by deriving accounts from each of the various immutable ledgers used within an NFT platform. For each of these blockchains, the media wallet application can automatically provide simplified views whereby fungible tokens and NFTs across multiple accounts and/or multiple blockchains can be rendered as single user profiles and/or wallets. In many embodiments, the single view can be achieved using deep-indexing of the relevant blockchains and API services that can rapidly provide information to media wallet applications in response to user interactions. In certain embodiments, the accounts across the multiple blockchains can be derived using BIP32 deterministic wallet key. In other embodiments, any of a variety of techniques can be utilized by the media wallet application to access one or more immutable ledgers as appropriate to the requirements of a given application.

NFTs can be purchased by way of exchanges 130 and/or from other users. In addition, content creators can directly issue NFTs to the media wallets of specific users (e.g. by way of push download or AIRDROP). In many embodiments, the NFTs are digital collectibles such as celebrity NFTs 122, character NFTs from games 126, NFTs that are redeemable within games 126, and/or NFTs that contain and/or enable access to collectibles 124. It should be appreciated that a variety of NFTs are described throughout the discussion of the various embodiments described herein and can be utilized in any NFT platform and/or with any media wallet application.

While the NFTs are shown as static in the illustrated embodiment, content creators can utilize users' ownership of NFTs to engage in additional interactions with the user. In this way, the relationship between users and particular pieces of content and/or particular content creators can evolve over time around interactions driven by NFTs. In a number of embodiments, collection of NFTs can be gamified to enable unlocking of additional NFTs. In addition, leaderboards can be established with respect to particular content and/or franchises based upon users' aggregation of NFTs. As is discussed further below, NFTs and/or fungible tokens can also be utilized by content creators to incentivize users to share data.

NFTs minted in accordance with several embodiments of the invention may incorporate a series of instances of digital content elements in order to represent the evolution of the digital content over time. Each one of these digital elements can have multiple numbered copies, just like a lithograph, and each such version can have a serial number associated with it, and/or digital signatures authenticating its validity. The digital signature can associate the corresponding image to an identity, such as the identity of the artist. The evolution of digital content may correspond to the transition from one representation to another representation. This evolution may be triggered by the artist, by an event associated with the owner of the artwork, by an external event measured by platforms associated with the content, and/or by specific combinations or sequences of event triggers. Some such NFTs may also have corresponding series of physical embodiments. These may be physical and numbered images that are identical to the digital instances described above. They may also be physical representations of another type, e.g., clay figures or statues, whereas the digital representations may be drawings. The physical embodiments may further be of different aspects that relate to the digital series. Evolution in compliance with some embodiments may also be used to spawn additional content, for example, one NFT directly creating one or more secondary NFTs.

When the user wishes to purchase an NFT using fungible tokens, media wallet applications can request authentication of the NFT directly based upon the public key of the content creator and/or indirectly based upon transaction records within the NFT blockchain. As discussed above, minted NFTs can be signed by content creators and administrators of the NFT blockchain. In addition, users can verify the authenticity of particular NFTs without the assistance of entities that minted the NFT by verifying that the transaction records involving the NFT within the NFT blockchain are consistent with the various royalty payment transactions required to occur in conjunction with transfer of ownership of the NFT by the smart contract underlying the NFT.

Applications and methods in accordance with various embodiments of the invention are not limited to media wallet applications or use within NFT platforms. Accordingly, it should be appreciated that the data collection capabilities of any media wallet application described herein can also be implemented outside the context of an NFT platform and/or in a dedicated application and/or in an application unrelated to the storage of fungible tokens and/or NFTs. Various systems and methods for implementing NFT platforms and media wallet applications in accordance with various embodiments of the invention are discussed further below.

### NFT Platform Network Architectures

NFT platforms in accordance with many embodiments of the invention utilize public blockchains and permissioned blockchains. In several embodiments, the public blockchain is decentralized and universally accessible. Additionally, in a number of embodiments, private/permissioned blockchains are closed systems that are limited to publicly inaccessible transactions. In many embodiments, the permissioned blockchain can be in the form of distributed ledgers, while the blockchain may alternatively be centralized in a single entity.

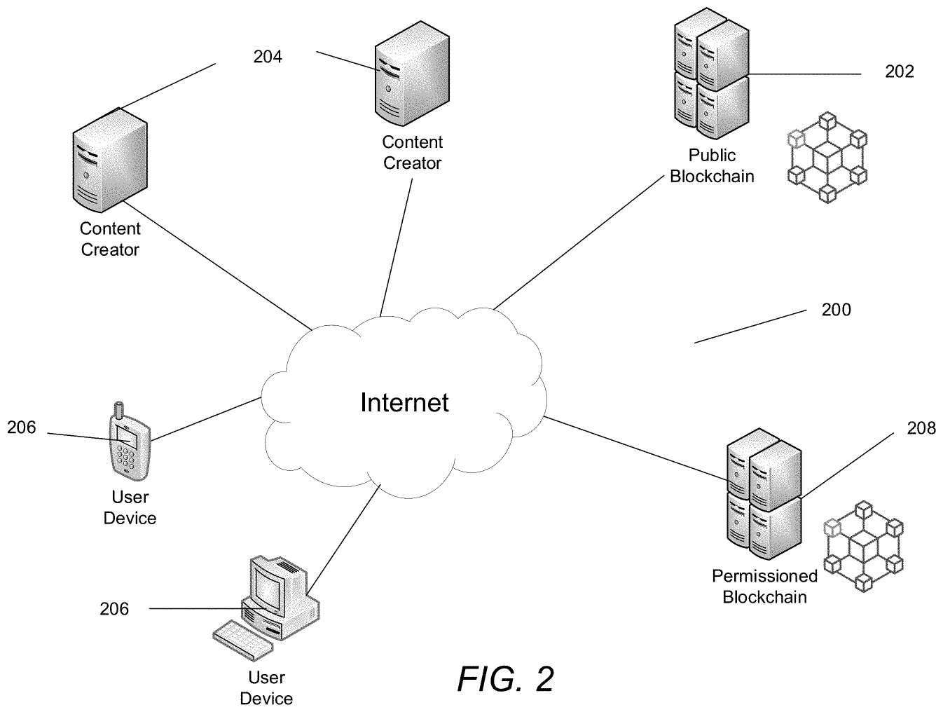

An example of network architecture that can be utilized to implement an NFT platform including a public blockchain and a permissioned blockchain in accordance with several embodiments of the invention is illustrated in FIG. 2. The NFT platform 200 utilizes computer systems implementing a public blockchain 202 such as (but not limited to) Ethereum and Solana. A benefit of supporting interactions with public blockchains 202 is that the NFT platform 200 can support minting of standards based NFTs that can be utilized in an interchangeable manner with NFTs minted by sources outside of the NFT platform on the public blockchain. In this way, the NFT platform 200 and the NFTs minted within the NFT platform are not part of a walled garden, but are instead part of a broader blockchain-based ecosystem. The ability of holders of NFTs minted within the NFT platform 200 to transact via the public blockchain 202 increases the likelihood that individuals acquiring NFTs will become users of the NFT platform. Initial NFTs minted outside the NFT platform can also be developed through later minted NFTs, with the initial NFTs being used to further identify and interact with the user based upon their ownership of both NFTs. Various systems and methods for facilitating the relationships between NFTs, both outside and within the NFT platform are discussed further below.

Users can utilize user devices configured with appropriate applications including (but not limited to) media wallet applications to obtain NFTs. In many embodiments, media wallets are smart device enabled, front-end applications for fans and/or consumers, central to all user activity on an NFT platform. As is discussed in detail below, different embodiments of media wallet applications can provide any of a variety of functionality that can be determined as appropriate to the requirements of a given application. In the illustrated embodiment, the user devices 206 are shown as mobile phones and personal computers. As can readily be appreciated user devices can be implemented using any class of consumer electronics device including (but not limited to) tablet computers, laptop computers, televisions, game consoles, virtual reality headsets, mixed reality headsets, augmented reality headsets, media extenders, and/or set top boxes as appropriate to the requirements of a given application.

In many embodiments, NFT transaction data entries in the permissioned blockchain 208 are encrypted using users' public keys so that the NFT transaction data can be accessed by the media wallet application. In this way, users control access to entries in the permissioned blockchain 208 describing the user's NFT transaction. In several embodiments, users can authorize content creators 204 to access NFT transaction data recorded within the permissioned blockchain 208 using one of a number of appropriate mechanisms including (but not limited to) compound identities where the user is the owner of the data and the user can authorize other entities as guests that can also access the data. As can readily be appreciated, particular content creators' access to the data can be revoked by revoking their status as guests within the compound entity authorized to access the NFT transaction data within the permissioned blockchain 208. In certain embodiments, compound identities are implemented by writing authorized access records to the permissioned blockchain using the user's public key and the public keys of the other members of the compound entity.

When content creators wish to access particular pieces of data stored within the permissioned blockchain 208, they can make a request to a data access service. The data access service may grant access to data stored using the permissioned blockchain 208 when the content creators' public keys correspond to public keys of guests. In a number of embodiments, guests may be defined within a compound identity. The access record for the compound entity may also authorize the compound entity to access the particular piece of data. In this way, the user has complete control over access to their data at any time by admitting or revoking content creators to a compound entity and/or modifying the access policies defined within the permissioned blockchain 208 for the compound entity. In several embodiments, the permissioned blockchain 208 supports access control lists and users can utilize a media wallet application to modify permissions granted by way of the access control list. In many embodiments, the manner in which access permissions are defined enables different restrictions to be placed on particular pieces of information within a particular NFT transaction data record within the permissioned blockchain 208. As can readily be appreciated, the manner in which NFT platforms and/or immutable ledgers provide fine-grained data access permissions largely depends upon the requirements of a given application.

In many embodiments, storage nodes within the permissioned blockchain 208 do not provide content creators with access to entire NFT transaction histories. Instead, the storage nodes simply provide access to encrypted records. In several embodiments, the hash of the collection of records from the permissioned blockchain is broadcast. Therefore, the record is verifiably immutable and each result includes the hash of the record and the previous/next hashes. As noted above, the use of compound identities and/or access control lists can enable users to grant permission to decrypt certain pieces of information or individual records within the permissioned blockchain. In several embodiments, the access to the data is determined by computer systems that implement permission-based data access services.

In many embodiments, the permissioned blockchain 208 can be implemented using any blockchain technology appropriate to the requirements of a given application. As noted above, the information and processes described herein are not limited to data written to permissioned blockchains 208, and NFT transaction data simply provides an example. Systems and methods in accordance with various embodiments of the invention can be utilized to enable applications to provide fine-grained permission to any of a variety of different types of data stored in an immutable ledger as appropriate to the requirements of a given application in accordance with various embodiments of the invention.

While various implementations of NFT platforms are described above with reference to FIG. 2, NFT platforms can be implemented using any number of immutable and pseudo-immutable ledgers as appropriate to the requirements of specific applications in accordance with various embodiments of the invention. Blockchain databases in accordance with various embodiments of the invention may be managed autonomously using peer-to-peer networks and distributed timestamping servers. In some embodiments, any of a variety of consensus mechanisms may be used by public blockchains, including but not limited to Proof of Space mechanisms, Proof of Work mechanisms, Proof of Stake mechanisms, and hybrid mechanisms.

NFT platforms in accordance with many embodiments of the invention may benefit from the oversight and increased security of private blockchains. As can readily be appreciated, a variety of approaches can be taken to the writing of data to permissioned blockchains and the particular approach is largely determined by the requirements of particular applications. As such, computer systems in accordance with various embodiments of the invention can have the capacity to create verified NFT entries written to permissioned blockchains.

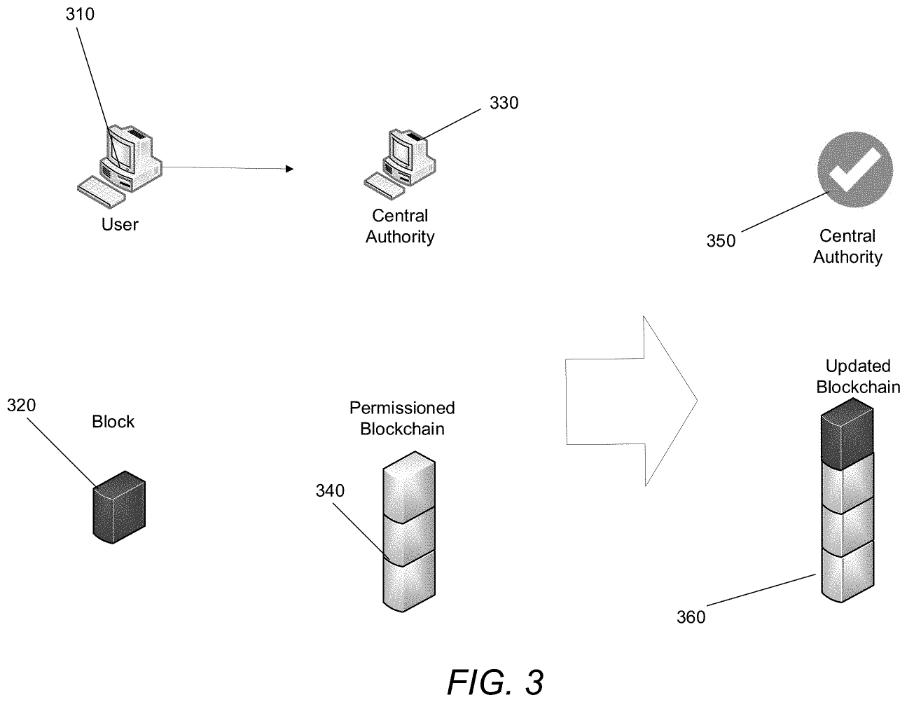

An implementation of permissioned (or private) blockchains in accordance with some embodiments of the invention is illustrated in FIG. 3. Permissioned blockchains 340 can typically function as closed computing systems in which each participant is well defined. In several embodiments, private blockchain networks may require invitations. In a number of embodiments, entries, or blocks 320, to private blockchains can be validated. In some embodiments, the validation may come from central authorities 330. Private blockchains can allow an organization or a consortium of organizations to efficiently exchange information and record transactions. Specifically, in a permissioned blockchain, a preapproved central authority 330 (which should be understood as potentially encompassing multiple distinct authorized authorities) can approve a change to the blockchain. In a number of embodiments, approval may come without the use of a consensus mechanism involving multiple authorities. As such, through a direct request from users 310 to the central authority 330, the determination of whether blocks 320 can be allowed access to the permissioned blockchain 340 can be determined. Blocks 320 needing to be added, eliminated, relocated, and/or prevented from access may be controlled through these means. In doing so the central authority 330 may manage accessing and controlling the network blocks incorporated into the permissioned blockchain 340. Upon the approval 350 of the central authority, the now updated blockchain 360 can reflect the added block 320.

NFT platforms in accordance with many embodiments of the invention may also benefit from the anonymity and accessibility of a public blockchain. Therefore, NFT platforms in accordance with many embodiments of the invention can have the capacity to create verified NFT entries written to a permissioned blockchain.

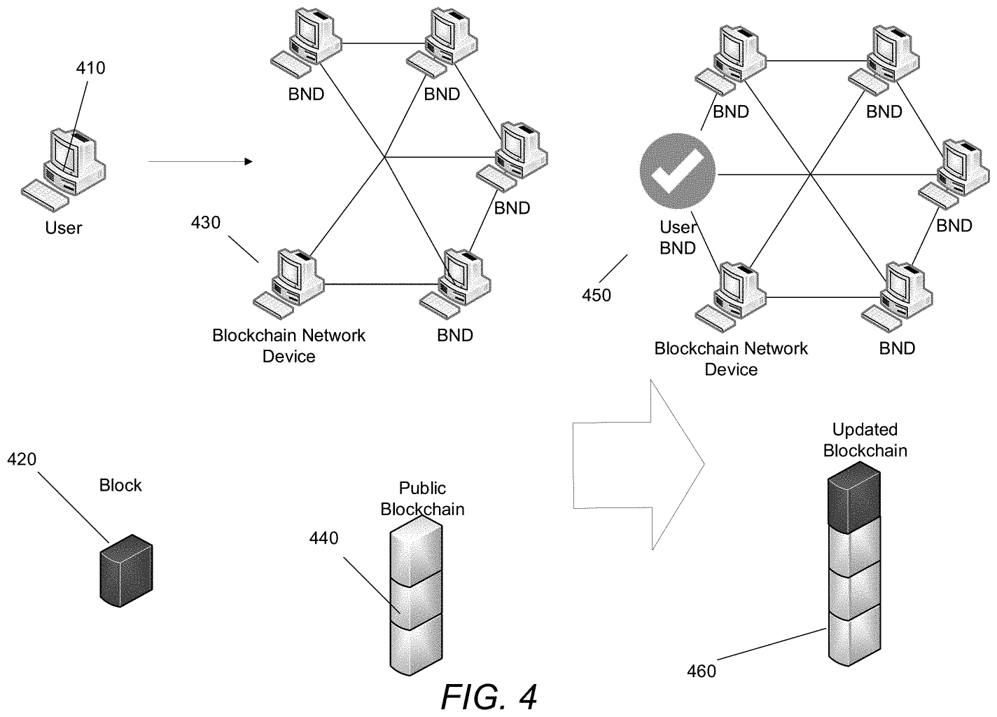

An implementation of a permissionless, decentralized, or public blockchain in accordance with an embodiment of the invention is illustrated in FIG. 4. In a permissionless blockchain, individual users 410 can directly participate in relevant networks and operate as blockchain network devices 430. As blockchain network devices 430, parties would have the capacity to participate in changes to the blockchain and participate in transaction verifications (via the mining mechanism). Transactions are broadcast over the computer network and data quality is maintained by massive database replication and computational trust. Despite being decentralized, an updated blockchain 460 cannot remove entries, even if anonymously made, making it immutable. In many decentralized blockchains, many blockchain network devices 430, in the decentralized system may have copies of the blockchain, allowing the ability to validate transactions. In many instances, the blockchain network device 430 can personally add transactions, in the form of blocks 420 appended to the public blockchain 440. To do so, the blockchain network device 430 would take steps to allow for the transactions to be validated 450 through various consensus mechanisms (Proof of Work, proof of stake, etc.). A number of consensus mechanisms in accordance with various embodiments of the invention are discussed further below.

Additionally, in the context of blockchain configurations, the term smart contract is often used to refer to software programs that run on blockchains. While a standard legal contract outlines the terms of a relationship (usually one enforceable by law), a smart contract enforces a set of rules using self-executing code within NFT platforms. As such, smart contracts may have the means to automatically enforce specific programmatic rules through platforms. Smart contracts are often developed as high-level programming abstractions that can be compiled down to bytecode. Said bytecode may be deployed to blockchains for execution by computer systems using any number of mechanisms deployed in conjunction with the blockchain. In many instances, smart contracts execute by leveraging the code of other smart contracts in a manner similar to calling upon a software library.

A number of existing decentralized blockchain technologies intentionally exclude or prevent rich media assets from existing within the blockchain, because they would need to address content that is not static (e.g., images, videos, music files). Therefore, NFT platforms in accordance with many embodiments of the invention may address this with blockchain mechanisms, that preclude general changes but account for updated content.

NFT platforms in accordance with many embodiments of the invention can therefore incorporate decentralized storage pseudo-immutable dual blockchains. In some embodiments, two or more blockchains may be interconnected such that traditional blockchain consensus algorithms support a first blockchain serving as an index to a second, or more, blockchains serving to contain and protect resources, such as the rich media content associated with NFTs.

In storing rich media using blockchain, several components may be utilized by an entity (“miner”) adding transactions to said blockchain. References, such as URLs, may be stored in the blockchain to identify assets. Multiple URLs may also be stored when the asset is separated into pieces. An alternative or complementary option may be the use of APIs to return either the asset or a URL for the asset. In accordance with many embodiments of the invention, references can be stored by adding a ledger entry incorporating the reference enabling the entry to be timestamped. In doing so, the URL, which typically accounts for domain names, can be resolved to IP addresses. However, when only files of certain types are located on particular resources, or where small portions of individual assets are stored at different locations, users may require methods to locate assets stored on highly-splintered decentralized storage systems. To do so, systems may identify at least primary asset destinations and update those primary asset destinations as necessary when storage resources change. The mechanisms used to identify primary asset destinations may take a variety of forms including, but not limited to, smart contracts.

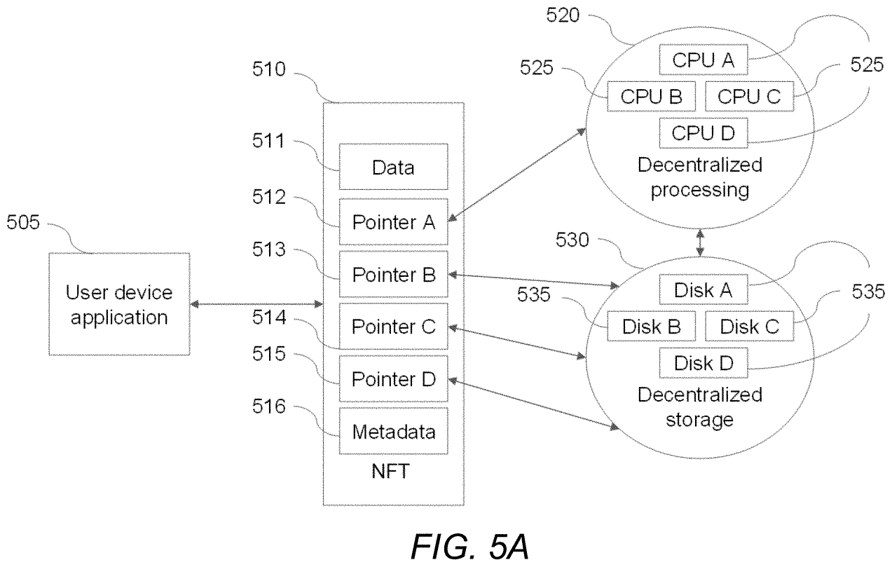

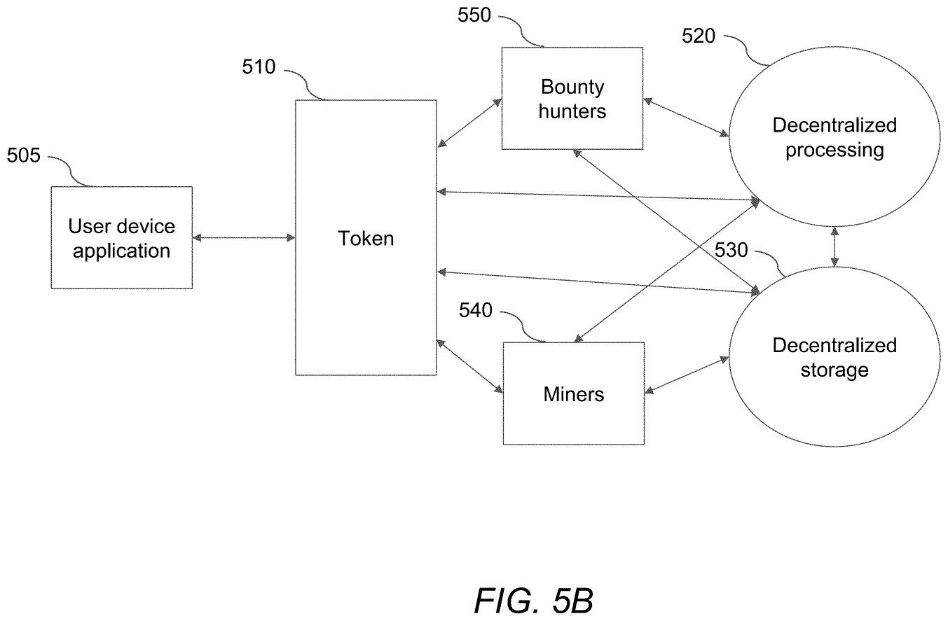

A dual blockchain, including decentralized processing 520 and decentralized storage 530 blockchains, in accordance with some embodiments of the invention is illustrated in FIG. 5A. Application running on devices 505, may interact with or make a request related to NFTs 510 interacting with such a blockchain. An NFT 510 in accordance with several embodiments of the invention may include many values including generalized data 511 (e.g. URLs), and pointers such as pointer A 512, pointer B 513, pointer C 514, and pointer D 515. In accordance with many embodiments of the invention, the generalized data 511 may be used to access corresponding rich media through the NFT 510. The NFT 510 may additionally have associated metadata 516.

Pointers within the NFT 510 may direct an inquiry toward a variety of on or off-ledger resources. In some embodiments of the invention, as illustrated FIG. 5A, pointer A 512 can direct the need for processing to the decentralized processing network 520. Processing systems are illustrated as CPU A, CPU B, CPU C, and CPU D 525. The CPUs 525 may be personal computers, server computers, mobile devices, edge IoT devices, etc. Pointer A may select one or more processors at random to perform the execution of a given smart contract. The code may be secure or nonsecure and the CPU may be a trusted execution environment (TEE), depending upon the needs of the request. In the example reflected in FIG. 5A, pointer B 513, pointer C 514, and pointer D 515 all point to a decentralized storage network 530 including remote off-ledger resources including storage systems illustrated as Disks A, B, C, and D 535.

The decentralized storage system may co-mingle with the decentralized processing system as the individual storage systems utilize CPU resources and connectivity to perform their function. From a functional perspective, the two decentralized systems may also be separate. Pointer B 513 may point to one or more decentralized storage networks 530 for the purposes of maintaining an off-chain log file of token activity and requests. Pointer C 514 may point to executable code within one or more decentralized storage networks 530. And Pointer D 515 may point to rights management data, security keys, and/or configuration data within one or more decentralized storage networks 530.

Dual blockchains may additionally incorporate methods for detection of abuse, essentially operating as a “bounty hunter” 550. FIG. 5B illustrates the inclusion of bounty hunters 550 within dual blockchain structures implemented in accordance with an embodiment of the invention. Bounty hunters 550 allow NFTs 510, which can point to networks that may include decentralized processing 520 and/or storage networks 530, to be monitored. The bounty hunter's 550 objective may be to locate incorrectly listed or missing data and executable code within the NFT 510 or associated networks. Additionally, the miner 540 can have the capacity to perform all necessary minting processes or any process within the architecture that involves a consensus mechanism.

Bounty hunters 550 may also choose to verify each step of a computation, and if they find an error, submit evidence of this in return for some reward. This can have the effect of invalidating the incorrect ledger entry and, potentially based on policies, all subsequent ledger entries. Such evidence can be submitted in a manner that is associated with a public key, in which the bounty hunter 550 proves knowledge of the error, thereby assigning value (namely the bounty) with the public key.

Assertions made by bounty hunters 550 may be provided directly to miners 540 by broadcasting the assertion. Assertions may be broadcast in a manner including, but not limited to posting it to a bulletin board. In some embodiments of the invention, assertions may be posted to ledgers of blockchains, for instance, the blockchain on which the miners 540 operate. If the evidence in question has not been submitted before, this can automatically invalidate the ledger entry that is proven wrong and provide the bounty hunter 550 with some benefit.

Applications and methods in accordance with various embodiments of the invention are not limited to use within NFT platforms. Accordingly, it should be appreciated that the capabilities of any blockchain configuration described herein can also be implemented outside the context of an NFT platform network architecture unrelated to the storage of fungible tokens and/or NFTs. A variety of components, mechanisms, and blockchain configurations that can be utilized within NFT platforms are discussed further below. Moreover, any of the blockchain configurations described herein with reference to FIGS. 3-5B (including permissioned, permissionless, and/or hybrid mechanisms) can be utilized within any of the networks implemented within the NFT platforms described above.

NFT Platform Consensus Mechanisms

NFT platforms in accordance with many embodiments of the invention can depend on consensus mechanisms to achieve agreement on network state, through proof resolution, to validate transactions. In accordance with many embodiments of the invention, Proof of Work (PoW) mechanisms may be used as a means of demonstrating non-trivial allocations of processing power. Proof of Space (PoS) mechanisms may be used as a means of demonstrating non-trivial allocations of memory or disk space. As a third possible approach, Proof of Stake mechanisms may be used as a means of demonstrating non-trivial allocations of fungible tokens and/or NFTs as a form of collateral. Numerous consensus mechanisms are possible in accordance with various embodiments of the invention, some of which are expounded on below.

Traditional mining schemes, such as Bitcoin, are based on Proof of Work, based on performing the aforementioned large computational tasks. The cost of such tasks may not only be computational effort, but also energy expenditure, a significant environmental concern. To address this problem, mining methods operating in accordance with many embodiments of the invention may instead operate using Proof of Space mechanisms to accomplish network consensus, wherein the distinguishing factor can be memory rather than processing power. Specifically, Proof of Space mechanisms can perform this through network optimization challenges. In several embodiments the network optimization challenge may be selected from any of a number of different challenges appropriate to the requirements of specific applications including graph pebbling. In some embodiments, graph pebbling may refer to a resource allocation game played on discrete mathematics graphs, ending with a labeled graph disclosing how a player might get at least one pebble to every vertex of the graph.

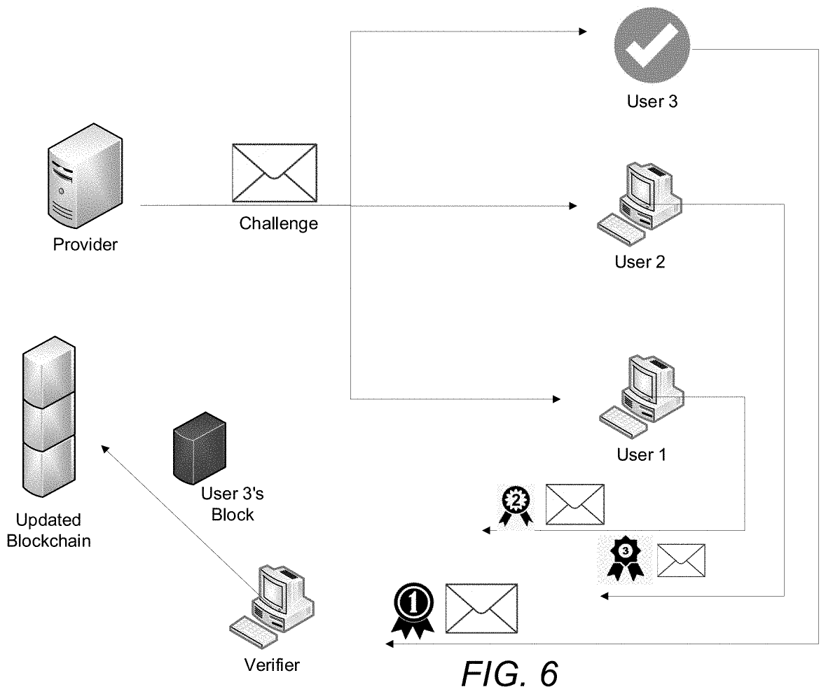

An example of Proof of Work consensus mechanisms that may be implemented in decentralized blockchains, in accordance with a number of embodiments of the invention, is conceptually illustrated in FIG. 6. The example disclosed in this figure is a challenge—response authentication, a protocol classification in which one party presents a complex problem (“challenge”) 610 and another party must broadcast a valid answer (“proof”) 620 to have clearance to add a block to the decentralized ledger that makes up the blockchain 630. As a number of miners may be competing to have this ability, there may be a need for determining factors for the addition to be added first, which in this case is processing power. Once an output is produced, verifiers 640 in the network can verify the proof, something which typically requires much less processing power, to determine the first device that would have the right to add the winning block 650 to the blockchain 630. As such, under a Proof of Work consensus mechanism, each miner involved can have a success probability proportional to the computational effort expended.

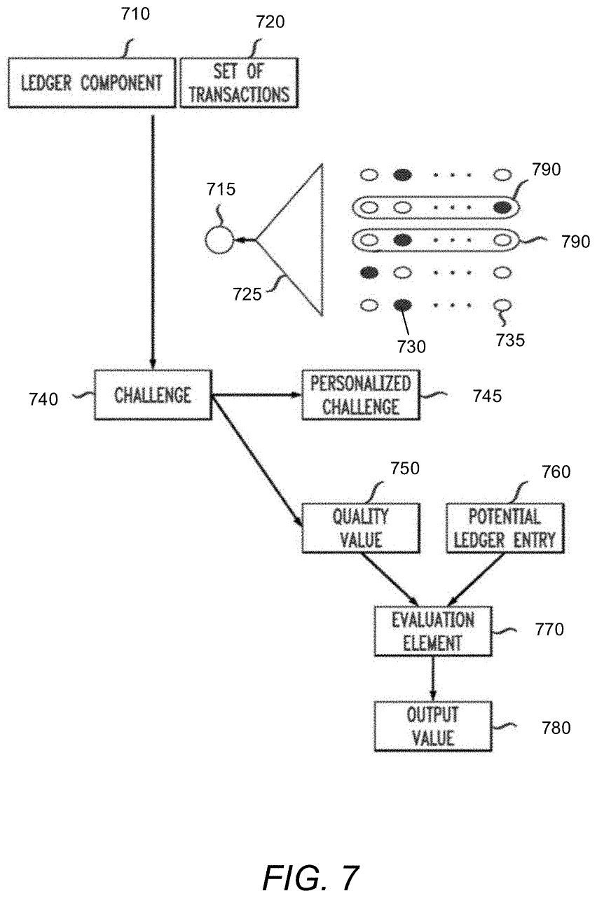

An example of Proof of Space implementations on devices in accordance with some embodiments of the invention is conceptually illustrated in FIG. 7. The implementation includes a ledger component 710, a set of transactions 720, and a challenge 740 computed from a portion of the ledger component 710. A representation 715 of a miner's state may also be recorded in the ledger component 710 and be publicly available.

In some embodiments, the material stored on the memory of the device includes a collection of nodes 730, 735, where nodes that depend on other nodes have values that are functions of the values of the associated nodes on which they depend. For example, functions may be one-way functions, such as cryptographic hash functions. In several embodiments the cryptographic hash function may be selected from any of a number of different cryptographic hash functions appropriate to the requirements of specific applications including (but not limited to) the SHA1 cryptographic hash function. In such an example, one node in the network may be a function of three other nodes. Moreover, the node may be computed by concatenating the values associated with these three nodes and applying the cryptographic hash function, assigning the result of the computation to the node depending on these three parent nodes. In this example, the nodes are arranged in rows, where two rows 790 are shown. The nodes are stored by the miner, and can be used to compute values at a setup time. This can be done using Merkle tree hash-based data structures 725, or another structure such as a compression function and/or a hash function.

Challenges 740 may be processed by the miner to obtain personalized challenges 745, made to the device according to the miner's storage capacity. The personalized challenge 745 can be the same or have a negligible change, but could also undergo an adjustment to account for the storage space accessible by the miner, as represented by the nodes the miner stores. For example, when the miner does not have a large amount of storage available or designated for use with the Proof of Space system, a personalized challenge 745 may adjust challenges 740 to take this into consideration, thereby making a personalized challenge 745 suitable for the miner's memory configuration.

In some embodiments, the personalized challenge 745 can indicate a selection of nodes 730, denoted in FIG. 7 by filled-in circles. In the FIG. 7 example specifically, the personalized challenge corresponds to one node per row. The collection of nodes selected as a result of computing the personalized challenge 745 can correspond to a valid potential ledger entry 760. However, here a quality value 750 (also referred to herein as a qualifying function value) can also be computed from the challenge 740, or from other public information that is preferably not under the control of any one miner.

A miner may perform matching evaluations 770 to determine whether the set of selected nodes 730 matches the quality value 750. This process can take into consideration what the memory constraints of the miner are, causing the evaluation 770 to succeed with a greater frequency for larger memory configurations than for smaller memory configurations. This can simultaneously level the playing field to make the likelihood of the evaluation 770 succeeding roughly proportional to the size of the memory used to store the nodes used by the miner. In some embodiments, non-proportional relationships may be created by modifying the function used to compute the quality value 750. When the evaluation 770 results in success, then the output value 780 may be used to confirm the suitability of the memory configuration and validate the corresponding transaction.

In many embodiments, nodes 730 and 735 can also operate as public keys. The miner may submit valid ledger entries, corresponding to a challenge-response pair including one of these nodes. In that case, public key values can become associated with the obtained NFT. As such, miners can use a corresponding secret/private key to sign transaction requests, such as purchases. Additionally, any type of digital signature can be used in this context, such as RSA signatures, Merkle signatures, DSS signatures, etc. Further, the nodes 730 and 735 may correspond to different public keys or to the same public key, the latter preferably augmented with a counter and/or other location indicator such as a matrix position indicator, as described above. Location indicators in accordance with many embodiments of the invention may be applied to point to locations within a given ledger. In accordance with some embodiments of the invention, numerous Proof of Space consensus configurations are possible, some of which are discussed below.

Hybrid methods of evaluating Proof of Space problems can also be implemented in accordance with many embodiments of the invention. In many embodiments, hybrid methods can be utilized that conceptually correspond to modifications of Proof of Space protocols in which extra effort is expanded to increase the probability of success, or to compress the amount of space that may be applied to the challenge. Both come at a cost of computational effort, thereby allowing miners to improve their odds of winning by spending greater computational effort. Accordingly, in many embodiments of the invention dual proof-based systems may be used to reduce said computational effort. Such systems may be applied to Proof of Work and Proof of Space schemes, as well as to any other type of mining-based scheme.

When utilizing dual proofs in accordance with various embodiments of the invention, the constituent proofs may have varying structures. For example, one may be based on Proof of Work, another on Proof of Space, and a third may be a system that relies on a trusted organization for controlling the operation, as opposed to relying on mining for the closing of ledgers. Yet other proof structures can be combined in this way. The result of the combination will inherit properties of its components. In many embodiments, the hybrid mechanism may incorporate a first and a second consensus mechanism. In several embodiments, the hybrid mechanism includes a first, a second, and a third consensus mechanisms. In a number of embodiments, the hybrid mechanism includes more than three consensus mechanisms. Any of these embodiments can utilize consensus mechanisms selected from the group including (but not limited to) Proof of Work, Proof of Space, and Proof of Stake without departing from the scope of the invention. Depending on how each component system is parametrized, different aspects of the inherited properties will dominate over other aspects.

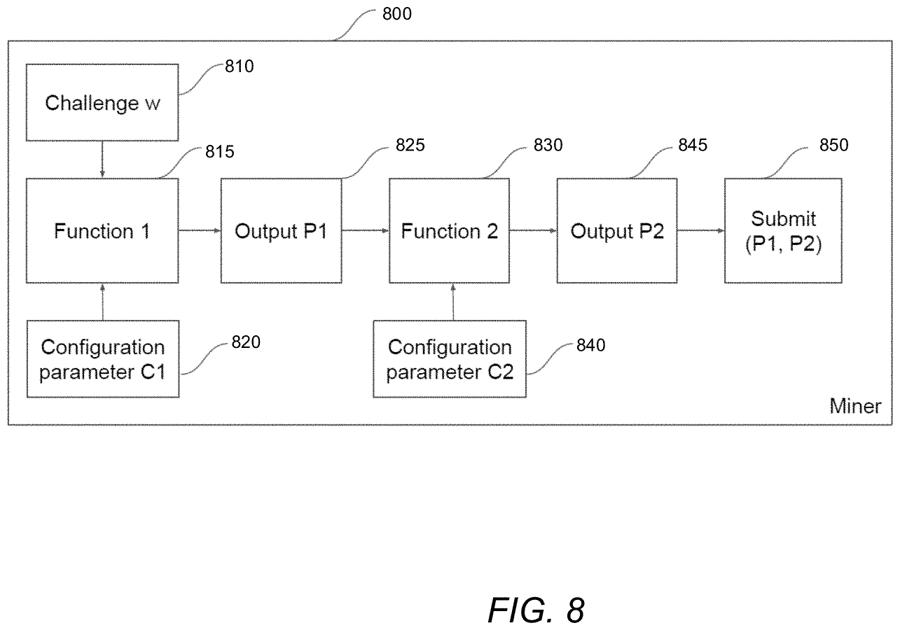

Dual proof configurations in accordance with a number of embodiments of the invention is illustrated in FIG. 8. A proof configuration in accordance with some embodiments of the invention may tend to use the notion of quality functions for tie-breaking among multiple competing correct proofs relative to a given challenge (w) 810. This classification of proof can be described as a qualitative proof, inclusive of proofs of work and proofs of space. In the example reflected in FIG. 8, proofs P1 and P2 are each one of a Proof of Work, Proof of Space, Proof of Stake, and/or any other proof related to a constrained resource, wherein P2 may be of a different type than P1, or may be of the same type.

Systems in accordance with many embodiments of the invention may introduce the notion of a qualifying proof, which, unlike qualitative proofs, are either valid or not valid, using no tie-breaking mechanism. Said systems may include a combination of one or more qualitative proofs and one or more qualifying proofs. For example, it may use one qualitative proof that is combined with one qualifying proof, where the qualifying proof is performed conditional on the successful creation of a qualitative proof. FIG. 8 illustrates challenge w 810, as described above, with a function 1 815, which is a qualitative function, and function 2 830, which is a qualifying function.

To stop miners from expending effort after a certain amount of effort has been spent, thereby reducing the environmental impact of mining, systems in accordance with a number of embodiments of the invention can constrain the search space for the mining effort. This can be done using a configuration parameter that controls the range of random or pseudo-random numbers that can be used in a proof. Upon challenge w 810 being issued to one or more miners 800, it can be input to Function 1 815 along with configuration parameter C1 820. Function 1 815 may output proof P1 825, in this example the qualifying proof to Function 2 830. Function 2 830 is also provided with configuration parameter C2 840 and computes qualifying proof P2 845. The miner 800 can then submit the combination of proofs (P1, P2) 850 to a verifier, in order to validate a ledger associated with challenge w 810. In some embodiments, miner 800 can also submit the proofs (P1, P2) 850 to be accessed by a 3rd-party verifier.

NFT platforms in accordance with many embodiments of the invention may additionally benefit from alternative energy-efficient consensus mechanisms. Therefore, computer systems in accordance with several embodiments of the invention may instead use consensus-based methods alongside or in place of proof-of-space and proof-of-space based mining. In particular, consensus mechanisms based instead on the existence of a Trusted Execution Environment (TEE), such as ARM TRUSTZONE or INTEL SGX may provide assurances exist of integrity by virtue of incorporating private/isolated processing environments.

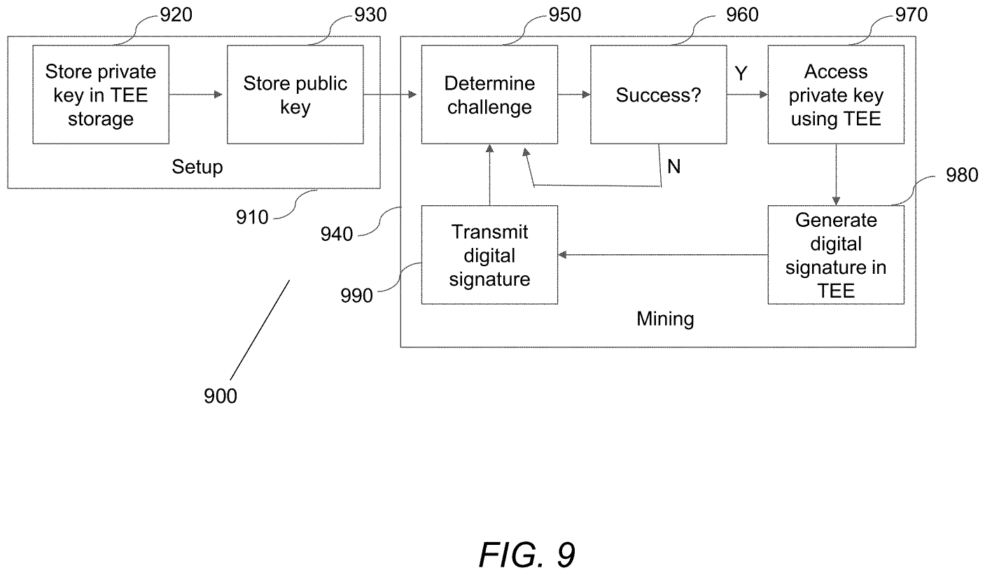

An illustration of sample process 900 undergone by TEE-based consensus mechanisms in accordance with some embodiments of the invention is depicted in FIG. 9. In some such configurations, a setup 910 may be performed by an original equipment manufacturer (OEM) or a party performing configurations of equipment provided by an OEM. Once a private key/public key pair is generated in the secure environment, process 900 may store (920) the private key in TEE storage (i.e. storage associated with the Trusted Execution Environment). While storage may be accessible from the TEE, it can be shielded from applications running outside the TEE. Additionally, processes can store (930) the public key associated with the TEE in any storage associated with the device containing the TEE. Unlike the private key, the public key may also be accessible from applications outside the TEE. In a number of embodiments, the public key may also be certified. Certification may come from OEMs or trusted entities associated with the OEMs, wherein the certificate can be stored with the public key.

In many embodiments of the invention, mining-directed steps can also be influenced by the TEE. In the illustrated embodiment, the process 900 can determine (950) a challenge. For example, this may be by computing a hash of the contents of a ledger. In doing so, process 900 may also determine whether the challenge corresponds to success 960. In some embodiments of the invention, the determination of success may result from some pre-set portion of the challenge matching a pre-set portion of the public key, e.g. the last 20 bits of the two values matching. In several embodiments the success determination mechanism may be selected from any of a number of alternate approaches appropriate to the requirements of specific applications. The matching conditions may also be modified over time. For example, modification may result from an announcement from a trusted party or based on a determination of a number of participants having reached a threshold value.

When the challenge does not correspond to a success 960, process 900 can return to determine (950) a new challenge. In this context, process 900 can determine (950) a new challenge after the ledger contents have been updated and/or a time-based observation is performed. In several embodiments the determination of a new challenge may come from any of a number of approaches appropriate to the requirements of specific applications, including, but not limited to, the observation of as a second elapsing since the last challenge. If the challenge corresponds to a success 960, then the processing can continue on to access (970) the private key using the TEE.

When the private key is accessed, process can generate (980) a digital signature using the TEE. The digital signature may be on a message that includes the challenge and/or on a message which otherwise references the ledger entry being closed. Process 900 can also transmit (980) the digital signature to other participants implementing the consensus mechanism. In cases where multiple digital signatures are received and found to be valid, a tie-breaking mechanism can be used to evaluate the consensus. For example, one possible tie-breaking mechanism may be to select the winner as the party with the digital signature that represents the smallest numerical value when interpreted as a number. In several embodiments the tie-breaking mechanism may be selected from any of a number of alternate tie-breaking mechanisms appropriate to the requirements of specific applications.

Applications and methods in accordance with various embodiments of the invention are not limited to use within NFT platforms. Accordingly, it should be appreciated that consensus mechanisms described herein can also be implemented outside the context of an NFT platform network architecture unrelated to the storage of fungible tokens and/or NFTs. Moreover, any of the consensus mechanisms described herein with reference to FIGS. 6-9 (including Proof of Work, Proof of Space, proof of stake, and/or hybrid mechanisms) can be utilized within any of the blockchains implemented within the NFT platforms described above with reference to FIGS. 3-5B. Various systems and methods for implementing NFT platforms and applications in accordance with numerous embodiments of the invention are discussed further below.

### NFT Platform Constituent Devices and Applications

A variety of computer systems that can be utilized within NFT platforms and systems that utilize NFT blockchains in accordance with various embodiments of the invention are illustrated below. The computer systems in accordance with many embodiments of the invention may implement a processing system 1010, 1120, 1220 using one or more CPUs, GPUs, ASICs, FPGAs, and/or any of a variety of other devices and/or combinations of devices that are typically utilized to perform digital computations. As can readily be appreciated each of these computer systems can be implemented using one or more of any of a variety of classes of computing devices including (but not limited to) mobile phone handsets, tablet computers, laptop computers, personal computers, gaming consoles, televisions, set top boxes and/or other classes of computing device.

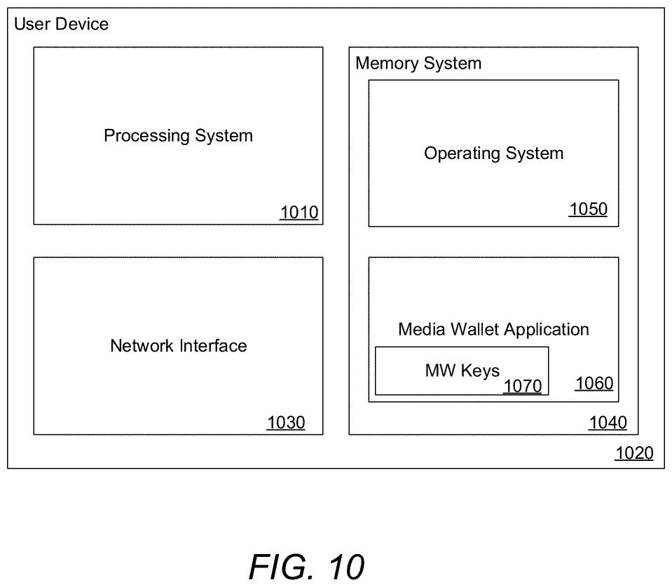

A user device capable of communicating with an NFT platform in accordance with an embodiment of the invention is illustrated in FIG. 10. The memory system 1040 of particular user devices may include an operating system 1050 and media wallet applications 1060. Media wallet applications may include sets of media wallet (MW) keys 1070 that can include public key/private key pairs. The set of MW keys may be used by the media wallet application to perform a variety of actions including, but not limited to, encrypting and signing data. In many embodiments, the media wallet application enables the user device to obtain and conduct transactions with respect to NFTs by communicating with an NFT blockchain via the network interface 1030. In some embodiments, the media wallet applications are capable of enabling the purchase of NFTs using fungible tokens via at least one distributed exchange. User devices may implement some or all of the various functions described above with reference to media wallet applications as appropriate to the requirements of a given application in accordance with various embodiments of the invention.

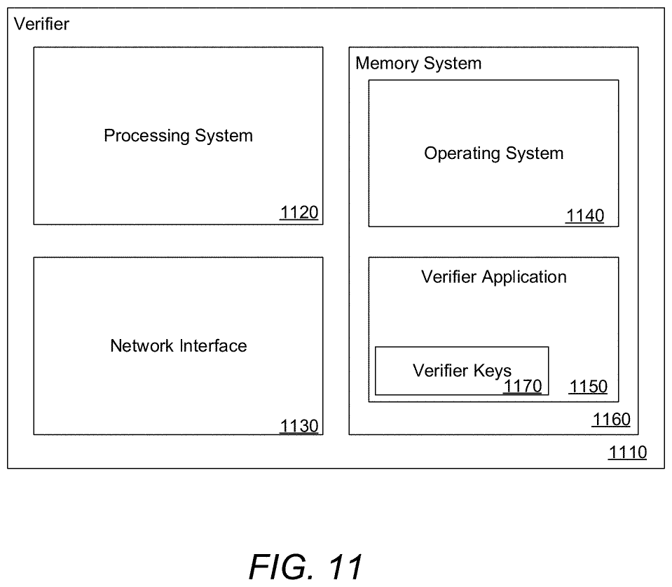

A verifier 1110 capable of verifying blockchain transactions in an NFT platform in accordance with many embodiments of the invention is illustrated in FIG. 11. The memory system 1160 of the verifier computer system includes an operating system 1140 and a verifier application 1150 that enables the verifier 1110 computer system to access a decentralized blockchain in accordance with various embodiments of the invention. Accordingly, the verifier application 1150 may utilize a set of verifier keys 1170 to affirm blockchain entries. When blockchain entries can be verified, the verifier application 1150 may transmit blocks to the corresponding blockchains. The verifier application 1150 can also implement some or all of the various functions described above with reference to verifiers as appropriate to the requirements of a given application in accordance with various embodiments of the invention.

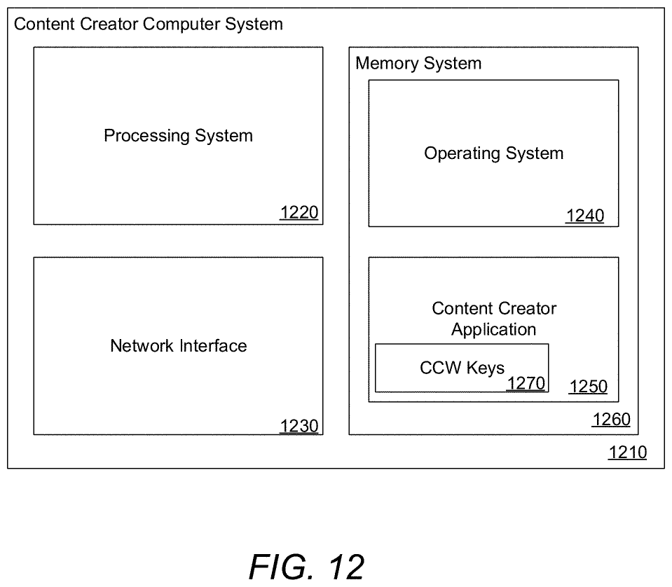

A content creator system 1210 capable of disseminating content in an NFT platform in accordance with an embodiment of the invention is illustrated in FIG. 12. The memory system 1260 of the content creator computer system may include an operating system 1240 and a content creator application 1250. The content creator application 1250 may enable the content creator computer system to mint NFTs by writing smart contracts to blockchains via the network interface 1230. The content creator application can include sets of content creator wallet (CCW) keys 1270 that can include a public key/private key pairs. Content creator applications may use these keys to sign NFTs minted by the content creator application. The content creator application can also implement some or all of the various functions described above with reference to content creators as appropriate to the requirements of a given application in accordance with various embodiments of the invention.

Computer systems in accordance with many embodiments of the invention incorporate digital wallets (herein also referred to as “wallets” or “media wallets”) for NFT and/or fungible token storage. In several embodiments, the digital wallet may securely store rich media NFTs and/or other tokens. Additionally, in some embodiments, the digital wallet may display user interface through which user instructions concerning data access permissions can be received.

In a number of embodiments of the invention, digital wallets may be used to store at least one type of token-directed content. Example content types may include, but are not limited to crypto currencies of one or more sorts; non-fungible tokens; and user profile data.

Example user profile data may incorporate logs of user actions. In accordance with some embodiments of the invention, example anonymized user profile data may include redacted, encrypted, and/or otherwise obfuscated user data. User profile data in accordance with some embodiments may include, but are not limited to, information related to classifications of interests, determinations of a post-advertisement purchases, and/or characterizations of wallet contents.

Media wallets, when storing content, may store direct references to content. Media wallets may also reference content through keys to decrypt and/or access the content. Media wallets may use such keys to additionally access metadata associated with the content. Example metadata may include, but is not limited to, classifications of content. In a number of embodiments, the classification metadata may govern access rights of other parties related to the content.

Access governance rights may include, but are not limited to, whether a party can indicate their relationship with the wallet; whether they can read summary data associated with the content; whether they have access to peruse the content; whether they can place bids to purchase the content; whether they can borrow the content, and/or whether they are biometrically authenticated.

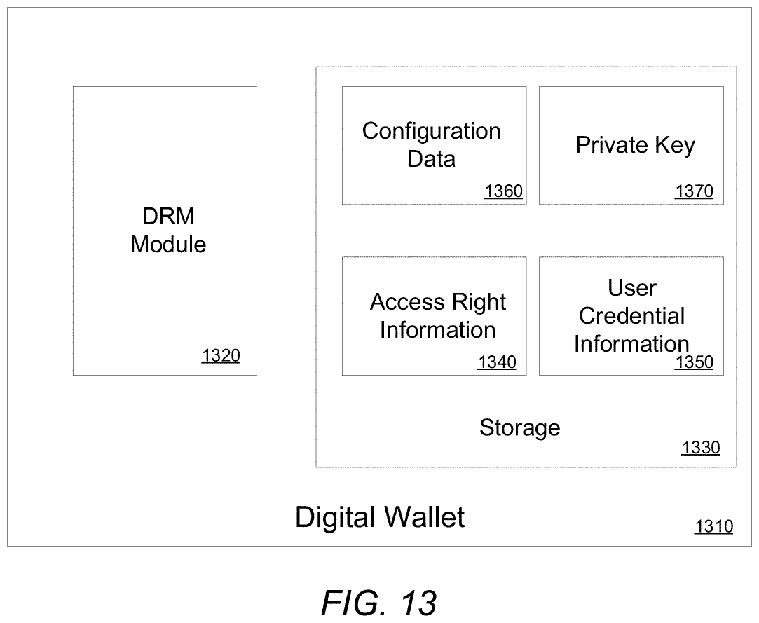

An example of a media wallet 1310 capable of storing rich media NFTs in accordance with an embodiment of the invention is illustrated in FIG. 13. Media wallets 1310 may include a storage component 1330, including access right information 1340, user credential information 1350, token configuration data 1360, and/or at least one private key 1370. In accordance with many embodiments of the invention, a private key 1370 may be used to perform a plurality of actions on resources, including but not limited to decrypting NFT and/or fungible token content. Media wallets may also correspond to a public key, referred to as a wallet address. An action performed by private keys 1370 may be used to prove access rights to digital rights management modules. Additionally, private keys 1370 may be applied to initiating ownership transfers and granting NFT and/or fungible token access to alternate wallets. In accordance with some embodiments, access right information 1340 may include lists of elements that the wallet 1310 has access to. Access right information 1340 may also express the type of access provided to the wallet. Sample types of access include, but are not limited to, the right to transfer NFT and/or fungible ownership, the right to play rich media associated with a given NFT, and the right to use an NFT and/or fungible token. Different rights may be governed by different cryptographic keys. Additionally, the access right information 1340 associated with a given wallet 1310 may utilize user credential information 1350 from the party providing access.

In accordance with many embodiments of the invention, third parties initiating actions corresponding to requesting access to a given NFT may require user credential information 1350 of the party providing access to be verified. User credential information 1350 may be taken from the group including, but not limited to, a digital signature, hashed passwords, PINs, and biometric credentials. User credential information 1350 may be stored in a manner accessible only to approved devices. In accordance with some embodiments of the invention, user credential information 1350 may be encrypted using a decryption key held by trusted hardware, such as a trusted execution environment. Upon verification, user credential information 1350 may be used to authenticate wallet access.

Available access rights may be determined by digital rights management (DRM) modules 1320 of wallets 1310. In the context of rich media, encryption may be used to secure content. As such, DRM systems may refer to technologies that control the distribution and use of keys required to decrypt and access content. DRM systems in accordance with a number of embodiments of the invention may enable the display and consumption of content from a plurality of sources. DRM systems in accordance with many embodiments of the invention may require a trusted execution zone. Additionally, said systems may require one or more keys (typically a certificate containing a public key/private key pair) that can be used to communicate with and register with DRM servers. DRM modules 1320 in some embodiments may also use one or more keys to communicate with a DRM server. In several embodiments, the DRM modules 1320 may include code used for performing sensitive transactions for wallets including, but not limited to, content access. In accordance with a number of embodiments of the invention, the DRM module 1320 may execute in a Trusted Execution Environment. In a number of embodiments, the DRM may be facilitated by an Operating System (OS) that enables separation of processes and processing storage from other processes and their processing storage.

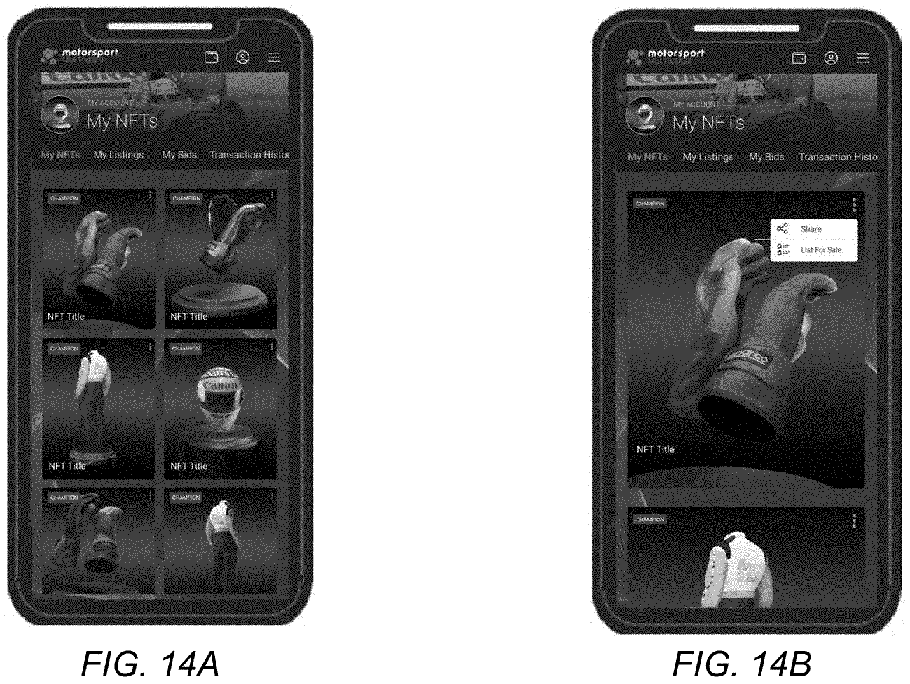

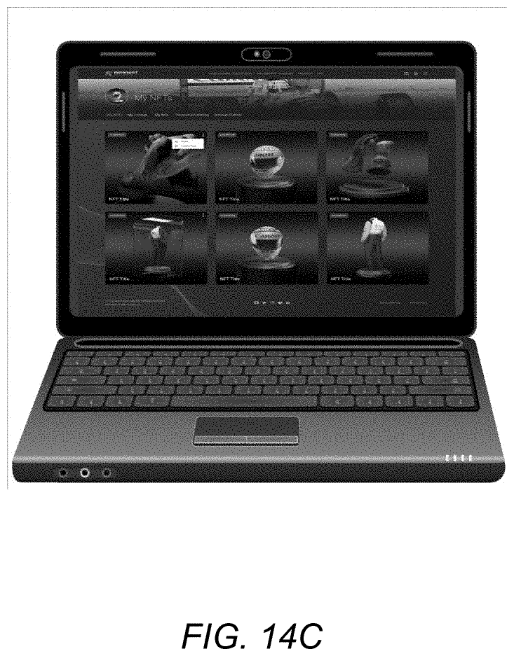

Operation of media wallet applications implemented in accordance with some embodiments of the invention is conceptually illustrated by way of the user interfaces shown in FIGS. 14A-14C. In many embodiments, media wallet applications can refer to applications that are installed upon user devices such as (but not limited to) mobile phones and tablet computers running the iOS, Android and/or similar operating systems. Launching media wallet applications can provide a number of user interface contexts. In many embodiments, transitions between these user interface contexts can be initiated in response to gestures including (but not limited to) swipe gestures received via a touch user interface. As can readily be appreciated, the specific manner in which user interfaces operate through media wallet applications is largely dependent upon the user input capabilities of the underlying user device. In several embodiments, a first user interface context is a dashboard (see, FIGS. 14A, 14C) that can include a gallery view of NFTs owned by the user. In several embodiments, the NFT listings can be organized into category index cards. Category index cards may include, but are not limited to digital merchandise/collectibles, special event access/digital tickets, fan leaderboards. In certain embodiments, a second user interface context (see, for example, FIG. 14B) may display individual NFTs. In a number of embodiments, each NFT can be main-staged in said display with its status and relevant information shown. Users can swipe through each collectible and interacting with the user interface can launch a collectible user interface enabling greater interaction with a particular collectible in a manner that can be determined based upon the smart contract underlying the NFT.

Media wallet applications in accordance with various embodiments of the invention are not limited to use within NFT platforms. Accordingly, it should be appreciated that applications described herein can also be implemented outside the context of an NFT platform network architecture unrelated to the storage of fungible tokens and/or NFTs. Moreover, any of the computer systems described herein with reference to FIGS. 10-14C can be utilized within any of the NFT platforms described above.

### NFT Platform NFT Interactions

NFT platforms in accordance with many embodiments of the invention may incorporate a wide variety of rich media NFT configurations. The term “Rich Media Non-Fungible Tokens” can be used to refer to blockchain-based cryptographic tokens created with respect to a specific piece of rich media content and which incorporate programmatically defined digital rights management. In some embodiments of the invention, each NFT may have a unique serial number and be associated with a smart contract defining an interface that enables the NFT to be managed, owned and/or traded.

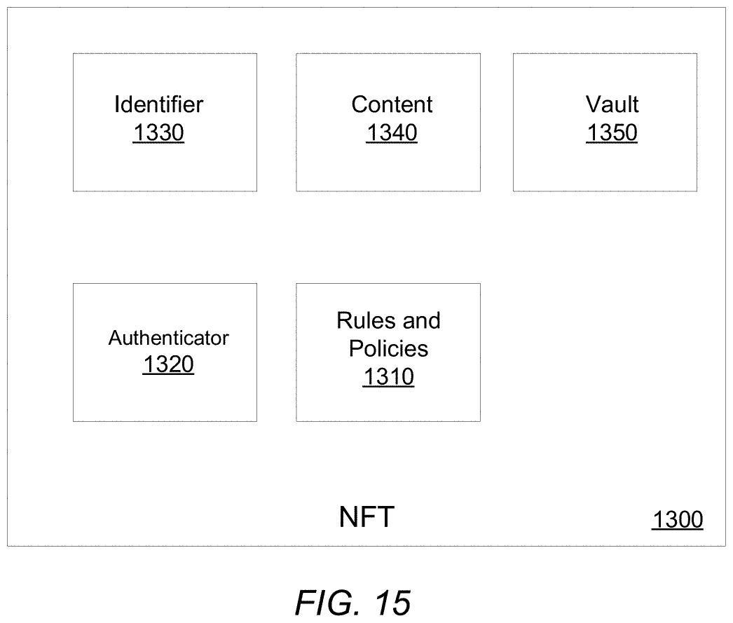

An example NFT which may be associated with specific content in accordance with several embodiments of the invention is illustrated in FIG. 15. In some embodiments, an NFT 1500 may utilize a vault 1550, which may control access to external data storage areas. Methods of controlling access may include, but are not limited to, user credential information. In accordance with a number of embodiments of the invention, control access may be managed through encrypting content 1540. As such, NFTs 1500 can incorporate content 1540, which may be encrypted, not encrypted, yet otherwise accessible, or encrypted in part. In accordance with some embodiments, an NFT 1500 may be associated with one or more content 1540 elements, which may be contained in or referenced by the NFT. A content 1540 element may include, but is not limited to, an image, an audio file, a script, a biometric user identifier, and/or data derived from an alternative source. An example alternative source may be a hash of biometric information). An NFT 1500 may also include an authenticator 1520 capable of affirming that specific NFTs are valid.

In accordance with many embodiments of the invention, NFTs may include a number of rules and policies 1510. Rules and policies 1510 may include, but are not limited to access rights information. In some embodiments, rules and policies 1510 may also state terms of usage, royalty requirements, and/or transfer restrictions. An NFT 1500 may also include an identifier 1530 to affirm ownership status. In accordance with many embodiments of the invention, ownership status may be expressed by linking the identifier 1530 to an address associated with a blockchain entry.

In accordance with a number of embodiments of the invention, NFTs may represent static creative content. NFTs may also be representative of dynamic creative content, which changes over time. In accordance with many examples of the invention, the content associated with an NFT may be a digital content element.

One example of a digital content element in accordance with some embodiments may be a set of five images of a mouse. In this example, the first image may be an image of the mouse being alive. The second may be an image of the mouse eating poison. The third may be an image of the mouse not feeling well. The fourth image may be of the mouse, dead. The fifth image may be of a decaying mouse.

The user credential information of an NFT may associate each image to an identity, such as of the artist. In accordance with a number of embodiments of the invention, NFT digital content can correspond to transitions from one representation (e.g., an image of the mouse, being alive) to another representation (e.g., of the mouse eating poison). In this disclosure, digital content transitioning from one representation to another may be referred to as a state change and/or an evolution. In a number of embodiments, an evolution may be triggered by the artist, by an event associated with the owner of the artwork, randomly, and/or by an external event.

When NFTs representing digital content are acquired in accordance with some embodiments of the invention, they may also be associated with the transfer of corresponding physical artwork, and/or the rights to said artwork. The first ownership records for NFTs may correspond to when the NFT was minted, at which time its ownership can be assigned to the content creator. Additionally, in the case of “lazy” minting, rights may be directly assigned to a buyer.

While specific configurations are described above with reference to FIG. 15, NFTs can be implemented in any of a number of different ways to enable as appropriate to the requirements of specific applications in accordance with various embodiments of the invention. Additionally, the specific manner in which NFTs can be utilized within NFT platforms in accordance with various embodiments of the invention is largely dependent upon the requirements of a given application.

### NFT Platform Collaboration

NFT platforms in accordance with many embodiments of the invention may implement collaboration systems directed to facilitating collaborative content creation. Current systems lack tools for enabling collaboration among artists that do not rely on already-established trust and use traditional methods of sharing data. It is often difficult to enable remote collaboration with limited trust requirements, which can hold back creative efforts, especially collaboration involving not-yet-discovered artists, which makes up the greatest portion of the population of artists.

In some embodiments of the invention, collaborative content creation may utilize a user interface in order to enable the creation of NFTs. Certain methods for collaborative generation of non-fungible tokens (NFTs) and associated content may enable recording artists to contribute to other artists' projects of a range of types in a straightforward manner.

A. Collaboration Between Content Creators

Collaboration systems in accordance with numerous embodiments of the invention may incorporate user interfaces (UIs) for collaboration between creators. For example, a collaboration UI may allow a first content creator to produce and/or upload content and to select one or more second content creators for a collaboration. This selection may be made from a list of potentially available content creators. In a number of embodiments, content creators may be presented and selected from based on various factors including, but not limited to, budget, genre, possible content creators, etc.

In certain embodiments, collaboration UIs may allow content creators to provide and/or agree to terms governing their collaboration. Collaboration UIs may allow a content creator to express what they can request from any of the selected content creators. For example, a content creator may request that one or more of the selected second content creators generate a version of the content from the first content creator. Requests may be specific, e.g., “please play this on the piano”, “please sing this in a sad manner.” Requests may also be less specific, e.g., “please perform this in a way that you like”.

In a variety of embodiments, multiple methods of expressing requests may be incorporated into the UI. Requests in accordance with several embodiments of the invention may be provided using free-form text entry capabilities on the UI. Requests may also be made by the first content creator selecting from one or more options that have been provided by particular second content creators.

After the first content creator submits their request, selected content creators may be notified that they have been selected. Notification may come in various forms, such as (but not limited to), a message, an email, an SMS, etc. Additionally, and/or alternatively, selected content creators may be provided with a list of pending requests upon logging in to the system.

Collaboration UIs in accordance with numerous embodiments of the invention may filter requests based on available actions for the selected second content creators. In a number of embodiments, the list of available second content creators may change according to the first content creator's expressed need. For example, if the first content creator has indicated that they want something played on a ukulele, then only selected content creators who can fulfill this request may see the request. In this example, that group may include second content creators who can play the ukulele and have indicated this during a configuration phase.

In many embodiments, collaboration UIs may also filter requests based on terms. Terms in accordance with many embodiments of the invention can include (but are not limited to) prices, schedules, skillsets, distribution rights, royalty amounts, etc. For example, a first content creator may be willing to pay up to $100 for the fulfillment of a given request. This request may not be seen by a second content creator whose minimum payment may be set at $150. Terms in accordance with a variety of embodiments of the invention can correspond to the distribution rights of the generated content. For example, a first user may intend to generate up to 10 identical and/or related NFTs based on the generated content. In doing so, their terms may require the right to sell these with a maximum royalty payment of 5% going to the second content creator. If so, a content creator who requires at least a 10% royalty may not see this request. A second content creator that requires that at most 4 NFTs can be generated from content made by them also may not see the request.

In a variety of embodiments, content creators may be able to see, before submitting the request, how many potential matches there are. Potential matches may correspond to the maximum number of second content creators that may see the request. Potential matches may provide an indication to the first content creator regarding whether the request is likely to be successfully completed. In several embodiments, machine learning (ML) elements may be used to determine at least one of a probability of success and an estimated time of completion. These determinations may be based on factors including, but not limited to, the number of matching content creators, the number of pending requests to these content creators, and/or the typical throughput of the content creators.

In some embodiments, collaboration UIs may allow first content creators to rate their satisfaction with content delivered from second content creators. In doing so, second content creators may be associated with a rating of satisfaction. As an example, the satisfaction rating may range from 1 to 10, where 1 is not satisfied at all and 10 is extremely satisfied. In a number of embodiments, second content creators may have an average score of satisfaction associated with their work. In numerous embodiments, satisfaction scores can be displayed to a first content creator when selecting a second content creator. Alternatively or additionally, only second content creators having a score over a certain threshold level may be presented to the first content creator.

In several embodiments, satisfaction scores (or ratings) may affect the eventual compensation due collaborators. In a number of embodiments, a second content creator may have the possibility to rate the first content creator after their collaboration. For example, the work requested by the first content creator, to be performed by the second content creator, may involve some sort of compensation upon completion and the first content creator may contest the work, refusing to pay/compensate. The refusal may mean the first content creator does not pay and/or compensate according to the request. The first content creator may also end up being late with the payment/compensation. These actions may thereby influence the first content creator's rating.

Collaboration systems in accordance with several embodiments of the invention may keep track of the actions of a first content creator upon receiving the completion of the work requested by the first content creator. Said actions may include, but are not limited to, ratings given by the first content creator, fulfillment of any duties towards a second content creator as indicated in the request, etc. In a number of embodiments, collaboration systems may be operated by a service provider offering a collaboration UI. In numerous embodiments, first content providers who are likely to be very critical about the work received by second content creators may be identified and given a rating by the system.

Second content creators may view requests that are still available. A still-available request may refer to requests still rendered in a UI. If a second content creator decides to respond to the request, they can indicate an acceptance. An example acceptance may be clicking on a “commit” button. As soon as this is done, the request may be made unavailable to other selected content creators. Alternatively, if the first content creator has indicated that they wish to have multiple responses, requests may be available until a threshold is met. For example, the first content creator may be open to receive up to four responses.

In some embodiments, after a content creator has indicated acceptance, they may have a given period of time to generate the promised content (i.e. response). This period may be associated with terms expressed by the first content creator and/or be part of terms configured by the second content creator. The second content creator may, in a window of the UI, have a list of tasks they have committed to. The list of tasks may be sorted based on a criterion. Example criteria may include, but are not limited to: the order in which requests were committed to, the size of the payment to be obtained, how long it was since the requests were generated, etc. Task lists may also be custom sorted according to priority. In several embodiments, task lists may be partitioned into different subportions based on the nature of the task. For example, a first subportion may include all tasks that must involve a piano in one list, a second subportion may include all tasks that must involve vocalization, and a third subportion may include all tasks that could involve either a piano and/or vocalization can be listed in a third list.

As soon as a task is completed, this task can be removed from any list it was on. For example, if a task requires both a piano and a vocalization, then it may be taken off the piano list, but not the vocalization list, as soon as the piano recording has been completed. In a number of embodiments, partially completed tasks may be indicated in the UI. For example, partially completed tasks may be listed using a different color. Partially completed tasks may also be given a higher priority by the content creator. High-priority tasks may be shown higher up on the lists on which they remain.

After a second content creator generates content in response to a request, this content may be sent to the requesting party (the first content creator) and compensation may be determined. The requesting party may be given some amount of time (e.g., 48 hours) to object to a payment being made to the second content contributor. Multiple reasons may be the basis for an objection to payment, including (but not limited to) a failure to deliver content in line with the request. The requesting party may also approve the content if they have no objection.

When the requesting party approves the content and/or the time given to lodge complaints lapses, collaboration systems in accordance with certain embodiments of the invention may generate certifications of the content. Certifications in accordance with certain embodiments of the invention may provide verifiable evidence that the content was created by the second content creator. In many embodiments, certifications may include one or more components, such as, but not limited to, a file of content, a reference to a file of content, a unique identifier of the second content creator, and/or proof of the association between the content and the identifier. For example, a vocalization by a famous singer may be represented by an information package including elements Au, Id, Pf. Au may represent an audio file. Id may be a public key. Pf may be a digital signature on Au, where the digital signature can be verified using the public key of the party identified by Id.

In some embodiments, certifications may be encoded in a certification NFT. In a variety of embodiments, certification NFTs can be used as one of potentially several inputs to the generation of a derived NFT. Derived NFTs in accordance with a variety of embodiments of the invention can be derived from a combination of different types of NFTs, such as (but not limited to) certification NFTs, policy NFTs, rules NFTs, term NFTs, DRM NFTs, etc. For example, certifications (or certification NFTs) may be governed by a policy T. T may act as terms for the usage of the associated data. T may include, but is not limited to, a specification of how many NFTs may be generated from the content, how many versions of different NFTs may be created, and/or whether the second content creator should receive royalties from the sale of NFTs generated from the content associated with the certification. In such an example, the certification NFT and the policy NFT may be used to generate a derived NFT to implement policy T on the certification.

First content creators may also generate additional requests for second content creators. Additional requests may be to the same content creator that responded to previous requests. Additional requests in accordance with certain embodiments of the invention may include prior responses, parts of prior responses, and/or modifications of prior responses. This may allow a first content creator to iteratively build content by requesting additional contributions from second content creators. First content creators may also add content to the content descriptions that make up the requests. Upon receiving additional responses to such requests, first content creators may modify and/or combine the responses. Examples of modifications may include (but are not limited to) stretching content responses; increasing and/or decreasing the volume, pitch, treble, etc., of content responses; overlaying content responses and modified content responses with each other; and/or adding other effects, audio elements, synchronizations, etc.

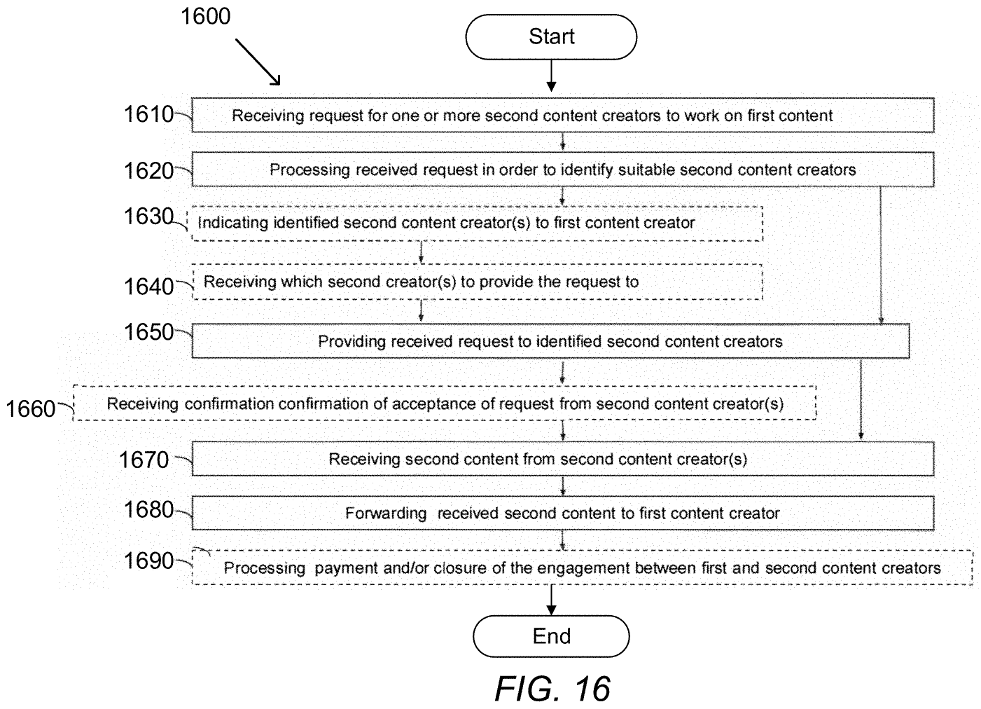

A flowchart exemplifying a process for providing an engagement between a first content creator and a second content creator in accordance with an embodiment of the invention is illustrated in FIG. 16. Such processes may be performed by a device (e.g., a node, server and/or computer arrangement). Devices may include input/output means by which the device may receive information and transmit and/or provide information to other units, devices, and/or entities. The device may also include processing means and memory means, the memory means storing instructions for the processing means.

Process 1600 receives (1610) a request for one or more second content creators to work on a first content, the request being received from a device of a first content creator. As described above, requests may include content and a description of what the first creator wishes one or more second creators to do with the content. For example, the content may be a song and the description may be “please play this on the piano”, and/or “please sing this in a sad manner.” In various embodiments, requests may relate to technical problems. For example, the content may be a CAD-drawing of a basic design of a surgical tool and the request may be “modify this tool to be suitable for surgery of type X”.

Process 1600 processes (1620) the received request in order to identify second content creators suitable for working on the first content. For example, processes may identify second users based on their user profiles listing their respective different skills. Process 1600 provides (1650) the received request to the identified second content creators. In this manner, one or more second content creators may be presented with the request from the first content creator. Presented requests in accordance with certain embodiments of the invention may include the content and the description of what the first content creator wants the one or more second content creators to do with the content in the request. This may give the one or more second content creators an option to accept the request and engage in working with the content. The one or more second content creators may compete with each other to finish first, do the best job, and/or to accept the request first.

Once the one or more second content creators have finished the task of working with the content in accordance with the request, the content can be said to have been modified. Modification may refer to the result of the work the second content creator(s) has performed on the first content. The one or more second content creators may then send the result back to the first content creator. Results in accordance with numerous embodiments of the invention may include, but are not limited to, the modified content and/or a description of a modification to be applied to the content. Process 1600 receives (1670) the modified (“second”) content, including the result of the work the second content creator(s) has performed on the first content. The process 1600 may then forward (1680) the modified content to the first content creator.

Depending on the settings of the first content creator, process 1600, may include additional steps. Process 1600 may further indicate (1630) the identified second content creators to the first content creator. This may be an optional step. As described herein, there may be different ways to process (1620) the received request in order to identify second content creators suitable for working on the first content. In this example, the method can include indicating the identified suitable second content creator(s) to the first content creator. This may allow the first content creator to provide additional input. Additional input may include, but is not limited to selecting which of the identified second content creator(s) can be to be provided with the request requesting they work on the content of the first content creator. Consequently, the process 1600 may receive (1640) input, from the first content creator. Input may, for example, relate to which second creator(s) to provide the request to. Providing the received request to the identified second creators may be done in accordance with the input received (1640) from the first content creator. The process 1600 may receive (1660) a confirmation from the second content creator(s) of acceptance of the request. The process 1600 may process (1690) payment and/or closure of the engagement between the first and the second content creator.

The first content creator may, in an analogous manner, create visual descriptions and/or sketches, and receive in response visual expressions from content creators. Such responses may be in the form of, but are not limited to, vector art, JPGs, MPEGs, and other formats as relevant to the expression of the response. Visual responses can be combined to create new visual responses. One example of a visual response may be a graphic depicting an ocean. Audio responses may be combined to create new audio responses. An example of an audio response may be of a vocal artist contributing to audio content, and may show the vocal artist as they record the response to the audio request. Audio responses may be combined with visual responses to create new audiovisual responses. Some requests may be requests for both audio and visual elements.

First content creators can verify the authenticity of content they receive in response to requests. In certain embodiments, third parties, such as viewers of an NFT generated from the content and/or prospective buyers of such an NFT, can verify the authenticity of one or more contributing content elements. This may be possible even if the authenticated content received from the second content creator has been modified by the first content creator. Post-authentication modifications may include, but are not limited to, the timbre being modified, the duration being modified, cutting and/or repeating segments, etc. In some embodiments, a content file may need to be authenticated. Content files in accordance with a number of embodiments of the invention may include elements such as (but not limited to) an audio recording, a video, and/or a set of commands that represent a Computer Aided Design (CAD) drawing.

Content files can be characterized in one or more ways. In several embodiments, content characterization can be used to generate graphs descriptive of content. Graphs in accordance with some embodiments of the invention can represent various types of content, such as (but not limited to) text-based content, audio content, and/or image content. In several embodiments, audio characterizations, such as a particular note being played, may be used as building blocks for a graph. Characterizations of music can be described in co-pending application titled “Tokenization and Quantification of Creative Content Elements,” U.S. Provisional Patent Application No. 63/220,641, by Ajay Kapur, Madhu Vijayan, Bjorn Markus Jakobsson, and Stephen C. Gerber.

Generating characterizations in accordance with a number of embodiments of the invention may include normalizing content and/or performing a transform (e.g., Fast Fourier Transform (FFT)) of the normalized content. In various embodiments, content can be normalized by selecting portions of the content of a given duration, based on factors including, but not limited to, time, number of drum beats, number of syllables enunciated, etc. In many embodiments, normalization can include applying a low-pass filter. One or more normalizations can be performed on the same content. In some embodiments, FFT representations can be characterizations that can be used to derive another characterization. For example, selecting information related to a particular frequency band of an FFT representation may provide a distinct normalization. One or more characterizations of the same content can be made. In accordance with a number of embodiments, characterizations may represent the entire content element from beginning to end. In accordance with several embodiments, characterizations may represent only sections of the content. Some embodiments may use different normalization components. Normalization steps can also be domain-specific. This may mean normalization can involve different steps for images than text.

In accordance with many embodiments, one or more characterizations may be automatically selected by the system. Characterization selection may be performed based on criteria set by the user(s) creating the content. In a number of embodiments, selected characterizations may then be digitally signed, which may affirm the content change. Digital signatures can represent a statement of origination of the content (e.g., the first content). Characterizations may be digitally signed on an individual basis as well as collectively. In some embodiments, a digital signature may be generated on a message M that includes multiple characterizations (C1, . . . Cn) of some content that needed to be authenticated. In various embodiments, a digital signature can be generated on a first characterization C1, another on a second characterization C2, etc.

The use of a digital signature may depend on the extent of a given change. If a first content is modified (e.g., by a second content creator) characterizations may remain the same and the digital signature may remain constant. In settings where modifications to content can be too drastic for the digital signature to remain verifiable, an interactive re-signing can be performed in accordance with various embodiments of the invention. In interactive re-signing in accordance with several embodiments of the invention, content originators (also referred to as first content creators herein) may receive changes (e.g., one or more parameters that modify the content, modified content, etc.) from another creator and, upon determining that the received changes represent a derivative work of the original content, generate a new digital signature for the new characterization. They may then transmit the new characterization to users that can utilize the (modified) content. Such users may include, but is not limited to, a buyer of the content.

In several embodiments, when modified content is verifiable, a buyer of an NFT associated with the modified content may verify who created the content and who modified the content. In some embodiments, various forms of authentication can be used, such as (but not limited to) by using message authentication codes (MACs) and/or by recording of the content on a blockchain that attributes the content to its originator. In various embodiments, blockchains on which content is recorded may be permissioned or non-permissioned.

Content in accordance with various embodiments of the invention may also be associated with textual descriptors by automated processes. Textual descriptors may include, but are not limited to, the transcription of speech in an audio and/or video file, and a set of descriptors output by a computational media analysis algorithm applied to music, non-speech audio, video, etc.

In some embodiments, generating characterizations and normalizing content may be used for recognition purposes. For example, the content can be a photo that was taken by content creator “Mr. A”. Mr. A may compute one or more characterizations of the content and generate a digital signature related to the one or more characterizations. The digital signature can also be seen as a digital signature of the content, e.g., the photo. This can indicate that the photo was created by Mr. A. If another user, “Mr. B” obtains the digitally signed photo, they may remove the signature and modify the photo in some way. By doing so, they may change the photo to make it different from the photo taken by Mr. A. Mr. B can then compute a digital signature for one or more characterizations of the modified photo, thus signing the modified photo. Both digital signatures may then be valid.

The robustness of the characterizations to changes can govern how much modification can be performed without the digital signature being invalid. In this example, Mr. A's digital signature may remain valid in spite of the modifications of the content generated, since at least some of the characterizations can remain the same with a high probability. Should Mr. B make very large modifications, the result may be that the original photo is no longer recognized as having a valid digital signature by Mr. A. If Mr. B makes minimal changes, it may be recognizable as the same content. In other words, Mr. B can claim that Mr. A originated the content that underlies the modified version in a publicly verifiable manner. If Mr. A is a famous person with whom Mr. B wishes to associate, this may be beneficial to Mr. B.

In several embodiments, digital signatures may help the system determine the provenance of content. Digital signatures in accordance with several embodiments of the invention may enable the tracking of versions of content. Normalization and/or characterization in accordance with several embodiments of the invention may be performed by the first content creator prior to uploading and/or sending the content (e.g., to a collaboration node and/or system of other content creators). In a number of embodiments, normalization and/or characterization may be performed by a service provider upon receipt of the content from content creators. Normalization and/or characterization in accordance with many embodiments of the invention may be performed via interaction with the content creator upon receipt of the content.

In accordance with several embodiments, characterization can include application of a fuzzy hash. This can be a construction that permits minor changes to content while maintaining an output representing the content to remain the same. Fuzzy hash approaches in accordance with a variety of embodiments of the invention can be part of a characterization that also performs other normalization steps as disclosed herein.

Numerous embodiments of the invention may address content that is text-based. For example, digital signatures can be generated from characterizations of text files, providing verifiers with evidence indicating the origin of a text file. Evidence in accordance with a variety of embodiments of the invention may survive content manipulation, including (but not limited to) the re-ordering of paragraphs, fixing of grammar, replacement of works with their synonyms, etc.

In certain embodiments, the reason that a digital signature, created on a content element by a first party, can be verified even after a second party has made modifications to the first content and replaced it with second content, is because the digital signature can relate to one or more characterizations of the content as opposed to the verbatim content. One characterization, for example, may be the result of an analysis in which text can be normalized by replacing words with corresponding indicators of meaning. In this case “happy” and “enjoy” may both be represented by the same indicator. Moreover “sad” and “sulk” may be represented by the same indicator, while differing from the indicator used to represent “happy” and “enjoy”.

In a number of embodiments, normalization may include generating a characterization of the content where the representation obtained from another normalization is characterized and a descriptor is selected on a different basis. For example, a representation obtained from the replacement of words with meaning indicators can be characterized and descriptor may be selected on a paragraph basis. In some such embodiments, to enable paragraphs to be reordered, processes in accordance with various embodiments of the invention can use a windowing method as a third normalization. In a windowing method in accordance with some embodiments of the invention, a sliding window representing a number of consecutive paragraphs of normalized content can be assessed and given a corresponding value. In many embodiments, two texts may be considered to be essentially the same if more than a threshold number of associated normalized values representing the texts match. A person of skill in the art will recognize that this is just an illustrative example of the use of normalization for the purpose of creating robustness of characterizations, where such resulting characterizations (e.g., the set of output values from the third normalization step above) can be used to generate a digital signature.

In several embodiments, content can include images, such as photographs, digital files, and/or design files. For example, the first content creator may be a designer of medical instruments. In this example, the first content creator may desire to design a surgical tool. The first content creator may create a basic design (e.g., a CAD-drawing) of the surgical tool. However, the first content creator may not know how to design a specific feature of the surgical tool for it to be optimally designed for its purpose. The first content creator can send a request to a network node in order to find a second content creator who may help with this design. Processes in accordance with several embodiments of the invention may provide a user interface in various ways, such as (but not limited to) a website, an app on a smartphone, and/or an application on a computer to allow a content creator to send requests. User interfaces in accordance with a variety of embodiments of the invention may function as a portal to a service provider providing the service of finding a suitable second content creator. The request sent by the first content creator may, in this illustrative example, include the CAD-drawing and information pertaining to what type of second content creators the request should be provided and/or offered to. Such information may include having knowledge in CAD and being an expert in medical instruments and/or an expert on the type of medical instrument the first content creator wishes to design. The request may also include some sort of description of what the first content creator wishes the second creator(s) to do to the CAD-drawing as well as an offered monetary compensation offered to the second content creator(s).

As described above, the service provider (e.g., network node(s) a service provider uses in order to provide the service) may process a request, indicate suitable second content provider(s) for the first content provider to choose from, and provide the request to those second content creator(s) that the first content creator indicated. A second content creator may accept the request, work on the CAD-drawing, and produce a modified CAD-drawing of the surgical tool now being designed in accordance with the request to be optimally designed for its purpose. The second content creator may send the modified CAD-drawing back to the service provider to be forwarded to the first content creator. The original CAD drawing may be associated with an NFT, whereby the modified CAD-drawing can also be associated with the NFT now carrying information about the second content creator. The first content creator may intend to seek patent protection for the surgical tool as defined in the modified CAD-drawing. Then all the necessary information can be carried by the NFT so that the second content creator may be listed as an inventor in a patent application for the surgical tool.

Systems and methods in accordance with various embodiments of the invention can provide a connection/negotiation/engagement between content creators. Connections in accordance with various embodiments of the invention may be arranged by various devices, such as (but not limited to) a computer, a mobile device, a network node, a server in a cloud and/or a control unit in a device. Hereinafter, such devices may be referred to as network node for sake of simplicity. In the below description, some examples can be given referring to other parts of this disclosure. These examples can be illustrative and non-limiting and can be given to clarify what may be included in a method step.

In a variety of embodiments, first content creator may, as exemplified above, produce and/or upload content to a network node; this may also be referred to as sending a request to the network node. When a request is sent to a network node, the network node may receive the content from the first content creator. As described above, requests may include information as to what a first content creator desires a second content creator to do with the uploaded content. The information may indicate various request parameters, such as (but not limited to), a budget, a genre, one or more indicated content creators, etc. and/or specific requests (e.g., “please play this on the piano”, “please sing this in a sad manner”, etc.)

Network nodes in accordance with several embodiments of the invention can process the received request. Processing a received request may include filtering the received request based on available actions for the selected second content creators. For example, if the first content creator has indicated that they want something played on a ukulele, then only selected content creators who can fulfill this request (e.g., who can play the ukulele). By processing the received request, the network node may identify second content creators that may be suitable candidates for doing what the first content creator wishes the second content creators to do with the uploaded content. Identifying suitable candidates is described in greater detail throughout.

Once the request has been processed and suitable candidates (second content creators) who fulfill the requirements as given in the received request from the first content creator have been identified, processes in accordance with a variety of embodiments of the invention may present the identified suitable candidates (second content creators) to the first content creator. Hence, processes may include providing information to the first content creator, the information pertaining to second content creator(s) who fulfill the requirements as indicated by the first content creator. The first content creator may have an interface on their device that presents the information to the first content creator as described throughout. The first content creator may then select which second content creator(s) they wish to engage to work on the uploaded content.

Processes in accordance with a variety of embodiments of the invention may include receiving, from a first content creator, an indication of which second content creator to whom to present the uploaded content, together with the requests of what the first content creator wishes the second content creator to do with the uploaded content. The request may be presented to the indicated second content creators.

The second content creator(s) may then accept to work on the uploaded content from the first content creator. This may include clicking a “commit” button. Network nodes may receive information, from a second content creator, indicating that the second content creator agrees to work on the uploaded content of the first content creator. In many embodiments, network nodes can stop providing the information to other second creators once one (or more) second content creators has committed to work on the uploaded content from the first content creator. In this manner, once enough second content creators have accepted to work on the uploaded content, network nodes can stop providing information about the request (the uploaded content from the first content creator) to other second content creators.

Once the second content creator has done their work on the content, the second content creator may upload the “result” to the network node. The second content creator may have altered the original uploaded content from the first content creator in accordance with the wishes as indicated by the first content creator. The work of the second content creator can be referred to as result for sake of simplicity, but it may also be referred to as the content uploaded from the second content creator or modified content. Thus, the network node may receive the result from the second content creator.

In certain embodiments, network nodes can forward the result to the first content creator. In some embodiments, network nodes may include processing payment and/or closure of the engagement between the first and the second content creator.

In some embodiments, a computer program may implement the relevant process. The computer program may include computer-readable code which, when run in a processing unit included in an arrangement in a network node, causes the node to perform the method as described herein. Processing units may be included in the arrangement in the network node. For example, processing units may include a Digital Signal Processor (DSP). In many embodiments, processing units may include a single Central Processing Unit, CPU. Processors in accordance with several embodiments of the invention may include general-purpose microprocessors; instruction set processors and/or related chips sets and/or special-purpose microprocessors such as Application Specific Integrated Circuits, ASICs. In a number of embodiments, processors may include board memory for caching purposes. Computer programs in accordance with a number of embodiments of the invention may be carried by a computer program product connected to the processor. Processing units in accordance with several embodiments of the invention may include one or more units and perform different actions of procedures described herein.

Network nodes may also include an input unit for receiving signals from other entities and arrangements, and an output unit for providing signal(s) to other entities and arrangements. The input unit and the output unit may be arranged as an integrated entity. The input and output units may also include one or more interfaces. Furthermore, network nodes may include at least one computer program product in the form of a non-volatile memory. In some embodiments, the memory may include an Electrically Erasable Programmable Read-Only Memory (EEPROM), a flash memory and/or a hard drive. In many embodiments, computer program products including the computer program can be provided. Computer program products in accordance with many embodiments of the invention may include code, which when executed by processing units of the network node cause the network node to perform the actions described herein.

Computer program products in accordance with a number of embodiments of the invention may include a computer-readable medium on which the computer program is stored. For example, computer program products may include, but are not limited to, flash memory, Random-Access Memory (RAM), Read-Only Memory (ROM), and/or EEPROM. Computer program modules as described herein can be distributed on different computer program products in the form of memories within one or more network nodes.

B. Enabling Trust for Collaboration

Collaborative content creation environments are often based on an assumption of trust. This is a meaningful assumption within an enterprise, since the only users with access (e.g., read access or read/write access) are usually employees, and potentially, employees who have been granted access to the content (e.g., by their manager). The underlying trust assumptions of such settings use controlled security environments to enable collaborative efforts. However, in an open setting, not limited to an enterprise, where mostly anybody can potentially access documents or wherein there is little inherent recourse if there is abuse, traditional mechanisms can be woefully inadequate. This can hamper distributed efforts for content creation. Systems and methods in accordance with a variety of embodiments of the invention can address several aspects of this problem, creating structures that enable the creation of trust in settings where there may be no inherent trust.

Content characterization systems in accordance with some embodiments of the invention can obtain content (e.g., text, audio, video, images, etc.), and create one or more characterizations of the content. Characterizations in accordance with various embodiments of the invention can include a mapping of one or more portions of the content to one or more descriptors. For example, text content may include a script for a movie and a characterization of the text content may be a description of the text, on a very high level, as a sequence of terms (e.g., “harmony”, “natural disaster”, “separation”, “grief”, “search”, “relief”, etc.). The same script may also be described in another manner in another characterization (e.g., “family”, “danger”, “loss”, “trying”, “success”).

Characterizations in accordance with a number of embodiments of the invention can also be expressed in more detail. In many embodiments, characterizations may be hierarchical. In several embodiments, each element of a characterization may correspond to a node in a tree, where connected child nodes provide different levels of detail; e.g., “separation” may be broken down in “large wave”, “swimming”, “saved by a stranger”, “weak”, “hospital”, “memory loss”. In several embodiments, nodes corresponding to elements describing the content may be broken down into child nodes that corresponding sub-elements of a given element. Although examples of nodes corresponding to different terms are described, terms do not have to correspond to words, whether in English language and/or other languages, but may correspond to other representations of the text, such as (but not limited to) a collection of measurements of various emotions and occurrences. Nodes in accordance with a number of embodiments of the invention could be associated with a vector of weights associated with words and/or concepts. In a number of embodiments, nodes may correspond to other vectors, matrices, and/or tensors of arbitrary dimensionality, which may not even be human-interpretable, such as (but not limited to) a vector produced by a neural network (e.g., a transformer and/or a component thereof such as an encoder).

Descriptions (or characterizations) of content in accordance with some embodiments of the invention can be represented using one or more graphs, where the graphs may be in the form of trees, and where each such tree may correspond to a temporal representation of events and emotions. In certain embodiments, content can be represented using graphs that are not trees. For example, edges between nodes may represent causal relationships, e.g., one term depending on another. In the example above, “grief” may depend on “separation”, indicating that the grief was to a large extent due to the separation. In some embodiments, edges between nodes may have a weight, which may be represented as one or more values. Weights in accordance with certain embodiments of the invention can represent an assessment of the causality and/or the temporal relationships between two nodes. For example, “relief” may be strongly associated with “search”, i.e., that the search was successful, but may also be associated with “harmony”, which is a state to which entities return once the relief takes place. This enables the description of content, such as film scripts, novels, magazine articles, and/or news stories, using graph representations. By representing content using multiple graphs, collaboration systems in accordance with several embodiments of the invention may cover different aspects of the story. For example, for a given set of content, a first representation may track the temporal flow of events and their connection to each other, a second representation may track the emotional tone, and a third representation may represent uncertainty and may include representations of suspense.

Graphs in accordance with some embodiments of the invention can be generated to represent the logical ordering of events of content (e.g., a script). This does not need to correspond to the order in which the story elements were introduced, as a flashback, for example, can be introduced in a variety of places but still describes a time prior to the locations in the story in which it was introduced. Thus, the edges of such a graph representation of the script can correspond to causality. Once these edges have been introduced, other edges can be introduced. For example, other edges may be introduced to represent what one character in the story understands and/or knows about at a given time. Many stories include a protagonist and an antagonist with very separate storylines, and/or limbs on an event tree, until which time in the story the two characters interact, often in conflict. This does not need to be the same as the causal ordering, as a person may learn about an event of the past much later than it takes place. Such a representation can identify the relationship between causality and the understanding of a given entity. Other such relative expressions can be encoded in a similar manner, and quantified by expressing weights associated with edges. Weights in accordance with certain embodiments of the invention can be used to determine a similarity between graphs representing two different content elements, along with the structure of the graphs, and the similarity of the graphs. A storyline arch can represent characteristics of an authored work over the time horizon of the story. Storyline arcs of an authored work are described in greater detail in U.S. Provisional Patent Application No. 63/234,086 titled ‘Tokenization and Promotion of Authored Content”, by Ajay Kapur, Stephen C. Gerber, Bjorn Markus Jakobsson, and Madhu Vijayan, the contents of which are incorporated in their entirety by reference herein.

Two terms may be compared in terms of their similarity. In a number of embodiments, comparisons may be performed using a machine-learning algorithm, a word embedding model, and/or a lexical database that determines the emotional distance between constructs. For example, “excitement” and “wedding” may have a distance of 1.2 representing that the two words can be relatively close to each other, while “storm” and “wedding” may have a distance of 9.43 representing that they can be relatively far apart. Two words being relatively close may thus be “related” in the sense that they may describe and/or refer to the same thing/object/item and/or one may describe the other.

Computing distances for terms in accordance with a variety of embodiments of the invention can be performed with a variety of methods. Examples of such methods are described below. In several embodiments, distances can be computed by computing a distance measure between words in an embedding space (e.g., GloVe and/or word2vec), and/or to the coordinates of each term in a latent space as computed by a neural network applied to the term. Processes in accordance with a variety of embodiments of the invention can compute distances by processing each term by employing hypernyms of each term, followed by computing a distance measure in an embedding space. In various embodiments, distance computation could be achieved through comparing the outputs for words from a machine-learning based sentiment analyzer (e.g., using a transformer model), which could be an off-the-shelf pre-trained sentiment analyzer and/or an analyzer that has been trained and/or fine-tuned to a relevant corpus. Distance computation in accordance with various embodiments of the invention could be achieved using an algorithm such as Wu-Palmer computed on a lexical database such as WordNet. In a variety of embodiments, multiple such approaches to computing similarity may be applied and combined into a single measure, and/or program logic and/or a machine learning model may choose among multiple models according to the use case and/or surrounding text context.

Similarly, in many embodiments, a first node with multiple children nodes, grandchildren nodes, etc., (which can be collectively referred to as descendant nodes) can be compared with a second node with multiple descendant nodes. A score of similarity can be determined for such a comparison. Multiple similarity scores can be generated from the one or more graph representations of a content element.

In many embodiments, sequences of terms can be compared in terms of their similarity, and computations can be performed in ways that accommodate differences in length and pacing. For instance, consider two versions of the “three little pigs” children's story. Version A, the classic telling of the story, may be summarized at a high level by the sequence of terms “home,” “danger,” and “relief.” Version B may include a preface in which Mother Goose introduces the story to an audience of sleepy children, and be summarized at a high level by the sequence of terms “story”, “home”, “danger,” and “relief.” An ordered term-by-term comparison of A and B may not yield high similarity, but an appropriate comparison of the sequences of A and B may yield high similarity. Sequence similarity computations in accordance with various embodiments of the invention can be achieved using various techniques, such as (but not limited to) Levenshtein distance, edit distance in a space of very-high-level terms, in a vector-quantized space of high-level terms, and/or using techniques such as dynamic time warping applied to a sequence of word embeddings.

In certain embodiments, content can be related to music. In several embodiments, characterizations of content can be performed for musical scores, recordings of music, etc., and characterizations of such content can be determined. Characterizations of such content may include (but is not limited to) using metrics such as emotional analysis (e.g., estimates of emotion coordinates in an arousal-valence space, computational characterizations of rhythm, timbre, genre, complexity, structure, etc.). Characterizations of music in accordance with numerous embodiments of the invention are described in U.S. Provisional Patent Application No. 63/220,641 titled “Tokenization and Quantification of Creative Content Elements” by Ajay Kapur, Madhu Vijayan, Bjorn Markus Jakobsson, and Stephen C. Gerber, the disclosure of which is incorporated by reference herein in its entirety. Content in accordance with various embodiments of the invention may be associated with textual descriptors by an automated process. For instance, the transcription of speech in an audio and/or video file, and/or a set of descriptors output by a computational media analysis algorithm applied to music, non-speech audio, video, and/or other data. Such descriptors can further be processed by performing sentiment analysis to create emotional characterizations of texts extracted, e.g., from lyrics.

In non-text content, sequences of terms can be compared using similar approaches. For instance, a musical sequence could be represented as a sequence of melody notes, a sequence of harmonies, and/or a sequence of frames represented e.g. by a short-time Fourier Transform. These could each correspond to a different sequence of “terms”, for instance, represented as a sequence of scale-degree/duration pairs, a sequence of chord-name/duration pairs, and a sequence of complex-valued matrices. In some embodiments, melodic and/or harmonic sequences can be compared using Levenshtein distance, and/or variations thereof that attempt to represent music perception and convention such as ensuring distance is invariant to the musical key signature of either sequence. In several embodiments, various types of sequences could be compared using dynamic time warping, which allows accurate identification of musically similar content even when the tempo of two musical renditions is different.

In a number of embodiments, when a person introduces content to a collaboration system, the system can generate graphs that characterize the content. Content introduction may include uploading a script and/or an NFT including a script and/or audio material. Graph generation in accordance with some embodiments of the invention may be done automatically by an algorithm or using input from a person (e.g., a content creator, another person and/or group of people) who may have the option to iteratively view, verify, construct, and/or edit graph content through a user interface. Automatic computational generation of graphs in accordance with various embodiments of the invention may be accomplished through computational analysis of the uploaded content. In a number of embodiments, automatic computation graph generation may be informed and/or augmented through other channels of information. Examples of other channels of information may include (but are not limited to) tags and/or section markers applied to the text by users and/or users, comments users and/or group of users have applied to the text, histories of graphs and graph corrections associated with media from this user and/or other users, and/or other data.

The collection of graphs associated with a content element may be referred to as fingerprints of the content. Fingerprints in accordance with some embodiments of the invention may be obfuscated and/or encrypted, whether in their entirety and/or in part, making it possible for a party to utilize them without associated rights to access the fingerprints. In several embodiments, locality-sensitive and/or locality-preserving hash methods may be used to derive fingerprint hash representations for faster comparison. In several embodiments, fingerprints representing subgraphs of the content may be explicitly stored to facilitate comparison of local content portions. Processes in accordance with several embodiments of the invention can utilize fingerprints to search or match content. For example, fingerprints can be used to identify two storylines that share a distinctive exchange between two characters as similar even though their highest-level narrative arcs can be different.

In numerous embodiments, content may be stored, whether in the same record as the fingerprints it can be associated with and/or in another record. In many embodiments, at least one of the records of the content and the record of the fingerprints references the other record. In various embodiments, records with content fingerprints and/or records with content, can be stored in one or more databases, which may be a public database, including a distributed database and/or ledger such as a blockchain. Databases in accordance with various embodiments of the invention may not be publicly accessible with access control that may be managed by a party, whether a single entity and/or a distributed entity.

In certain embodiments, content fingerprints may be associated with timestamps. If users update content, the corresponding new content fingerprints can be stored along with their associated timestamps. The old fingerprints and their timestamps may also be stored, but potentially moved to another database, e.g., an archival database. Content elements may have multiple versions, including “old” and “current” versions. Content elements may have multiple old versions, e.g., representing the changes made to the content during its creation; it may also have multiple current versions, representing different alternatives. One alternative may be developed and/or configured based on a first audience, and a second alternative developed and/or configured based on a second audience, for example.

In certain embodiments, processes may score content elements in terms of its similarity to one or more other content elements, including old content and new content. This may be done by performing a similarity comparison of the fingerprints of the given content elements and the other content elements. In some embodiments, this can be done in a lazy manner: for example, a high-level comparison is performed at first, and only if that results in a resulting similarity greater than a first threshold does a second-level comparison get performed. For example, a first-level comparison may be performed using two tree-shaped graphs, where only the first three levels of the two trees can be considered in the comparison. If this comparison results in a score exceeding a threshold value, such as 40, then a full comparison of the complete trees can be performed. This can also be done on graphs that are not trees. In a variety of embodiments, comparisons may be performed using a first comparison that only takes into consideration nodes and edges with a weight exceeding a given value, such as 0.7, and generating an assessment of the similarity between these resulting two graphs. If that similarity score exceeds a threshold value, then a full comparison can be performed. Such high-level comparisons could be performed on fingerprints containing trees and/or graphs corresponding to entire pieces of content, e.g. entire film scripts, and/or they could be performed on fingerprints containing trees and/or graphs, and/or sub-trees and/or sub-graphs, corresponding to smaller segments of content, e.g. scenes in a film.

In some embodiments, the comparison of two trees can be performed at a specified level of granularity through a comparison of the two term sequences corresponding to the ordered list of nodes at the specified level of each tree. For instance, Tree 1 may have nodes A, B, and C at level 2 of the tree. Tree 2 may have nodes D, E, F, G at level 2 of the tree. A comparison of Tree 1 and Tree 2 at level 2 entails a comparison of the sequence corresponding to A, B, C with the sequence corresponding to D, E, F, G. As described above, this could entail the use of techniques such as Levenshtein distance and/or edit distance in a space of very-high-level terms, and/or in a vector-quantized space of high-level terms, and/or the use of techniques such as dynamic time warping applied to a sequence of numerical and/or vector values such as embedding vectors. The comparison of two graphs and/or subgraphs can be achieved using similar means given a method for mapping a given graph onto a sequence of terms. This may be through specifying the selection and ordering of nodes in a subgraph and producing an ordered sequence of terms from those nodes.

In some embodiments, the comparison of two trees and/or non-tree graphs can be performed through the use of machine learning. For instance, an unsupervised learning algorithm can take a tree and/or graph as input and produce an output vector, and a comparison of two trees and/or graphs entails a computation on their respective output vectors. For example, a neural network may produce an output which can be interpreted as a latent vector, and two latent vectors can be compared using a distance metric in the latent space. Or, an algorithm such as a neural network and/or a clustering algorithm such as k-means may produce an output which may be interpreted as a probability distribution, and two such vectors can be compared using methods such as KL-divergence, the Jensen-Shannon divergence, and/or other known methods for comparing distributions.

In some embodiments, vector quantization and similar techniques can be applied to facilitate locality-sensitive and/or locality-preserving hashing and fast comparison of trees, graphs, sub-trees, and/or sub-graphs. In several embodiments, compressed representations can be computed from a graph using a technique such as clustering and/or an autoencoder. Compressed representations in accordance with several embodiments of the invention can be used directly to produce an estimate of similarity. In several embodiments, similarity can be estimated by applying a distance metric on two vectors. In some embodiments, compressed representations can be used in a first pass to identify likely similar candidates, wherein an exact and/or close match and/or a short distance can be used to flag these candidates for further comparison, for instance using another comparison method. Compressed representations can be used to facilitate locality-sensitive hashing and locality-preserving hashing in which more computationally expensive similarity computations can be only executed on likely matches rather than across the full dataset. In many embodiments, determinations of similarity can be used to cluster content, enabling selective comparisons to be performed. For example, only comparing a new item to elements in one or more clusters identified as being related. In numerous embodiments, relevant clusters can be determined based on various factors, such as (but not limited to) detection of keywords, a description of the content (e.g., provided by a content creator and/or a content curator, incl. a content contributor).

In some embodiments, different representations and different comparison methods can be used in combination to assess different notions of similarity. For instance, one method for finding near-copies of spoken dialogue snippets in film scripts may be used alongside another method for finding film scripts with similar story arcs. In the first case, for instance, fingerprints containing vector representations of low-level text, e.g., sentences, may be compared. In the second case, for instance, comparison may be performed on upper levels of hierarchical tree representations representing both plot descriptors and emotion arousal-valence coordinates in fingerprints. Or, as another example, comparison of video content may separately use comparison methods applied to audio-content fingerprints and comparison methods applied to fingerprints computed from the visual content.

Comparisons between two sets of fingerprints in accordance with numerous embodiments of the invention may be performed by comparing the graphs of the fingerprints of the first content element (such as a given element) with the graphs of the fingerprints of a second content element (such as the fingerprints of the first stored content element). Collaboration systems in accordance with many embodiments of the invention can generate similarity scores associated with the given content and each stored element, and/or a subset of these (e.g., based on keywords, classes and assessments associated with the given content and the stored content). Keywords, classes and/or assessments may be provided by the associated content creators, and/or be generated in an automated manner, e.g., based on sentiment analysis, keyword analysis, text summarization, etc.; and/or a combination of these approaches.

In a variety of embodiments, collaboration systems can determine novelty scores for content elements. In some embodiments, novelty scores can be based on similarity scores. For example, a content element whose highest similarity score is 42, and the second-highest score is 30 may have a novelty score of 80, whereas a content element whose highest similarity score is 42 and the second highest is 41 may have a novelty score of 67, and a content element whose highest similarity score is 90 and second highest similarity score is 70 may have a novelty score of 26. In a number of embodiments, if an item has a novelty score above a pre-set threshold (e.g., 90), it may be classified as “green” (i.e. novel), whereas an item with a novelty score below another threshold (e.g., 30) may be considered “red” (i.e. plagiarized). Scores in between these two thresholds may be considered “yellow”. In a variety of embodiments, additional tests can be performed based on these classifications. For example, one test may be to select two sets of fingerprints, both of which caused high similarity scores, and then evaluate the given content, and its associated fingerprints, against the combination of the two selected fingerprints. This may result in a much higher similarity score. For instance, if the given content is a straightforward combination of the first half of content1 and the second half of content2.

In some embodiments, novelty scores can be informed by other computations. Such computations in accordance with several embodiments of the invention may involve comparison to and/or computation on other content for which fingerprints have not been computed, such as employing a search within another corpus for matching text in order to detect text that has been copied from other sources, such as existing film scripts and/or novels. In a number of embodiments, such computations may involve the application of natural language processing and/or machine learning methods to assess the quality and/or origin of the content. For instance, a supervised deep neural network such as an LSTM may be employed to classify whether a segment of text is generated by a bot, and/or to identify the probability that a given segment of text is in English, and/or to classify the probability that an audio file contains music as opposed to speech, silence, and/or other sounds. Such methods can be useful to defend against the case where content that is irrelevant, plagiarized from other sources, produced by random generation and/or other trivial automated approaches, can be contributed with the intention of achieving a high novelty score. One skilled in the art can recognize that such methods can additionally and/or alternatively be employed in various applications, such as (but not limited) to flag content before accepting it for upload and/or before employing additional computation to produce a novelty score.

In many embodiments, collaboration systems can create user profiles with particular identifiers. For example, profiles may be associated with a unique username, a public key, etc. Users can then upload one or more content elements, such as those described herein. In a variety of embodiments, content elements can be fingerprinted, and representations of the content and their fingerprints stored in a database. This database can serve as a record proving when new notions, as expressed by the uploaded content, were developed. In various embodiments, uploaded content can be compared to other content that has been uploaded. Some such content may be legacy content; for example, somebody can generate a profile for Daniel Defoe, and upload the text for Robinson Crusoe. While the content can be associated with a timestamp indicating when it was uploaded, content in accordance with several embodiments of the invention can also be associated with an assertion when it was first produced, e.g., “25 Apr. 1719”, as is believed to be the publication date of the book named Robinson Crusoe. Collaboration systems in accordance with certain embodiments of the invention can utilize multiple time indicators including (but not limited to) timestamps and assertions. Assertions in accordance with several embodiments of the invention may be digitally signed by trusted entities, and/or be associated with evidence of their provenance.

Provenance methods can be disclosed in U.S. Provisional Patent Application No. 63/220,488 entitled “Content Origin Determination and Tokenization” by Bjorn Markus Jakobsson and U.S. Provisional Patent Application No. 63/208,366 entitled “Perpetual NFT Assets” by Bjorn Markus Jakobsson, Stephen C. Gerber, and Guy Stewart, the disclosures of which are incorporated by reference herein in their entireties.

As content is compared with other content, the content with an older timestamp (or asserted time for legacy content) may be considered in the context of younger content, or the content with a more recent timestamp. The younger content can be given a novelty score based on the comparison with the older content. In certain embodiments, if legacy content is not found to be authentic then its corresponding content may not be used in comparisons aimed at providing a novelty score for other content.

An account with uploaded content can be associated with one or more novelty scores, as described above. Alternatively or additionally, it may be associated with one or more similarity scores. In addition, links to content associated with said novelty scores and/or similarity scores can be indicated in the profile of the user. In several embodiments, users may be provided with reputation scores. One dimension of a reputation score in accordance with a number of embodiments of the invention can be the predicted novelty score of content associated with the account. This may an indication of a risk that new content that is not yet uploaded may not have a high novelty score, based on the determined novelty score of content that already has been associated with the account. Another way of seeing this is that this aspect of the reputation score (or novelty reputation score) can be an indication of the novelty of the already uploaded content associated with the account. Novelty reputation scores can also be computed for users' contributions to other users' work. For example, if Alice writes a paragraph to add to Bob's story, then this paragraph of Alice's may be associated with a novelty reputation score, to be added to Alice's novelty reputation score, in spite of the fact that the resulting content may belong to Bob, and not Alice, as Alice may have provided the suggestion in return for a payment, for example.

Reputation scores in accordance with a variety of embodiments of the invention can include information about the quality of improvements to content associated with other users, where the improvement may be a modification provided with the account holder. For example, if Alice reads a text provided by Bob and makes some edits, and Bob approves these edits and opts to incorporate them in his content, then Alice's reputation score increases. This dimension of Alice's reputation score represents her contribution to other users' content, and may be referred to as her collaborative reputation score. A large number of measurable properties may be combined to compute a collaborative reputation score. For instance, this score may be increased by the number of contributions Alice makes to others' works, the size of these contributions for instance in the number of words, the proportion of Alice's edits that other creators choose to keep, and/or the number and strength of positive reviews Alice receives for her edits from other users. The reputations and activities of people accepting and/or rejecting Alice's edits may also be considered, for instance, so that Alice's reputation increases even more when she makes accepted edits for users who has a well-established history of using the site, and/or for users who has a history of rejecting proportionally more edits made to their content. In various embodiments, combining constituent measures into a single collaborative reputation score may employ an explicitly defined mathematical equation, and/or a machine learning model trained to reproduce target collaborative reputation scores supplied for a set of real and/or fictional users. In a number of embodiments, the creator of the original content, in this example Bob, may also give a rating of his satisfaction of the addition. This may help to assign a fairer score to Alice depending on whether Bob accepts her addition(s) thinking it is ok and/or accepts her addition(s) really loving the addition and perhaps even inspiring him to further improvements of his original content.

In a variety of embodiments, reputation scores of users may be based on the uniqueness of the addition and/or contribution of the user. For example, assume a user named Alice makes an addition to Bob's content, and Bob's content may be a script relating to a book relating to a murder history. Alice's addition pertains to a murderer using a very odd poison that can be put into someone's food and/or drink adding no taste and being untraceable/undetectable. The addition can be accepted by Bob and Alice's reputation score then goes up. Later on, Alice makes another addition to Dick's content, and Dick's content may be a script relating to a “sad movie”. In this case, Alice's addition pertains to a character accidentally consuming food somehow accidentally having the same very odd poison as in her previous addition to Bob's content, wherein the character tragically dies leaving his wife alone with their newborn child. Thus, when Alice makes a very similar addition to Dick's content it won't be as unique and/or surprising as it was when she added it to Bob's content. In one example, since the content of Bob is a book of a first genre and the content of Dick is a movie of a second genre, but the addition made by Alice is not unique the second time, Alice's reputation score can be unchanged even though Dick accepts Alice's addition. In another example, Alice's reputation score may be lowered due to lack of uniqueness the second time she makes the addition. Thus, contributions in accordance with numerous embodiments of the invention may be considered as a collection that is scored based on their relative novelty, as well as with respect to other aspects, as disclosed elsewhere herein. Merely as an illustrative and non-limiting example, reputation scores can be measured and/or given in a range from 0 to 100, wherein 0 represents the worst novelty score (or initial novelty score when no content has yet been received), and 100 represents the absolute best reputation score possible. As described herein, a reputation score may be changed for the better and/or the worse for each content being uploaded and/or received by a content creator. For example, assume a content creator has a reputation of 63, then a change by 1-5 units and/or points may be considered low, any change between 5-10 units may be considered medium and a change above 10 may be considered high. In this illustrative example, a change from 63 to e.g., 65 may be considered low, a change from 63 to 56 may be considered medium and a change from 63 to 74 may be considered high.

In several embodiments, collaboration systems may restrict or limit access for a first user wishing to access the content of a second user. The second user may set requirements for what users may access her content based on reputation scores. For example, the second user may specify that only users with a novelty reputation score of at least 65 and with a collaborative reputation score of at least 50 may access content. A user with a low collaborative reputation score may not be trusted to make good suggestions, and users with a low novelty reputation score may not be trusted with providing original content suggestions.

In several embodiments, collaboration systems may determine the cost to hire users as a function of their reputation scores. For example, Bob may have minimum requirements indicating who can access and/or make suggestions for content for him, and also have a pay scale that indicates the payment for various tasks, based on one or more scores, such as the novelty reputation score and the collaborative reputation score. In certain embodiments, various other scores can be used. For example, an activity reputation score can indicate how active users are, e.g., whether they are available within 24 h and/or a week; whether they return approved results faster and/or slower than average, etc. Activity reputation scores in accordance with several embodiments of the invention may indicate how many tasks the user has completed, and/or the estimated effort associated with these tasks, where each task can be associated with some quantity of effort, such as “10 minutes” and/or “two days”. In a number of embodiments, effort quantifiers may be determined based on the actual amount of time it took to complete, the estimated time needed before it was completed, and/or another measure of quantity. For example, Bob may indicate that the proofreading of a given chapter, if approved, can result in a payment of $10 for users with a certain score exceeding 78, but in a payment of $30 for users for whom the same score exceeds 90. Bob may also assign bonuses. In many embodiments, payments may depend on the assessment of unrelated third parties that can be commissioned to assess the quality of the contribution, and/or by an ML component that assigns a payment within a given range based on metrics such as the success of the content in a marketplace. Different users may be associated with different payments and/or time constraints. Users having a very high novelty score may be more valuable to engage and/or may be paid more than users having a lower novelty score.

Payments in accordance with numerous embodiments of the invention may be provided as one-time fixed payments associated with the task performed, and/or as royalties based on the profits. Royalties may be a fixed share of the total royalties given to the main content creator. A combination of such payments may also be provided.

In many embodiments, databases including content and fingerprints can be used to determine whether content, independently of whether it is uploaded to the system and/or only used externally to the system, is “too close” to uploaded content that bears older timestamps than any known time indications of the content that it is compared to. For example, if a script is sold to a movie studio, but the script was not processed using the system disclosed herein, the system can still determine one or more similarity scores for the script, and/or a novelty score, which can be used as evidence of abuse. Similarly, movie studios may request novelty scores for all scripts they receive, as part of their processing of these scripts. Similar scoring and assessment techniques also apply to content that are not scripts, e.g., demo tapes. This aspect may discourage abuse, even beyond content that is uploaded in the system by the claimed and/or real content creator.

A content creator, in one example, may upload content, select one or more policies governing what other users have access to the content, and have one or more specifications identifying what needs the content creator perceives, e.g., “proofread the script”, “help improve the resolution of chapter 3”, “identify the most exciting story aspect”, “identify the least credible character”, “help write an explanation of why Corey, the killer, would want to steal the blue car”, etc. In some embodiments, content creators may identify how many users matching the access policies may be requested to work on the needs. For example, Alice may further identify selection criteria for these users in terms of the nature of their past contributions, whether related to Alice-originated content, content generators by others, and/or content created by the users allowed to access Alice's content in question. When responses can be received from the content contributors (e.g., the users being given access to Alice's content), content creators may be provided access to the contributions and asked to approve, reject, rate, etc., each contribution. Content creators can also ask an associated contributor to make modifications, clarify matters, give partial credit, and provide the contributor's suggestions to third parties, such as other contributors. The contributions that content creators accept may be automatically incorporated into her content. Payment decisions can be made by the system based on the decisions of content creators, whether related to immediate payments and/or in terms of incorporation of clauses in royalty polices. Content creators can request additional contributions from the same and/or other contributors. In certain embodiments, content creators may blacklist some contributors, whether for the current project and/or for the content creator in general. In a variety of embodiments, content creators may also indicate some contributors as preferred, whether for the current project and/or for the content creator in general. Content creators may assign bonuses, give partial payments, create endorsements for contributors, etc. Content creators may request that contributors endorsed by one or more selected content creators can be selected for a given task, and/or used as the pool of preferred contributors for feedback on content generated and/or curated by the content creator. This can provide a strong encouragement for contributors to do a good job, and becomes part of their profile, in addition to their reputation scores and list of approved tasks, etc.

Collaboration systems in accordance with several embodiments of the invention can protect against abuse in several ways. Collaboration systems in accordance with various embodiments of the invention can enable content creators to limit who can access their content, based on various factors, such as (but not limited to) reputation scores, endorsements, indications of what content users have contributed to and/or created, etc. Collaboration systems can maintain an audit trail of what users have accessed what content. In a number of embodiments, collaboration systems can identify whether a high-similarity content upload comes from an account that has had access to content to which the similarity is high. Collaboration systems can also identify clustering of accounts with access to and/or content similar to given content. This can be used to identify potential abusive users, and limit the access these have to content data. In various embodiments, collaboration systems can be used for provenance determination, which limits abuse, and to provide such evidence to law enforcement. Similar assessments can be performed and provided to entities concerned with their liability, for instance, a movie studio before acquiring a script. Collaboration systems may implement one or more of these security measures, and integrate them with other content creation and content curation systems. In several embodiments, a user's reputation scores may be represented as one or more NFTs. Reputation NFTs may be evolving NFTs in the sense that the scores may be affected by the actions of the user and others, e.g., the completion rate of users and the ratings of content creators.

Just as content creators may rate content contributors that perform tasks relative to the content uploaded by and/or curated by the content creators, collaboration systems in accordance with certain embodiments of the invention may allow content contributors to rate content and/or content creators. This may be in terms of various criteria, such as (but not limited to) the novelty of content, the appeal of content to a given market the content contributor is familiar with, and/or the extent to which the content creator provides fair reimbursement for efforts spent by the content contributors. In a number of embodiments, content contributors may also add content creators to blocklists, preferred lists of collaborators, etc. Such actions also impact the reputation of the content creators. This can be further affected by the success of content creators.

For example, a content creator that produces a successful NFT may lead to large royalties paid for the content creator and, optionally, content contributors. This can result in an increase of the content creator, as well as all contributors whose content contributions affected the final version of the content, e.g., were approved by the content creator.

In some embodiments, reputation scores may decrease for various reasons. Such cases might involve excessive corrections needed to align a piece of content with some standard. This might include spelling/grammar errors, errors of fact, and/or writings that differ from community standards in some way(s). In other words, if an original content creator is found to be a terrible writer, and/or their content is excessively factually erroneous, abusive, profane, and/or otherwise not up to standards, such content creators' reputations might substantially decrease, because of the necessary corrections and/or changes required. Similar to WIKIPEDIA and other collaborative writing environments, there may be a need to establish and maintain a system of edits, challenges, etc., especially when repudiation of written content is involved. Media blockchain technology in accordance with many embodiments of the invention provides a unique means to track and manage such transactions.

There can be other situations where reputation scores could decrease and increase. For example, an explicit and/or implicit ranking system could be established where other users rate content. Or, for a large population of users, an upvote/downvote system for content, and/or even authors, could be implemented. Authors whose content consistently receives low ratings, and/or significant downvotes, would have their reputation scores decreased. Other means for updating reputation scores exist, and this disclosure should not be considered as limiting the scope of application and use of a reputation-based content management and distribution system.

Users may also be associated with different reputation scores for different types of content and/or genres. For example, a script that relates to a story may have a genre of e.g., thriller, comedy, romance, drama, space, etc. Another example is music, which may be in the genre of e.g., classical, rock, pop, hip-hop, vocals, instrumental etc. In certain embodiments, users may then have different reputation scores depending on the genre. This enables a content creator who is creating, and/or has created, a piece of content, (e.g., a script for a horror movie), to identify one or more users who have satisfactory reputation score(s) for a specific genre (e.g., horror movies). In certain embodiments, users requesting help may be allowed to set individual thresholds for what is satisfactory. Thresholds in accordance with numerous embodiments of the invention may be set as relative thresholds, e.g., “scores in the upper 25%”. Reputation mechanisms in accordance with several embodiments of the invention are disclosed in U.S. Provisional Patent Application No. 63/247,331 titled “Token Validity Assessment Technology” by Markus Jakobsson, the disclosure of which is incorporated by reference herein in its entirety. In many embodiments, reputation can be expressed in the form of reputation tokens as disclosed, e.g., in U.S. Provisional Patent Application No. 63/213,251 titled “Token Creation and Management Structure” by Markus Jakobsson and Stephen C. Gerber, the disclosure of which is incorporated by reference herein in its entirety.

Collaboration systems in accordance with numerous embodiments of the invention may incorporate plagiarism-detection technologies, such as techniques disclosed in Christian Collberg, Stephen Kobourov, Joshua Louie, Thomas Slattery, “SPlaT: A System for Self-Plagiarism Detection,” published in IADIS International Conference WWW/INTERNET 2003, Algarve, Portugal 5-8 Nov. 2003; in Grozea, C., Gehl, C. and Popescu, M., “ENCOPLOT: Pairwise sequence matching in linear time applied to plagiarism detection” published in 3rd PAN Workshop. Uncovering Plagiarism, Authorship and Social Software Misuse 2009; and/or in Wenpeng Yin and Hinrich Schutze, “Convolutional neural network for paraphrase identification”, published in Proceedings of the 2015 Conference of the North American Chapter of the Association for Computational Linguistics: Human Language Technologies, 2015, the disclosures of which are incorporated by reference herein in its entirety. A person of skill in the art can recognize that other plagiarism detection techniques can also be used.

In a number of embodiments, various methods as described herein may be performed by a device, node, server, cloud server, computer and/or other entity having computer processing means, for checking the originality of content/for enabling collaborative work on content. The device, node, server, cloud server, computer and/or other entity having computer processing may have a single physical unit. The device may also be distributed into several physical entities. Hereinafter, the device, node, server, cloud server, computer and/or other entity having computer processing means can be referred to as a node.

Nodes in accordance with certain embodiments of the invention may be part of a network and/or system owned by, and/or rented by, a service provider, wherein the service provider may offer the service of checking originality of content/for enabling collaborative work on content.

Processes for collaboration can include receiving content from a content creator referred to as the originator. The originator may upload the content to the node by a laptop, computer, smartphone and/or any other device having communication means for communicating with the node. The content may be text, audio, video, pictures, etc.

In certain embodiments, collaboration systems can construct graph representations of the received content. Graph representations can include characterizations of elements/events of the content, thereby creating a fingerprint of the content as a whole. As described above, there can be many different ways to characterize the content in order to build a graph representation of the received content. This may be by creating a tree structure, vector(s), matrices, state diagrams, etc. This can enable the node to represent the received content in a manner that is unique to the content and easily comparable to other content being represented in the same manner.

Collaboration systems in accordance with a variety of embodiments of the invention may also determine novelty scores between for content based on graph representations and/or fingerprints of the content and of already existing content. By comparing the graph representation of the received content with graph representations of other content, the node may thus determine how different and/or how similar the received content is from other content. This may identify any plagiarism and/or just minor alterations to already existing content.

Processes in accordance with several embodiments of the invention can assign reputation scores to the originator, wherein reputation scores can be based on the novelty score such that a higher novelty score leads to a higher reputation score. By doing this, anyone who tries to copy existing content can be identified and given a very low reputation score, whereas anyone creating new content that does not have any similarities to existing content can be given a very high reputation score.

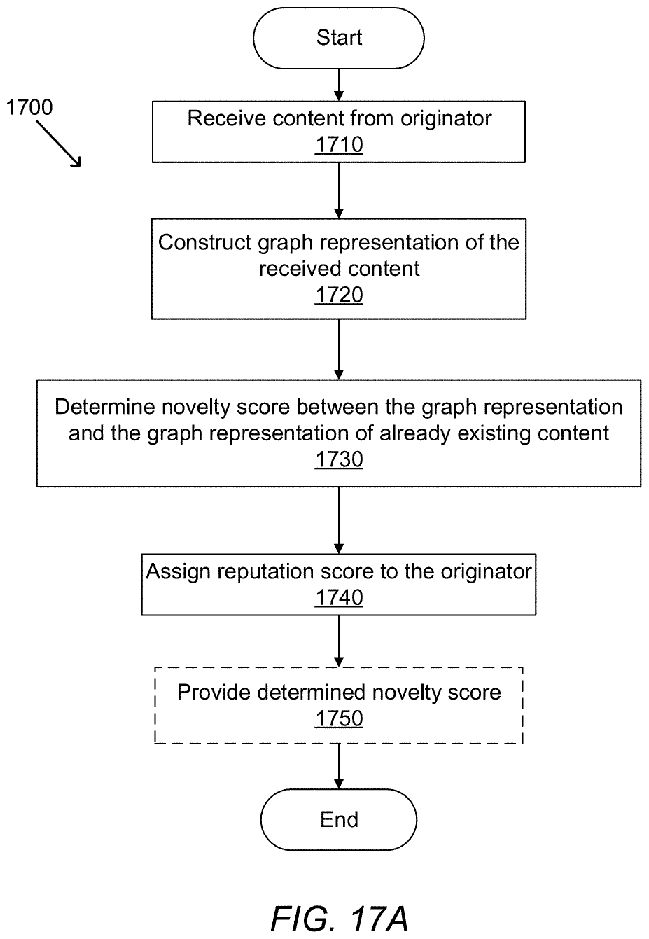

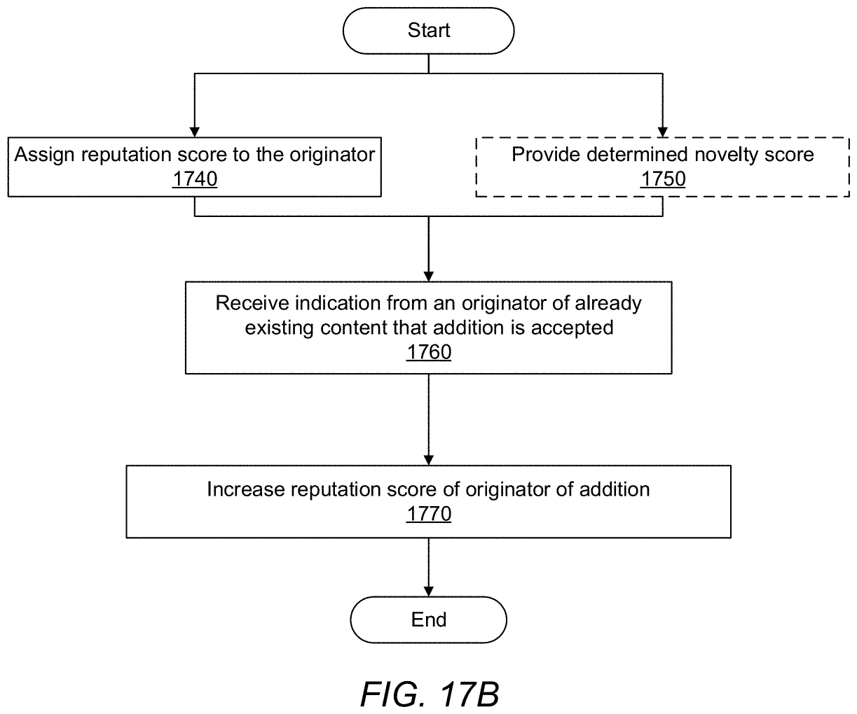

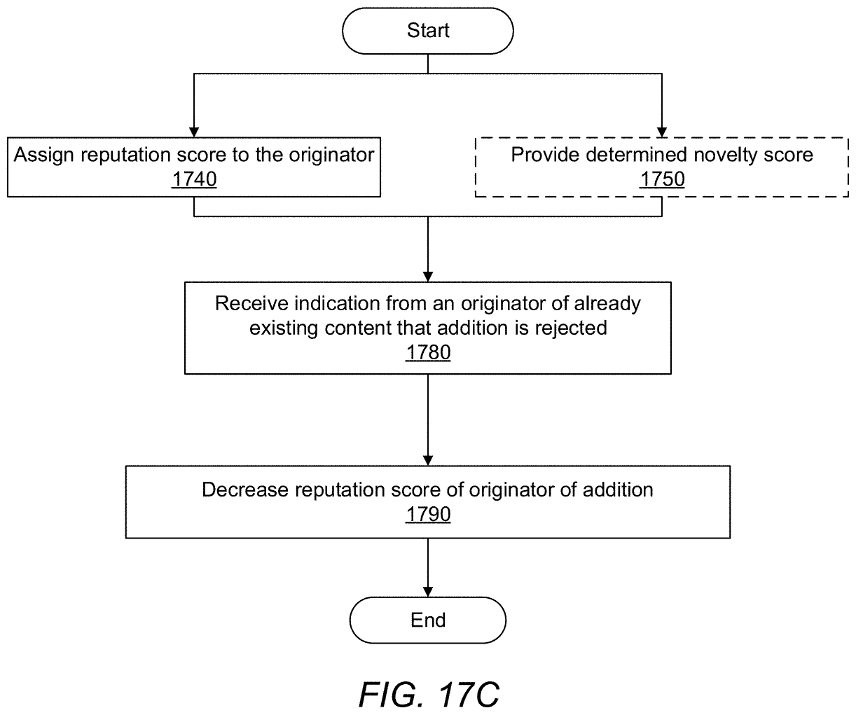

A flowchart depicting a process for checking originality of content and/or for enabling collaborative work on content in accordance with an embodiment of the invention is illustrated in FIG. 17A. The content may be created by a content creator, herein also referred to as an originator. The content may be an addition to existing content. The content also may be totally new content, that is not an addition to any existing content. The process may be performed by an entity including, but not limited to a device, node, server, cloud server, computer and/or any entity having computer processing means. The entity performing the process may be a single physical entity. The entity performing the process may be distributed among several physical entities. The entity performing the process may, but is not limited to, belong to a service provider and/or be part of a network of the service provider. The service provider may provide users with the ability to check originality of content and/or enable collaborative work on content.

The process 1700 receives (1710) content from the originator. In certain embodiments, processes may receive the content through the originator uploading the content to a database. The originator may also send the content directly to an entity facilitating the reception of the content, including (but not limited to) a service provider and/or a device, node, server, cloud server, computer, other entity having computer processing, etc.

Process 1700 constructs (1720) a graph representation of the received content. Graph representations may include one or more characterizations of elements/events of the content, creating a fingerprint of the content as a whole as described above.

Once the graph representation and/or the fingerprint is created, process 1700 determines (1730) a novelty score between the graph representation and/or the fingerprint of the content, and the graph representation and/or fingerprints of already existing content. The existing content may be any content accessible to the entity performing the process, including but not limited to content already uploaded to and/or received by the entity performing the process. For example, there may be several different databases accessible via the Internet that include content of the same type as the received content. Here examples of type may include audio, video, text, picture, etc. A novelty score may be a measure of the degree of novelty of the content. As such, the novelty score may be used as a metric for how much new content differs from any existing content. Content may be a murder mystery wherein the novelty score indicates how much the content differs from other murder mysteries. Some relevant factors may include, but are not limited to the way the victim was murdered, the reason, who the perpetrator(s) is/are, where it happened, time, age etc.

Process 1700 assigns (1740) a reputation score to the originator. Reputation scores in accordance with numerous embodiments of the invention can be based on the novelty score such that a higher novelty score leads to a higher reputation score. This is a way to indicate to the content providers and others, how much content(s) of the originator differs from existing content. A very poor novelty score may indicate that the originator tends to copy parts from existing content and/or at least base its content on existing content. Processes in accordance with several embodiments of the invention may also help indicate direct plagiarism as that would render a novelty score of zero. Should the process detect plagiarism, the originator of that plagiarism may be blocked, a warning might be issued to other originators, and/or content creators.

FIG. 17A further illustrates an option within the embodiment, wherein the process can include providing (1750) the determined novelty score to one or more users. In numerous embodiments, novelty scores can be provided to one or more of the originators. Processes in accordance with a variety of embodiments of the invention can provide the determined novelty score to the author of the content that is most similar to the content received from the originator. This may enable the originator of the already existing content to inspect the newly received content and make a judgment of how similar the newly received content is to the already existing content. In an example, the originator of the already existing content may issue a rating that may affect the novelty score of the originator of the newly received content. In many embodiments, novelty scores can be presented to any user being registered with a content provider. In this optional step, the process may make the novelty score of the originator available to other users and/or originators.

A flowchart of another exemplifying embodiment of the process for checking the originality of content and/or for enabling collaborative work on content is illustrated in FIG. 17B. In some embodiments, the received content can include an addition to already existing content. In this example, the process receives (1760) an indication from an originator of the already existing content that the addition is accepted by the originator of the already existing content and increases (1770) the reputation score of the originator of the addition. In many embodiments, originators of already existing content may have the option of either accepting and/or rejecting the addition. The addition in this case can be the received content from the originator in step 1710. When the originator of the already existing content accepts the addition, it most probably means that they are happy with the addition. Thus, it can be said that the originator of the addition did a good job and thus the reputation score for the originator of the addition goes up, and/or is increased. Even though not illustrated in FIG. 17B, the originator of the already existing content may also have an option of giving a rating of satisfaction, which may further determine the amount of the increase of the reputation score.

A flowchart of another exemplifying embodiment of the process for checking the originality of content and/or for enabling collaborative work on content is conceptually illustrated in FIG. 17C. In this example, the received content can include an addition to an already existing content. In this figure, the process receives (1780) an indication from an originator of the already existing content that the addition is rejected by the originator of the already existing content and decreases (1790) the reputation score of the originator of the addition. Analogously with FIG. 17B, the originator of the already existing content may have the option of either accepting and/or rejecting the addition. The addition in this case being the received content from the originator in step 1710. In case the originator of the already existing content rejects the addition, it most probably means that they are not happy with the addition. Thus, it can be said that the originator of the addition did a poor job and thus the reputation score for the originator of the addition goes down, and/or is decreased.

Even though not illustrated in FIG. 17C, the originator of the already existing content may also have an option of giving a rating of satisfaction, which may further determine the amount of the decrease of the reputation score.

In some embodiments, a computer program may be provided. The computer program may include computer-readable code which, when run in a processing unit included in an arrangement in a node as described in this disclosure causes the node to perform the method as described herein. In a number of embodiments, a computer program product including the computer program is provided. Processing units may be included of the arrangement in the node, e.g., with a DSP. Processing units may be a single unit and/or a plurality of units to perform different actions of procedures described herein. The arrangement in the node may also include an input unit for receiving signals from other entities and/or arrangements, and an output unit for providing signal(s) to other entities and/or arrangements. The input unit and the output unit may be arranged as an integrated entity and/or as one or more interfaces. Furthermore, the arrangement in the node may include at least one computer program product in the form of a non-volatile memory, e.g. an EEPROM, a flash memory and a hard drive. The computer program product may include a computer program, which includes code means, which when executed in the processing unit in the arrangement in the node causes the node to perform the actions described herein. The processor may be a single Central Processing Unit, CPU, but could also include two or more processing units. For example, the processor may include general-purpose microprocessors; instruction set processors and/or related chips sets and/or special-purpose microprocessors such as Application Specific Integrated Circuits, ASICs. The processor may also include board memory for caching purposes. The computer program may be carried by a computer program product connected to the processor. The computer program product may include a computer-readable medium on which the computer program is stored. For example, the computer program product may be a flash memory, a Random-Access Memory RAM, Read-Only Memory, ROM, and/or an EEPROM, and the computer program modules described above could in alternative embodiments be distributed on different computer program products in the form of memories within the node.

C. Collaboration for Application Development

Application development is a long and arduous process, and developers are not incentivized to share insights and techniques with each other, which can hinder development and slows down progress that society could have enjoyed with a more rapid development speed. One form of application for which rapid development is desirable is games, as games have a great potential to convey teachable insights, collect valuable statistics and perform marketing experiments to determine likely consumer preferences. With a slow development process, these benefits may not be unlocked. Collaboration systems in accordance with certain embodiments of the invention can address these and related problems by introducing a new paradigm for computing in which collaboration is incentivized. Although many of the examples described herein describe game development, one skilled in the art will recognize that similar systems and methods can be used in the development of a variety of different applications, without departing from this invention.

Collaboration systems in accordance with certain embodiments of the invention may incorporate a platform for collaborative development that can be applied to gaming. Collaborative platforms for development can also be applied to other types of software applications, such as (but not limited to) education software. Examples of such uses can be described herein. In a variety of embodiments, collaboration platforms can include various types of content, such as (but not limited to) executable elements (e.g., executable scripts), multimedia content, graphical content, layout templates, tables used for configuration choices, etc.

Collaboration platforms in accordance with several embodiments of the invention may be associated with an application (e.g., a game) that end-users can download and use. Developers, seeing that some such applications can be very successful, can download the collaboration platform and generate derivative works relative to the platform, where this derivative work is another application, such as another game. This enables rapid development of games at a very low cost. It benefits the developers, who can roll out new games at a very rapid rate and may benefit from the short turnaround time from idea to product. Collaboration platforms in accordance with several embodiments of the invention can be used for hypothesis testing. For example, a developer with a hypothesis related to consumer behavior can test the hypothesis with minimal effort by using the platform to develop and deploy a new application. An example of a hypothesis may be whether it is possible to teach geography to elementary school children in a way that is more appealing to the children than current methods, which creates greater educational benefits. After testing a collection of different hypotheses of how this could be done, the game developer may select one version of the game, corresponding to the winning hypothesis, and further develop this using additional rounds of hypothesis testing, which may take the form of A/B testing.

In various embodiments, an application is one type of derivative work relative to a software platform, and a second platform that is based on a first platform is another form of derivative work. Some developers, whether of platforms and/or of applications, may incorporate elements from other platforms, where one such element may be a routine for rendering a particular type of image, such as the fur of a dog. Derivative works in accordance with certain embodiments of the invention may depend on multiple platforms and/or platform elements.

In some embodiments, collaboration platforms and/or individual platform elements can be implemented as executable tokens with associated license policies. License policies in accordance with several embodiments of the invention can express various licensing policies, such as (but not limited to) royalties, terms and usage restrictions, and/or reporting requirements. For example, a royalty-related policy statement may specify that any derivative work must incorporate a license policy by which the originator of the platform obtains 5% of the revenue made from the game, and no less than $0.50 per install. Another example may state a profit-sharing requirement related to in-game advertising. One example term-related policy may require the use of only character designs from one of a pre-specified set of sources, where use of some of these character designs may require an additional license. In another example, a policy may specify a requirement of what types of advertisements can be used in the derivative work. An example usage restriction may require the absence of nudity. An example reporting requirement may state that any time users install the game, create a profile, perform an in-app purchase, and/or uninstall the game, information about such an event must be logged and reported to an aggregator within 24 hours, where the aggregator can report such information back to the platform originator.

In various embodiments, collaboration platforms and/or platform elements can be verified to satisfy a set of criteria, such as security and/or privacy criteria, and can be certified to satisfy the criteria. In certain embodiments, verification and certification may be performed by service providers specializing in the analysis of software, and may be associated with insurance. Insurance in accordance with a number of embodiments of the invention may be expressed using insurance tokens and related techniques, as disclosed in U.S. Provisional Patent Application No. 63/233,304 titled “Targeted Execution Environment” by Markus Jakobsson, U.S. Provisional Patent Application No. 63/220,488 titled “Content Origination Determination and Tokenization” by Markus Jakobsson, U.S. Provisional Patent Application No. 63/229,924 titled “Integration of Real-World Data and Measurements into Distributed and Consensus-Based Environments” by Markus Jakobsson, and U.S. Provisional Patent Application No. 63/213,251 titled “Token Creation and Management Structure” by Markus Jakobsson and Stephen C. Gerber, the disclosures of which are incorporated by reference herein in their entirety. In a number of embodiments, policies may specify that certifications of the platform apply to derivative works. For example, if a developer uses a certified platform, the certification may apply to the derived work, if so specified in a policy associated with the platform. In various embodiments, policies may also require a re-certification, which may be performed at a lower cost than a certification of a platform, as a large portion if the work may already have been done.

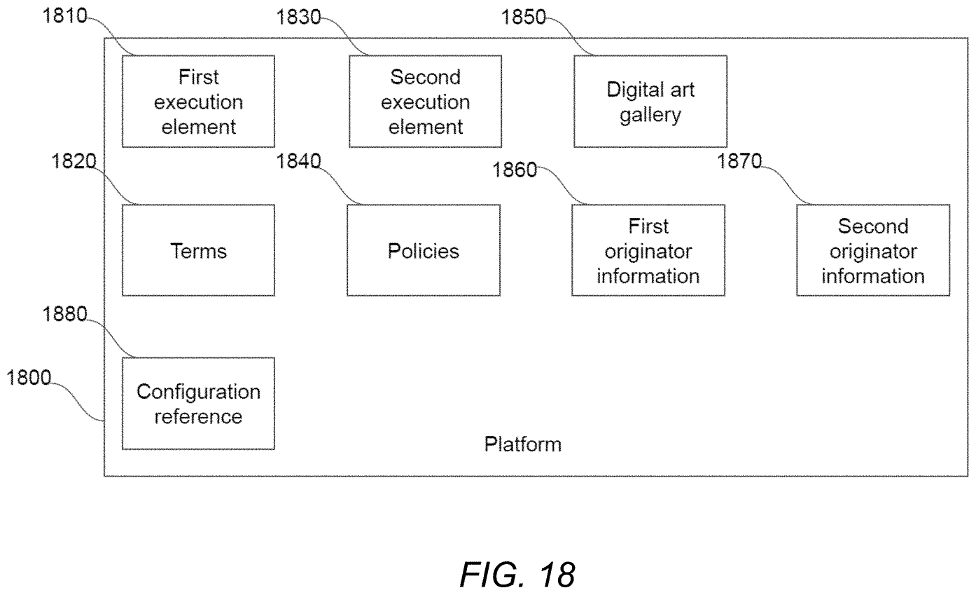

An example of a platform configuration for collaborative development implemented in accordance with some embodiments of the invention is illustrated in FIG. 18. Collaborative development platforms in accordance with many embodiments of the invention may include any number of execution elements to enable collaboration. Collaborative development platform 1800 includes a first execution element 1810, terms 1820, a second execution element 1830, policies 1840, digital art gallery 1850, first originator information 1860, second originator information 1870, and configuration reference 1880. First execution element 1810 may cause images from a database such as digital art gallery 1850 to be shown. Second execution element 1830 causes hints corresponding to the images to be rendered.

Terms 1820 can specify how the platform may be used. For example, the terms may specify that any derivative work needs to use imagery from a specific digital art gallery 1850. Other terms may specify that no derivative works teaching English Language can be allowed.

Policies 1840 associated with the platform may include terms directed to license rules. Policies 1840 may state that any end-user installation must result in a payment of a sum to the platform originator under certain circumstance. For example, this may be $0.10 if the installation is associated with users in North America, and/or $0.05 if the installation is associated with users in Asia.

The platform 1800 may also incorporate identifiers for the originator of content generated through the platform. First originator information 1860 may specify an identifier of the originator. Second originator information 1870 can specify an identifier of a second originator. A second originator may be a developer generating a product as a derivative work from another product created by a party corresponding to the first originator information 1860. The number of originators that may be associated with a platform can be limitless.

A configuration reference 1880 can indicate the location of tools to perform the configuration of platform 1800. The configuration reference 1880 may specify tools that can be part of the platform 1800 or that can be external to the platform 1800.

Although a specific example of a platform configuration is illustrated in this figure, any of a variety of platform configurations can be utilized to perform processes for collaborative development platforms similar to those described herein as appropriate to the requirements of specific applications in accordance with embodiments of the invention.

One example application can be a game that teaches school children ecology. The game may be based on showing an image of a natural environment such as a forest, wherein users can spot animals. At the bottom, there may be a list of names of species that may be spotted in the image. The player could turn around in the natural environment and potentially move around in the natural environment. If users spot any of the animals corresponding to a species in the list of species and click on it, they get one point and a new name of a species to be found, until a pre-set number of species can be found and the user advances to a new level that may correspond to different species and/or a different image of a natural environment. In another configuration of the same game, the user instead of spotting and identifying animals may spot and identify plants and/or mushrooms. Different levels may correspond to different levels of difficulty, where the level of difficulty may be expressed by how large the image and/or animated character corresponding to the species is, whether it is partially obstructed and/or fully visible, whether it sits still and/or engages in a characteristic activity, and whether it makes a sound and/or performs an action. This game may be configured for different levels of difficulties including animals of various commonalities, thereby matching the abilities of students at different levels. At a lower level, the user may have to identify a beaver, a deer and a rattlesnake, while at a higher level, the user may have to identify and distinguish a titmouse, a goldfinch and a blue jay. A teacher may be able to set levels, and also select geographies to match locally observable species and/or current lectures. This may correspond to a platform that allows identification of visual elements, with optional sound associated to them, in an environment set by the game designer, where the matching may be made using contents of a database that can also be selected and/or generated by the game designer.

The same platform can enable a game that teaches cooking. This game may provide a recipe in a scrollable form on the left, and an image of a kitchen on the right. Users may need to follow the recipe by selecting ingredients, in the right order, and selecting utensils and actions. One example utensil may be a bowl and another may be a whisk. Actions may include frying, increasing the temperature, reducing the temperature, stirring, whisking, cracking eggs, and more, and may be selected from a list of actions identified by icons. Both ingredients and utensils may be selected by clicking on graphical representations of these in the kitchen. In one version, the user can move around in the kitchen by clicking on different areas. Users may play in educational mode, where the recipe is shown, but may also play in a challenge-mode, where only the name of the dish is shown. A user may be given suggestions for what recipes to try next based on the performance, where the performance may be measured by how well the recipe was followed, and whether the ingredients were cooked to the right extent. A user may be given points based on how well they play, and suggested when they are ready to try to cook a given recipe for real, i.e., outside the game environment.

This game can be created on the same platform as the ecology game. It has a kitchen environment instead of a natural environment, it allows the user to move around, it allows the user to select items. The ecology game may not utilize the feature of identifying actions (such as frying something). The ecology game also may not require a pre-specified order. For example, if two species can be shown to the user and named, the user can select either of them, without the order mattering. In the recipe, there may be a specific order.

In accordance with several embodiments, features of different games can also be configured in manners that differ. For instance, the images may be different in the games, as may sound effects. These differences can correspond to configurations that the designer associates with items, actions, and instructions. A developer may play one of these games and think of another game that could be created based on the same underlying platform. The developer could then upload new item images and/or videos, new backgrounds. In doing so, they may configure a new game to be created based on one or more policies and/or constraints. The new game may be described using a simple programming language that may be visual and block-based, and therefore require a minimum of programming knowledge. A more technically competent developer may add code from a code library they wrote and/or imported, and may use a more advanced way of expressing the functionality of the game in terms of rules, steps, and designs.

Another developer, designing games, may use the same template to make a game that teaches the names of items to English as a Second Language (ESL) students. The developer may at some point decide to also have a version for Spanish, but has decided to develop a German-language version and/or a Chinese-language version. The developer may specify terms that its game may be used as a template for other developers of similar games, including German versions and Chinese versions. Alternatively, terms may be specified that versions can be made, but not for the development of Spanish-language games. Alternatively, the terms may specify the geographic locations a version of the game can be sold and/or used.

In numerous embodiments, the original developer of an application (e.g., a game) may specify a license policy indicating the royalty payment this party requires if his application is used as a template, on top of any license payments required by the developer of the platform that was used to generate the application they developed. For example, the original platform may have a license that specifies that for every sale of a derivative work, the originator of the original platform gets $0.19. Alice may be a developer who generates a game using this platform. She lists her game in a game store, which may be an online marketplace, at $2. The marketplace may charge a commission of $0.25 for each purchase, leaving Alice with $2−0.25−0.19=$1.56 for each copy that is sold. Alice may state that if somebody uses her game as a platform, to derive a derivative work that is a second game, then Alice requires a payment of $0.10 for each sale if the sale is in North America and/or Europe, and/or $0.05 if the sale is elsewhere. In addition, Alice may specify terms, such as that no derivative works relating to teaching English can be allowed. Bob creates a game to teach Hebrew, based on Alice's game, and lists the game in a marketplace in South America, for $1.50. The commission of the marketplace Bob used is 10%, which is $0.15 for this game. A user from Canada purchases Bob's game. Bob receives $1.50−0.15−0.19−0.10=$1.06, the marketplace gets $0.15, the developer of the platform gets $0.19, and Alice gets $0.10. Whereas Bob makes a smaller profit than Alice does, his effort was also lesser, as he used Alice's game as a template. A game, or more generally, a software element, may specify a term that no derivative work can be allowed, and/or that any derivative work is allowed for which all profit goes to a charity of choice of the party specifying the terms.

Terms of collaboration arrangements may be presented in various forms. In some embodiments, terms can be expressed as a smart contract. In some embodiments, terms can be machine readable, and may include an executable element that determines whether a given potential derivative work satisfies the terms. In instances where this cannot be reliably determined in an automated manner, an admin associated with a trusted third party and/or a marketplace with liability if there is abuse may assess whether a given derivative work is acceptable. In various embodiments, terms can also be expressed in human-readable manners. For example, human-readable terms may allow Bob to determine whether he is allowed to use Alice's game as a platform when developing a game teaching Hebrew. Bob can also use a search engine that may be associated with a marketplace to determine what platforms and games that can be used as platforms he can use for a Hebrew-language game, and/or for a game he wishes to sell in Portugal, and/or a game that uses DISNEY characters and teaching Italian language to toddlers. The search engine can determine, from the available games and platforms, which ones can be allowed by the associated terms, and may then rank those based on criteria that Bob specifies in the search engine, such as that the game must be appealing to toddlers. Alice, when developing her game from the template of her choice, can identify portions of the data, such as banner logos, that may not be included in the licensing of her game, as a platform, to other developers. When Bob starts to configure games based on the platform and Alice's configurations, he may have to choose a design for such areas, e.g., by using an archive provided in the template and/or external graphic design tools.

Game developers may implement processes to test hypotheses related to the desirability of particular game designs. For example, the game developer of the cooking game described above may wish to determine whether players use the game because it is fun and/or because they can be making the food that is being described, in order to better understand the audience of the users of the game. If a large number of users appear to make the food, the game designer may provide evidence of this to a grocery brand that may be interested in partnering on the ordering of ingredients. The game developer may also want to determine the opportunity to promote recipe collections from third-party providers, provide in-game coupons to purchase cookbooks and cooking utensils, and other related promotional opportunities. To determine this, the game designer needs to understand the profiles of the players, including how they use the game, what their demographics is, and what products and services they might be interested in. To establish this, the game developer may form and test various hypotheses. For example, to determine a demographic hypothesis, the game designer can provide in-game coupons of products that can be strongly related with demographics, ask questions about demographics at setup, ask users who enjoy the game to fill out brief surveys in order to unlock more in-game features, and more.

Game developers may also collect data through their games. A game developer may also wish to test a hypothesis about the real world by designing a game to obtain information about the real-world phenomenon. For example, consider a situation in which a toy manufacturer wishes to perform a test related to two possible character designs and their likability to teenage girls. To do this, the toy manufacturer develops, and/or hires somebody to develop, two versions of the same game, both of which can be made to appeal to the target audience. These two versions can be then made available, potentially in a manner that does not allow the player to determine and/or select what version they receive when downloading the game. Based on statistics related to the usage of the game, the toy manufacturer learns whether one of the designs has a significant advantage over the other. For example, if one of the versions results in an average game play time of 1.4 h per user and the other results in an average gameplay time of 2.2 h, then the second version is superior. If the difference exceeds a threshold such as 10%, the toy manufacturer may determine that the design associated with the second version should be used.

To configure a game based on a platform, a developer may use a freestanding tool, and/or a tool built into the platform. Configuration tools in accordance with various embodiments of the invention can present options related to the platform and enable the game developer to make selections. In one usage scenario, the game developer starts with a set of pre-made configurations and modifies one or more of these and/or adds one or more optional configurations. In one usage scenario, the developer starts without any selected configurations. Instead, he selects building blocks and configures these. Configurations in accordance with various embodiments of the invention may include uploading of digital art, and/or selection of digital art from associated archives. In one example setting, some of these archives may include digital art that is associated with licenses, where a payment is due on inclusion of the digital art in a game. In other settings, payment may be taken as users pay for and download a game. In certain embodiments, a hybrid between these two approaches is taken, where a basic fee is charged for using artwork, and an additional per-use fee is charged as the game is purchased, rented, installed and/or performs an action such as displaying an in-ad advertisement. In some instances, an owner of artwork available to be used in a game may require a payment in the form of data, such as demographic data of the users, e.g., the zip code of users and the estimated and/or determined gender of the user. In various embodiments, constraints can be expressed as terms and/or as license rules, as described elsewhere in this disclosure.

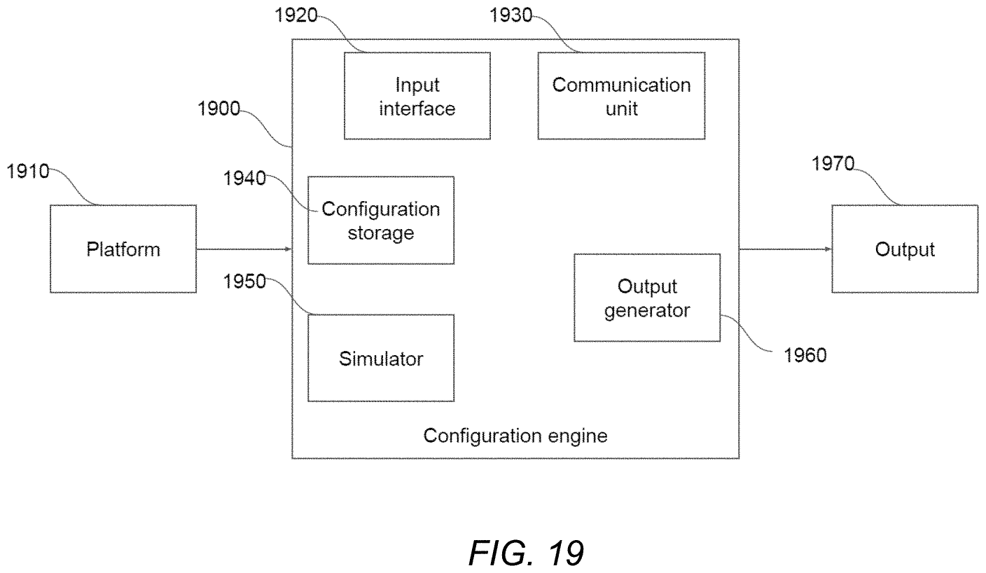

A mechanism for implementing configuration in accordance with many embodiments of the invention is disclosed in FIG. 19. FIG. 19 illustrates a configuration engine 1900 taking the platform 1910 as an input to generate an output 1970. Configuration engine 1900 includes input interface 1920, communication unit 1930, configuration storage 1940, simulator 1950, and output generator 1960. Output 1970 may be based on selections made using an input interface 1920. A developer making selections can access external information using communication unit 1930. External information in accordance with a number of embodiments of the invention may include but is not limited to, external graphics libraries, music libraries, and code libraries. Selections may be stored in configuration storage 1940. Using a simulator 1950, the developer can also emulate software created from the platform 1910 using the selections provided using the input interface 1920. Developers may use configuration to produce software as output 1970. The input interface 1920 may generate, using output generator 1960, the output 1970. In some embodiments, developers may use input interface 1920 to generate distributable versions of the software in the form of output 1970. In producing output 1970 from a platform 1910, they may process the platform 1910 using selections stored in configuration storage 1940. Outputs in accordance with a number of embodiments of the invention may take various forms, such as (but not limited to) an executable token, a new platform based on an existing platform, etc.

In various embodiments, a platform and/or a game can be expressed as one or more tokens, such as (but not limited to) executable tokens, license tokens, and/or control tokens. Control tokens in accordance with several embodiments of the invention can specify various rules to control the execution of a platform, such as (but not limited to) whether portions of the execution must take place in a TEE and/or DRM, how data is allowed to be stored, how the software package can be interacting with the execution environment, etc.

The use of tokens with targeted execution environments is described in U.S. Provisional Patent Application No. 63/233,304 application titled “Targeted Execution Environment” by Markus Jakobsson, the disclosure of which is incorporated by reference herein in its entirety. Collaborative platforms in accordance with a number of embodiments of the invention can run in an execution environment as described in that application. In this description, the term platform may refer to an application (e.g., a game) if it permits derivative works to be generated from it, as disclosed herein. Terms and policies may refer to constraints. Digital art can include (but is not limited to) imagery, videos, sound effects, and/or descriptors identifying how such can be rendered and/or used. When executable tokens can be executed, they cause local processing that results in users experience; they may also cause a generation of log entries, where such log entries can be communicated to external entities that perform book-keeping events (e.g., the transfer of money from a first account to a second account). Other examples of book-keeping events include the generation of demographic information, reports that describe usage statistics, and more.

In various embodiments, service providers can create a platform that is free of charge for developers and which can be used to create a large variety of games and other applications. A user of an application created from the template may still have to purchase applications developed from this platform, and/or may have to watch advertisements, have a subscription and/or a membership, etc. The service provider creating the platform may require that demographic data is provided each time an application is installed. Demographic data in accordance with certain embodiments of the invention may be associated with a Digital Rights Management (DRM) unit and/or Trusted Execution Environment (TEE) associated with an end user. In a number of embodiments, demographic data may have been provided by the user when they first configured the DRM and/or the TEE. In addition, the DRM and/or TEE may store a profile describing the user and their behavioral profile, as disclosed in U.S. Provisional Patent Application No. 63/233,304 titled “Targeted Execution Environment” by Markus Jakobsson, the disclosure of which is incorporated by reference herein in its entirety. Demographic data in accordance with a variety of embodiments of the invention includes a profile of the user. Profiles in accordance with various embodiments of the invention may include a characterization of the user and their preferences, but not individual events and observations used to determine the characterization. For example, one profile may indicate that a given user, with a 92% certainty is interested in action movies and cartoons; is 15-20 years old with an 82% certainty; and is associated with a billing zip code 94041, which is Mountain View, Calif., as well as with an IP address indicative of a Bay Area high school. This may be the demographic data that the service provider creating the platform wishes to obtain, along with information of the application used and the duration of use. This can help the service provider understand the preferences of various demographics. Another service provider creating platforms may require information about users' financial classifications. For instance, an estimate based on zip code and in-app purchases of the person's disposable income. As users install an application, they may be notified of the type of information that this application can share, e.g., “Your personal information like your name and address can remain secret, but your zip code can be shared, in addition to assessments of your likely gender, age and what types of movies you like.” A user who does not agree to this can halt the installation of the application. In some instances, users may be provided with an option, such as “You agree to share your zip code and age information (app cost: $2.99) and/or you prefer not sharing your zip code and age information (app cost: $5.99)”, followed by a selection prompt. A user can pre-configure their systems to only allow applications with terms of service that can be acceptable to the user, and not show other applications as being available for the user to install.

In various embodiments, developers may specify that games can be used as platforms by anybody who has reached a certain level. Additionally, they may indicate that the only type of modification such players/developers may perform may be to add one or more levels. The developer may also be able to state terms that specify that such modifications does not lead to any changes of the constraints, including the terms and the policies, and/or that the developer of the derived work cannot add advertisements. In some embodiments, developers may specify terms saying that games can be used freely as platforms, but only for settings where the distribution channel of the derived work performs licensing of the derived work only for educational entities such as schools and daycare centers.

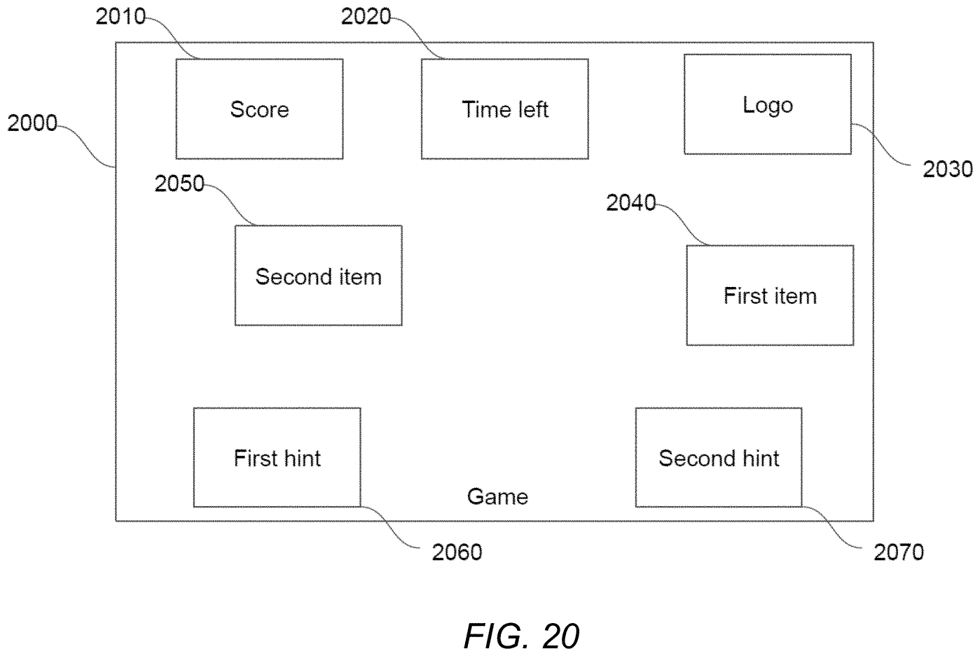

An example game, configured in accordance with several embodiments of the invention is illustrated in FIG. 20. A first game 2000 may be a derivative work generated using a configuration engine incorporating an example platform. A game 2000 may have features including, but not limited to a display of score 2010, time left 2020, logo 2030, first item 2040, second item 2050, first hint 2060 and second hint 2070.

In accordance with many embodiments of the invention, the features of the produced game may vary. When designing a game 2000 based on a platform, the developer may decide that the score can be updated per item found as part of the configuration. The first item 2040 may be worth a different amount of points than the second item 2050. The developer can also select the initial value of the time left 2020 indicator to be used. The time left 2020 may differ based on the level. A logo 2030 associated with the game may be generated and/or uploaded.

Various items and features from various sources may be included in the game 2000. For example, the game may include a first item 2040 and second item 2050 from a digital art gallery. If permitted by terms, items may be added by uploading other digital art items. The logic of the game can also be selected and/or programmed. For example, the developer may select that to score a point, a player may first need to click on first hint 2060 and then on first item 2040. Alternatively, the developer may select that, to score, the player needs to click on first item 2040 and drag and drop this to first hint 2060. Yet again, the developer may select that it is sufficient to click on first item 2040 in order to score, and that the first item 2040 can be automatically moved to the first hint 2060 after. The logic of the game may be expressed by selections received using input interface and stored in configuration storage.

In certain embodiments, rules may correspond to terms of collaboration. In this illustrative example, the developer may determine that it is acceptable for other developers to use game 2000 as a platform. In this case, it may be determined any configuration except logo 2030 may be used as long as the derived work is exclusively sold only in a different set of countries from where the game 2000 is sold. The developer may also specify the revenue required for each installation of derived work games, and/or other monetization terms and policies, such as profit-sharing rules related to in-app advertisements. In another example, the terms may indicate that the game 2000 is not allowed to be used as a platform to generate derivative works.

Terms and policies in accordance with numerous embodiments of the invention can be enforced by restrictions on features including but not limited to the tools used to create derived works, the marketplaces where games and other applications can be sold, and/or by devices such as end-user consumer devices on which games can be executed. Each one of these environments may include TEEs and/or DRMs for purposes of enforcement.

Distributed software such as a platform 1800 and game 2000 may also include elements used to control enforcement, and may be obfuscated and/or otherwise protected against reverse-engineering and/or manipulation using software protection technologies used in commercially deployed software to detect and/or limit attempts to abuse.

In various embodiments, at least some parameters defining an application such as a game can be values that can be collectively determined and/or generated from a real-life measurement. For example, the difficulty of a level may be a function of what percentage of players have reached another level when playing the game, based on a vote among players with at least 10,000 points, and/or based on a value that is determined by a consensus of miners and verifiers, as disclosed in U.S. Provisional Patent Application No. 63/232,728 titled “Secure and Intelligent Decentralized Technology” by Markus Jakobsson, Stephen C. Gerber, and Ajay Kapur, the disclosure of which is incorporated by reference herein in its entirety. The finalization of the generation of an application from a platform may be performed in response to the developer pressing a “compile” button and generating an executable from the platform and the stored configuration values. Finalization in accordance with a variety of embodiments of the invention may also take place at the time of the installation of the application on an end-user device, and/or even, at run-time in the case of an interpretative language being used to describe the application code. In various embodiments, a mapping may be made from the platform and developer-made selections to an executable package to be used by an end-user, based on a platform selection that can be provided by the developer, the end-user requesting to download the executable package, and/or automatically based on a determination of the end-user's preferred computational device, operating system and other parameters, such as screen size. In some embodiments, mapping can be performed in response to a request to download and/or install the execution package, which may be a game. In others, it may be done in response to an action by the developer. This may be by the developer clicking on “generate executables of the indicated types”, and/or clicking on “compile” and indicating a target computing environment. In other scenarios, mapping can be performed at least in part in response to the end-user starting the application and/or using the application, e.g., in contexts where the programming language is interpretative.

In numerous embodiments, constraints such as terms and policies may be evaluated on computational devices executing a platform and/or an application. These computational devices may have TEEs and/or DRMs that help maintain compliance with the constraints. The software, i.e., the platform and/or application, may also have built-in security mechanisms that protect against abuse. Some such mechanisms include personalization of software instances relative to the recipient computational device, partial encryption of software where the software itself holds the keys to decrypt and/or receive these from a service provider in response to a verification and/or authentication of the device, user and/or both. Another protection mechanism is software obfuscation. Constraints in accordance with various embodiments of the invention can also be evaluated on marketplaces, e.g., vending mechanisms where players and developers select games and platforms. For example, marketplaces can determine, based on credentials associated with a requester, the requester's location, and the requester's device type, operating system type, and more, whether to serve the requested content. Similarly, tools used for the development of software based on platforms can verify compliance with constraints, as can providers of data such as external sources of digital art associated with a given platform. In some instances, remote software attestation can be used to determine likely compliance.

In some embodiments, remote software attestation can, for example, be used to determine that a requesting device does not run offending code of some type, such as malware and/or software used to facilitate pirating. In some instances, a combination of methods such as these can be used to maintain compliance with constraints.

In one example use, a tablet manufacturer wishing to promote its tablets in educational settings may provide a large array of platforms that developers can use free of charge for the development of software for schools, where these platforms have terms that require that the execution environment of the games generated as derivative works from the platform must be run on the tablet manufacturer's tablets. In an alternative example, the tablet manufacturer also may permit the use of these games on tablets manufactured by competitors, but in such cases require a license and/or a subscription to be paid by the educational institution. Thus, the disclosed technology may enable low-cost software to be rapidly produced and deployed in many settings, such as educational settings, as a way for manufacturers and service providers to gain a foothold in the market. When this happens, their competitors can be likely to respond by also providing access to platforms and games, and as a result, school districts, hospitals, and after-school activities benefit. The disclosed technology can also help the distributed use of applications developed to help students learn languages, practice for standardized tests, and more.

D. Managing Composite Content

Current digital rights management (DRM) tools are geared towards consumption of static content, where such content is generated and finalized in a location external to the consumer of the content. The content that can be produced is finalized at the time it is received by the content consumer. Whereas there may be a small number of selections the content consumer can make, such as a selection of whether to display subtitles and a selection of the language of subtitles, these selections are already prepared by the content producer, and a mere selection remains. Beyond a selection of available content options, today's DRM solutions do not display dynamic content that depend on real-time events, e.g., actions taken by the content consumer.

Collaboration systems in accordance with numerous embodiments of the invention may incorporate techniques for management of composite content. In a number of embodiments, at least some components of composite content may be owned by one or more content creators. In many instances, content creators may have different policies for how content may be combined.

In some examples, a first content producer may provide an anime character voice that can speak to the content consumer, and a second content producer may provide content for what the anime character can say. This arrangement may allow a consumer to choose a bedtime story to be read by a child's favorite anime character, in the voice associated with this character. Consumers may further choose what bedtime story is to be read by the anime character, where this content may be originated by a source different from the source of the anime character. The creator of the anime character may require that only wholesome content be presented using the anime character, which can correspond to a first DRM policy. The creator of the bedtime story may not have any requirement on how their content is presented, other than that it may not be presented on devices associated with mass-display, such as a movie theatre projector, but only on personal devices, such as tablets and personal computers. This corresponds to a second policy. The notion of “wholesome” may be governed by a third policy, which may be provided by a third content provider. A consumer may add additional constraints in the form of additional policies, e.g., a policy regarding the time of the day a presentation may take place, for example avoiding scary stories at bedtime, and/or the type of content that may be presented.

One or more devices and/or applications associated with the presentation of DRM material can determine whether the set of policies permit the presentation of a given combination of content in a given context. This may, for example, be performed on an authorized consumer device and/or on a gateway device that assesses combinations and enables the presentation on authorized consumer devices. When a gateway device is used, the device may perform some of the processing associated with a combination of sources. In several embodiments, the combination of content may include computationally intensive tasks.

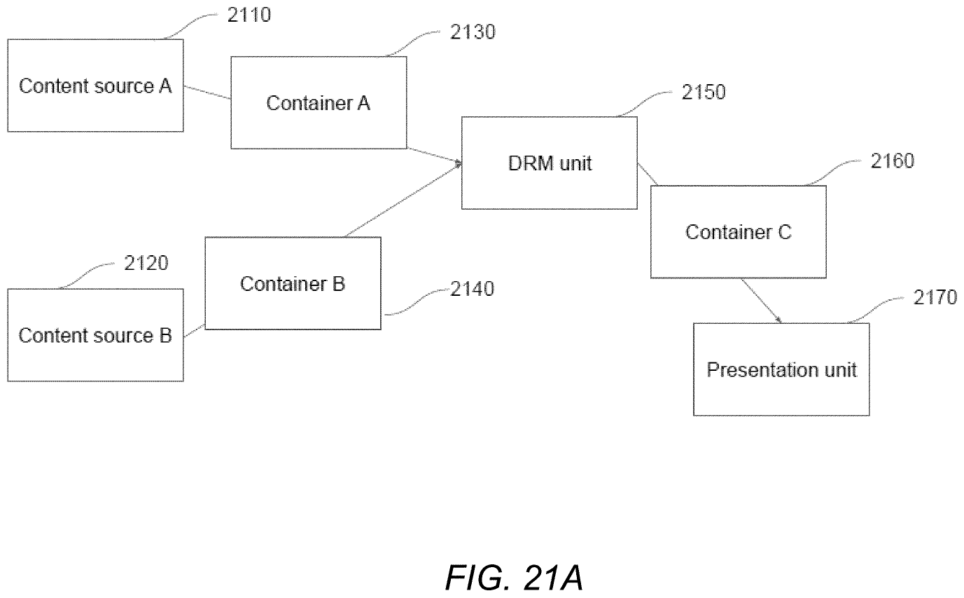

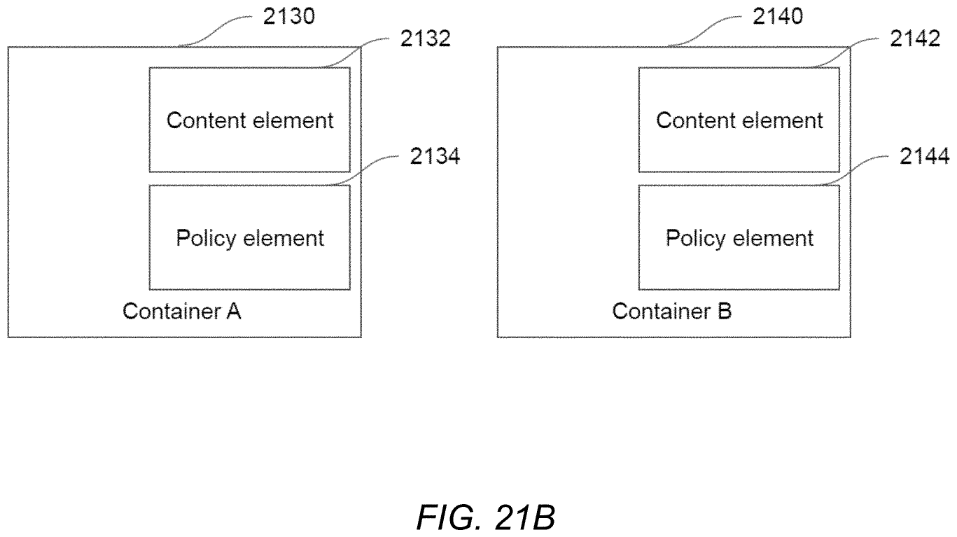

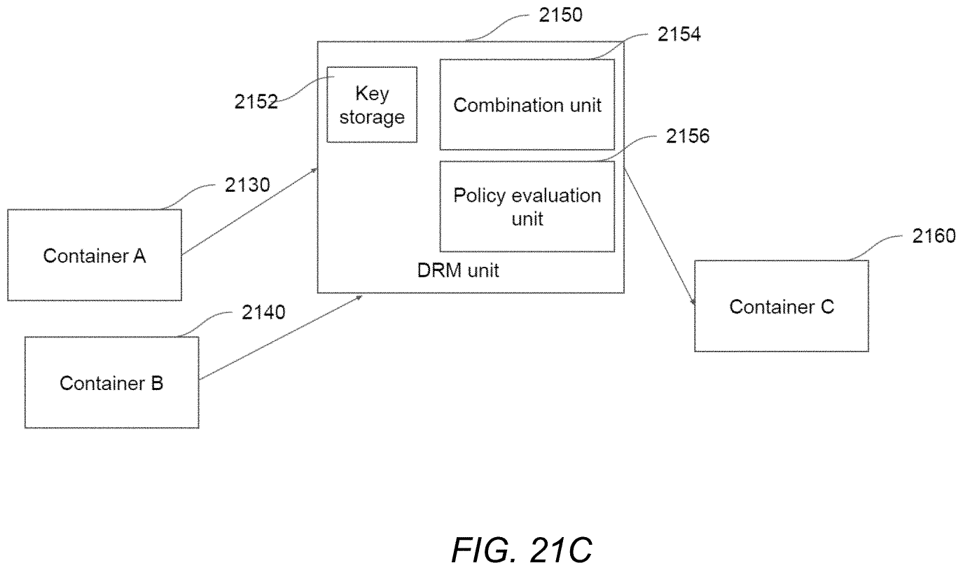

An example of the combination of content from two or more content sources in accordance with multiple embodiments of the invention, is illustrated in FIGS. 21A-21C. The combination illustrated in FIG. 21A illustrates at least one source associated with content with one or more policies. Content may be transferred through the use of one or more containers. In this example, a first content source, content source A 2110 can produce container A 2130 and transmit it to a DRM unit 2150. Content source B 2120 may produce container B 2140 and also transmit it to DRM unit 2150. DRM unit 2150 can then create container C for composite content generated from content associated with containers A and B. The data in the new product container C may then be displayed by user interfaces. In doing so, container C 2160 may be transmitted to presentation unit 2170. At the presentation unit 2170, content associated with container C 2160 may rendered, displayed and/or otherwise presented using one or more user interfaces.

Container configurations in accordance with some embodiments of the invention can be exhibited in FIG. 21B. Containers may include content elements 2132, 2142 disclosing content, and policy elements 2134, 2144 disclosing content policies. Container A 2130 may include a first content element 2132 and policy element 2134. Container B 2140 may include a second content element 2142 and policy element 2144. In some embodiment, portions of the data associated with content elements 2132, 2142 may be encrypted and/or otherwise obfuscated. DRM units in accordance with numerous embodiments of the invention may enabled to decrypt and/or de-obfuscate any encrypted and/or obfuscated data.

A DRM unit that includes a combination unit, policy evaluation unit, and key storage in accordance with various embodiments of the invention is illustrated in FIG. 21C. DRM unit 2150 of this example includes key storage 2152, combination unit 2154, and policy evaluation unit 2156. Key storage 2152 may be used to store one or more keys to decrypt and/or de-obfuscate incoming containers, such as container A 2130 and container B 2140. Policy evaluation unit 2156 may determine whether policy elements 2134, 2144 can be compatible. When policy elements can be compatible, policy evaluation units may enable a combination unit 201 to generate a composite content element from the content elements 2132, 2142.

The composite content element may be held new product container, such as container C 2160. Container C 2160 may include the data associated with container A 2130 and container B 2140, including, but not limited to content data and policy data. The data in container C 2160 may also, at least in part, be encrypted and/or obfuscated.

Multiple configurations of the container configurations similar to those disclosed in FIGS. 21A-21C may be implemented. For example, DRM units and presentation units may be housed in the same physical consumer device, such as a phone and a laptop. In various embodiments, DRM units and presentation units may be separate physical units connected by a cord and/or a wireless connection.

Collaboration systems in accordance with a variety of embodiments of the invention may enable dynamic content. Content preparation units (or combination units) in accordance with several embodiments of the invention may dynamically combine content, where at least one source of content is not a priori known. This source may be referred to as a dynamic source.

In some embodiments, multiple sources for a piece of composite content may be dynamic sources. An example of a dynamic source is one or more sensors that determine a context associated with a consumer of content. For example, the source may identify that a consumer is not attentive, and may generate a signal that causes the presentation of content to the consumer to be adapted to that. In the case of a bedtime story, the presentation of content may be performed at a lower volume and/or cease altogether. In the case of presentation of driving directions, a lack of attention may result in an alert; a suggestion for a coffee break; a reduction of distracting content such as the playing of music, etc. The decision of how to respond to a signal from a dynamic source such as this may be performed at the content preparation unit, for example. Another example of a dynamic source may be an entity associated with processing content from a football game. This source may identify portions of the display that can be used for the display of explanations and/or statistics, but without adding such explanations and/or statistics. The consumer may select their favorite commentator to be a provider of such explanations and statistics. This can also be a dynamic source of content.

Content preparation units in accordance with several embodiments of the invention may combine content with information obtained from the dynamic source, updating the content presented to the consumer. Combinations of content may be performed in one or more locations. For example, content from two sources of content may be combined at a gateway unit and the resulting composite content may then be combined with content from a third source, at the consumer device used for presentation to the consumer. This can permit the offloading of heavy computational activity from the consumer device to a computationally powerful device, for example, while also providing improved privacy in that potentially sensitive user data used for configuration may be used on the consumer device only, and may not be exposed to external devices such as a gateway device.

Some content may be commercial content, such as promotional material, advertisements, and more; other content may be proprietary content, such as movies, music, games, audiobooks, and executable content; yet other types of content may be user-generated content that can be accessed without incurring a billing event. Different content elements that may be of different types can be combined to create composite content, which is presented to users. In some embodiments, composite content can be personalized based on one or more personalization parameters that can be updated based on observed events. Events in accordance with a number of embodiments of the invention may include (but are not limited to) user inputs and/or sensor data indicating user actions, user locations, and/or environmental measurements.

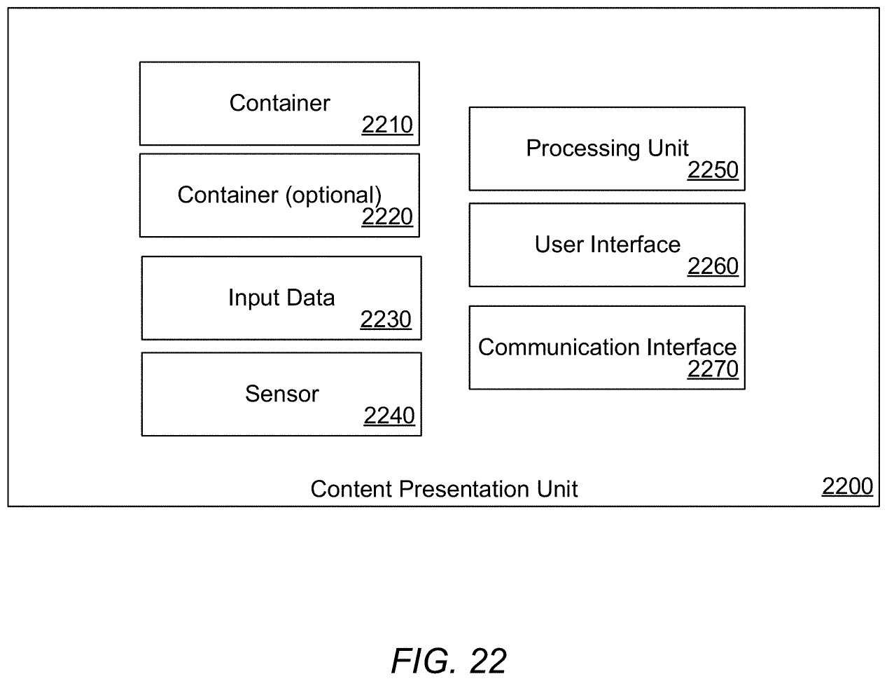

An example of a dynamic content presentation using a content presentation unit in accordance with an embodiment of the invention is depicted in FIG. 22. Content presentation unit 2200 includes containers 2210 and 2220, input data 2230, sensors 2240, processing unit 2250, user interface 2260, and communication interface 2270.

Processing unit 2250 processes received containers and/or other data. The processing unit 2250 may take as input container 2210 and container 2220. In a variety of embodiments, processing units may take only a single container as input. The processing unit 2250 may also receive input data 2230 from a sensor 2240. Container 2210 and optional container 2220 may be received using communication interface 2260. Upon receipt the containers 2210, 2220 may be stored and/or buffered before their content is combined with input data 2230.

The combination of container data and input data 2230 may create a signal that is sent to a communication interface 2270 and presented to users. The presentation may include, but is not limited to, rendering on images, playing sounds, generation of vibrations and/or other movement, as well as other types of output matching the type of content of container 2210, optional container 2220, and input data 2230.

The combination performed by the processing unit 2250 may be governed by policies associated with the containers 2210, 2220. The containers 2210, 2220 may also include executable elements in addition to policies. Special-purpose presentation units (or communication units) may have additional output formats, such as, for example, spraying water, operating a fan, heating and/or cooling a surface, and more. In various embodiments, content types may have policies describing how such special-purpose output formats may be integrated in the presentation of content. When such special-purpose output formats are not present, policies may govern alternative presentations and/or present some aspects of the content corresponding to the available output formats of content presentation unit 2200.

An example of a combination in accordance with a variety of embodiments of the invention may be the use of an animated character in a smart home, with various sensors connected to the same network as the “home” of the animation character as well as the user. Users can interact with the animation by watching its host show via NETFLIX, with which the smart device can communicate and/or otherwise observe traffic from/to, and the animation can start interacting based on specific time-based scenes. Users can play music via a smart audio system that is again connected to the smart home. The animation can then appropriately “virtually dance” to the music, e.g., synchronize animation movement to sound, which is one form of combination of content from two different sources in accordance with various embodiments of the invention. Users have the ability to use a touch screen and make the character jump and/or do some moves in real-time while listening to the music. The character starts to build a personality and uses A1 to learn from the user and personalize from their interaction with the environment. Another example is that the user might use their smart home to turn the lights off every day around 10 μm. The character may realize it is time to sleep and change its state. However, one day if the user does not sleep at 10 μm, the character might remind the user that “Hey, it's your bedtime”.

Collaboration systems in accordance with certain embodiments of the invention may implement a metering system that determines what sources can be used, and provides feedback that can be used for billing of the consumer as well as crediting content providers. This may include one or more components that may provide information that can be used to determine billing and crediting events as well as a consistency verification that is beneficial for purposes of fraud detection. For example, a consumer device may include a metering unit that collects and presents data that is periodically sent to a billing unit that may be a service provider on the backend. In addition, a gateway device may also include a metering unit that collects and sends metering information to the billing unit. The metering information generated by the gateway device may be less complete than the metering information sent by the consumer device, and may, for example, leave out information related to some sources that it does not process, such as a content source that may not convey data over the Internet but instead loads content from storage associated with the consumer device.

Billing units in accordance with some embodiments of the invention can determine what sources should be paid, and how much. The billing unit may also determine what consumers should be billed, and how much. In some embodiments, multiple billing units may manage this processing. For instance, one unit determines what sources should be paid, and how much, while another determines what the consumer should be charged.

In many embodiments, billing units may, in addition, determine whether there is likely abuse associated with an account. For example, a family account may be used by a very large number of users spread over a large geographic area as opposed to how family accounts more typically can be used. Detection of such events can be used to limit the presentation of content to devices associated with this account, to initiate security actions such as the resetting of passwords and/or blacklisting of devices, as well as suggestions of service agreement changes to accommodate a changing style of use. Such actions can be taken by a security unit distinct from the billing unit.

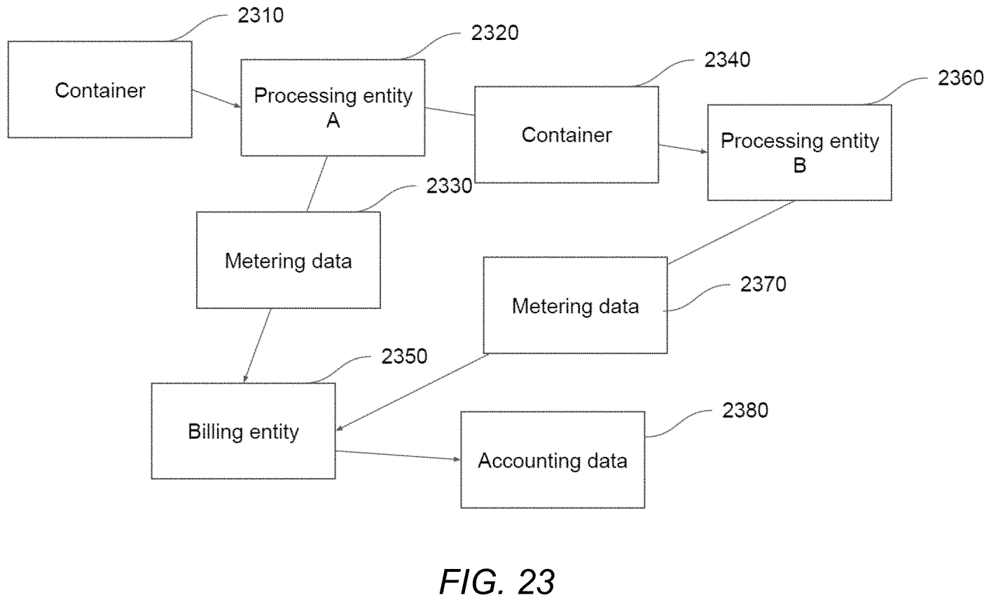

The collection of billing information in accordance with some embodiments of the invention is illustrated in FIG. 23. A processing entity, processing entity A 2320, may receive a container 2310 and optional additional containers. The processing entity may for example be the same as a DRM unit and/or a gateway unit. Processing entity A 2320 may process the initial containers 2310, creating a new product container 2340. The new product container 2340 may be the same as the originally received container 2310, but can include data from other containers. Processing entity A 2320 may send the new product container 2340 to processing entity B 2360. The second processing entity may be a physically separate unit from processing entity A 2320 and/or be a separate software unit. Processing entity B 2360 may also be housed on the same device as the presentation unit and/or be part of presentation unit. Processing entity B 2360 may receive the new product container 2340 and optionally additional containers.

The processing entities may also generate metering data related to the received containers. Processing entity A 2320 may generate metering data 2330 related to the initial container 2310 and optionally, to any actions taken on this data. Actions taken may include, but are not limited to combination with other data and/or its transmission to processing entity B 2360. Metering data 2330 can be transmitted to a billing entity 2350. Processing entity B 2360 can also generate. metering data 2370 related to the new product container 2340 and optionally, to any actions taken on this data. This metering data 2370 may also be transmitted to the billing entity 2350.

The billing entity may be used to determine the consistency of billable elements. Billing entity 2350 can process metering data 2330, 2370 and determine whether the two data elements can be consistent with each other. When consistent, billing entity 2350 may generate accounting data 2380. Accounting data 2380 may include, but is not limited to, information about what entities can be to receive funds, and how much, and/or what entities can be to pay funds, and how much. When inconsistencies can be detected, the billing entity 2350 may log them.

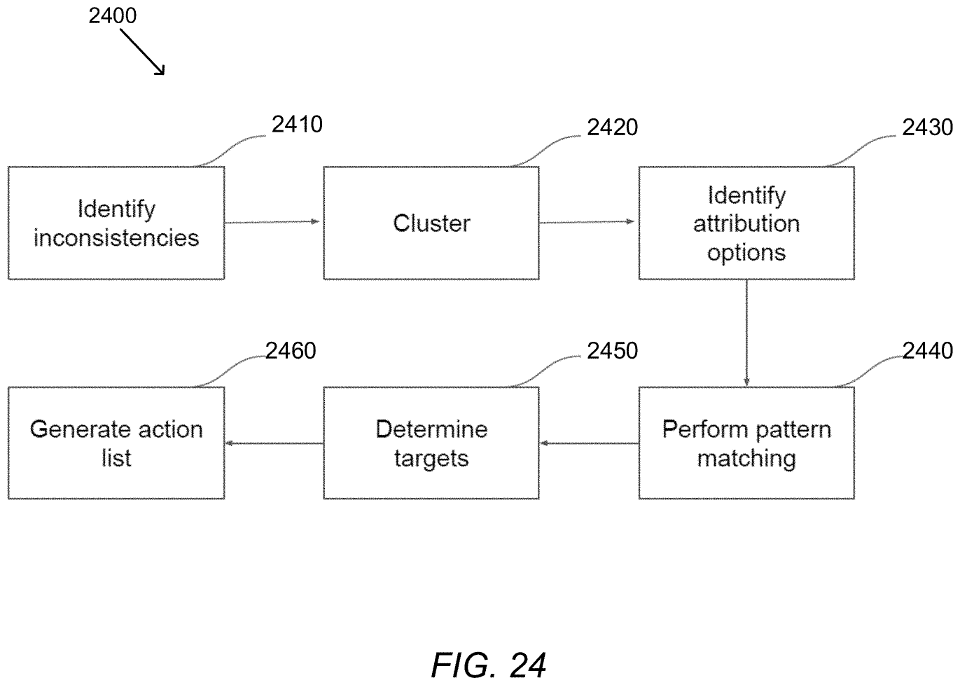

An example process of auditing of logs related to recorded inconsistencies, in accordance with various examples of the invention, is depicted in FIG. 24. Process 2400 may identify (2410) inconsistencies and related information from the received logs generated by a billing entity. For example, the identified inconsistencies and related information may include, but are not limited to, identifiers related to the reporting entities, such as processing entities; indicators of elements in associated metering data, that are not aligned; indicators related to the type of software/hardware the reporting entities can be associated with; and indicators of the user relationships of the reporting entities, where such indicators may include identifiers of users having installed, licensed and/or configured the reporting entities.

Process 2400 may cluster (2420) the data and indicators obtained in the prior step. This may be performed using methods including, but not limited to, statistical methods, machine learning techniques, and/or artificial intelligence scripts, for example.

Process 2400 may identify (2430) attribution options from the clustered data. Attribution options may be based on known patterns associated with known types of abuse and of indicators of yet-unknown patterns. The attribution may include indicators of the source of failure, including but not limited to lost data packets, malicious software modifications, failed hardware, attempts to piracy, attempts to overcharge, and more. Process 2400 may also perform (2440) pattern matching to determine the consistency of particular types of abuse.

Process 2400 may identify (2450) targets that can be particularly vulnerable to abuse. This may identify a collection of types of devices, for example, indicating that these may include vulnerabilities that enable them to be abused. The attribution and the identification of targets may also include, but are not limited to, a collection of user identities, geographical locations of users, and other data related to users. This data may be indicative of collusion among users, for example. The attribution and identification of targets may also include indications of processing entities, such as processing entity A, that should be blocked and/or not permitted access to content.

Process 2400 may generate (2460) an action list in order to select a remedial action to repair the system. Possible actions may include blocking, repair, etc. Blocking may include, but is not limited to revoking access credentials, not encrypting content that can be possible to decrypt for such entities; updating group encryption keys and redistributing such keys to members of a group not to be blocked; sending disabling instructions to executable scripts operating on devices that include processing entities to be disabled; and a combination and/or variation of such actions.

The selection of an action may depend on the severity of the detected inconsistency, and the type of attribution option determined in step 2430. For example, an attribution indicating an intentional corruption that may be associated with malware that is spreading may be more severe than an attribution indicating an individual user's attempt to modify hardware, which in turn may be more severe than an attribution indicating packet loss due to an internet outage associated with local weather. For some types of attribution, there may be no associated action to be taken. Additionally, the action may simply include the logging of an explanation of the likely problem in a log used for the maintenance and improvement of the system.

Several implementations in accordance with a number of embodiments may also include the use of executable content. For example, a content provider may provide a client-side script and/or a backend script that is used by a consumer to process other content and/or inputs. An example of the processing of content and/or inputs may include the marking up of the content and/or inputs, the formatting of it, and/or the modifications of it. For example, executable content that is associated with an end user device (such as a hearing aid) may identify whether a sound source is a desired sound source, such as a person speaking within ten feet of the consumer. The content may also identify an undesired sound source, such as the noise of a passing truck. In doing so, the former may be enhanced and the latter is filtered out and/or reduced. One provider of executable content may perform such processing in a different way, with different end results to a second source of such executable content. The consumer may therefore select one provider over another.

Multiple sources of executable content may also be used at the same time. For example, the above executable content may be used to reduce unwanted sound sources and enhance wanted sound sources. It may work together with a second executable and a third executable, where the second executable classifies sounds sources and labels them. This may include, but is not limited to, music, conversation, irrelevant speaker announcements in an airport. It may even identify different speakers, e.g., based on the frequency spectrum and/or their location as measured by directional audio processing and motion sensors, and differentiate between desired speakers and the sound of passersby speaking with each other. In addition to classifying the sources, it may separate the sounds from each other, so that each classified source is associated with a given sound file. Some of these sound files may be processed by a third executable. For example, the third executable may translate spoken language in real time, substituting the original sound file with the generated sound file. A fourth executable may then combine the sound files. The combination may be based on an assessment of importance, user preferences, and other contextual parameters. It may also introduce additional sound files, such as personal reminders, directional guidance, emergency alerts, and more. Such processing may be performed in a relatively powerful consumer device, such as a cellular phone. Meanwhile the final presentation may be performed in another device, such as a hearing aid in Bluetooth communication with the cellular phone, and/or visual information on eyewear in communication with the cellular phone. The sensing of inputs, such as sounds and situational indicators, could be performed by both of these devices, as well as on other devices, such as a wireless microphone worn on a shirt. The use of multiple sensors can enhance the quality of the inputs and help classify and filter inputs and content.

The use of executable content that can be obtained from a plurality of competing service providers can help improve services, and enhance innovation. It can also create a marketplace of service provision, where some content (such as the executable content) may enhance and/or modify other content (e.g., by selecting content, determining when to present it, translating it, etc.) Multiple collaborating executables may be used to enhance the content as it is presented to users. In the example given, the presented content is an audio sequence. However, this may be augmented with other types of presentation. For example, one executable may be a note-taking application that creates a written record corresponding to one or more sound files, where the written record is searchable and allows users to replay and/or read transcripts of selected portions of a conversation.

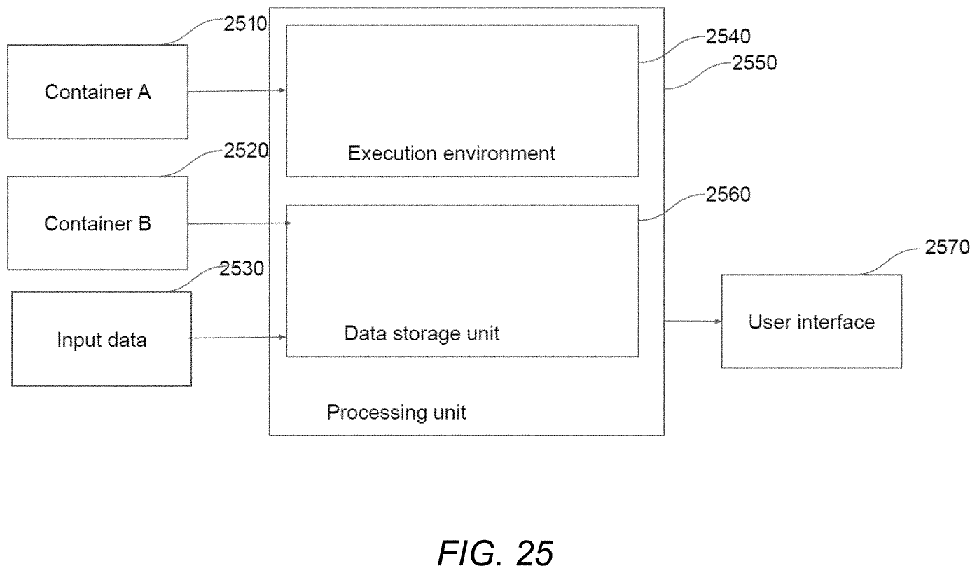

An example of presentation of executable content in accordance with some embodiments of the invention is illustrated in FIG. 25. As illustrated in FIG. 22, a processing unit 2550 may receive a container A 2510 and container B 2520, as well as input data 2530. In this example, container A 2510 may include executable content. As a result, the executable content may be loaded into an execution environment 2540, which may include an operating system running on the processing unit. Container B 2520 may be data content so can be loaded into the data storage unit 2560, along with input data 2530. The data storage unit 2560 may be accessible by the software executing in the execution environment 2540. The executable portions of container A 2510 may also be able to access the data storage unit 2560 when executing on the contents of container B 2520, input data 2530, and/or data derived from these.

The execution of container A 2510 in the execution environment 2540 may at least include a signal that is transmitted to the user interface 2570. This signal may be applied to enable the presentation of the executable data through the user interface 2570. In addition, the execution environment 2540 may also perform metering as may be described in earlier embodiments. Performing metering may include generating signals that processing units can be communicating to external entities such as a billing entity.

Many embodiments may implement a personalization component. This component may be provided in the form of executable content and may be part of the built-in functionality of a device used for conveyance, processing and/or presentation of content to a consumer. Personalization components in accordance with a variety of embodiments of the invention can obtain inputs and determine a modification of parameters. Inputs may come from, but are not limited to user actions and environmental conditions. These parameters may be locally stored on a consumer device, and may be stored on devices on the network such as cloud computers, and/or a combination thereof.

An example set of parameters correspond to values used to personalize the presentation of content to a consumer, e.g., using an anime character. The parameters may, for example, correspond to user preferences, a trained “personality” of the anime character, and/or a configuration provider by a third party.

User preferences can be explicitly expressed by a consumer who sets parameters using a user interface. For example, this may happen by stating “always translate Spanish to me.” User preferences may also be expressed implicitly, such as by observing that the user prefers jazz to rock based on the user's listening habits. A trained personality may be used to create digital pets that respond to user actions in a way consistent with their prior training, for example.

Configurations may be provided by third parties. For example, a configuration may come from a movie star and/or an influencer, whether as a paid service and/or as an opportunity to bond with a fan. Configurations of all of these types may be traded and/or sold, unless prohibited by an associated policy and/or based on the existence of a policy enabling such actions. Some configurations may be owned only by a limited number of consumers at a time, as governed by a policy associated with them, and/or may be resold and used freely by anybody with access rights.

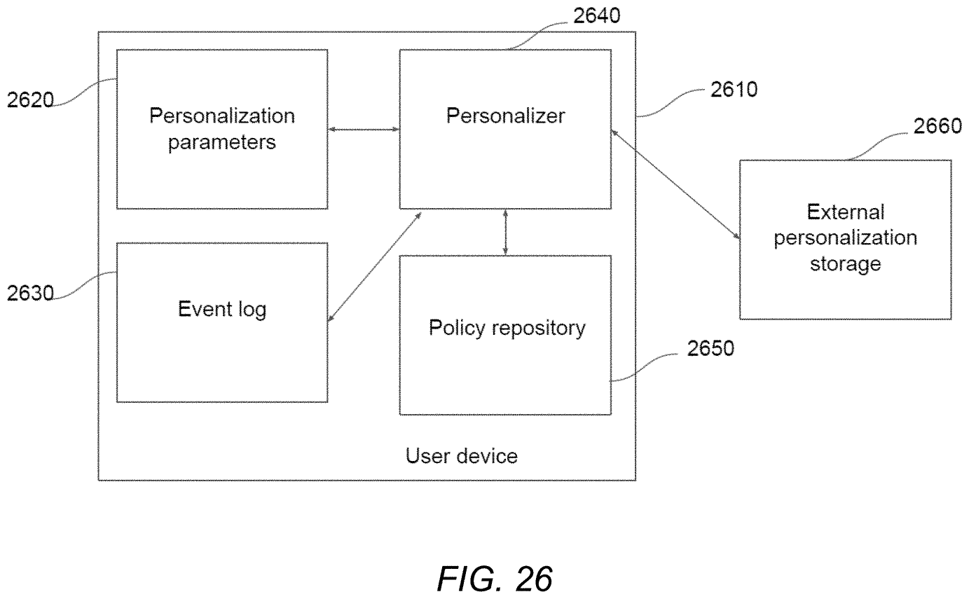

An example of a personalized content processing unit (also referred to as a personalizer), governed by one or more policies, in accordance with some embodiments of the invention is illustrated in FIG. 26. A user device 2610 incorporating a personalizer 2640 may also include one or more of a DRM unit, one or more processing entities, a processing unit, and a user interface. The personalizer 2640 may include hardware and/or software running in an execution environment.

The personalizer 2640 may review received content in order to tailor parameters to the user. The personalizer 2640 can read event log 2630 and/or received event notifications in real-time. The events associated with the event log 2630 may concern, but are not limited to, outputs from execution environment, metering data, information associated with containers, and input data. Example events may include, but are not limited to, indications that some content was presented, some content was combined with other content, some user input was received, a presentation of content was terminated, input data indicating user approval was received, and/or input data indicating users disapproval was received.

Personalization parameters in accordance with many embodiments of the invention may change in response to the obtained data. A policy repository 2650 may store one or more policies indicating how personalization parameters 2620 should be updated, including the conditions under which the personalization parameters 2620 can be updated. The personalization parameters 2620 may be associated with content of containers. For example, the personalization parameters 2620 may be governed by and/or associated with executable content of containers A and/or B.

The personalizer 2640 can also update and/or generate at least one personalization parameter in response to data. The personalizer 2640 may do so in response to at least one of accessing the event log 2630 and accessing the policy repository 2650. Personalization parameters 2620 can be periodically copied by the personalizer to external personalization storage 2660. The personalizer 2640 can access personalization parameters 2620 held in external personalization storage 2660, when originating from user device 2610 and when originating from another entity. Updating personalization parameters 2620 by personalizer 2640 may include, but is not limited to, performing training of a machine learning element, updating weights used by an artificial intelligence unit, selecting one or more preset rules, and/or modifying values indicating user preferences, such as volume settings, display speed, language settings, etc.

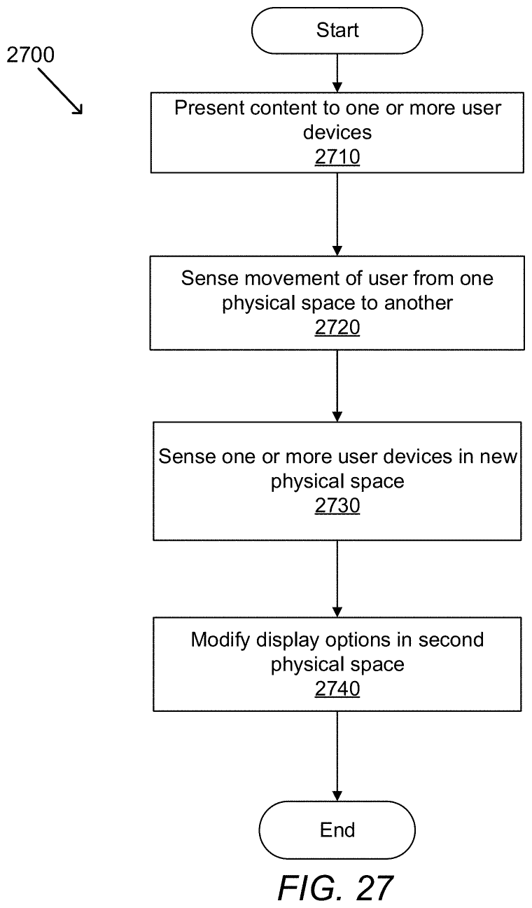

A process for integrating content in a feed, in accordance with some embodiments of the invention is illustrated in FIG. 27. Content may be integrated in a feed when presented to a consumer only and/or in a context in which the consumer is present. Process 2700, whether from a single source and/or from multiple sources, may present (2710) content to one or more user devices. User devices may include, but are not limited to, a screen, a wearable display, a loudspeaker, a headset, and more. Process 2700 may also sense (2720) the movement of users from one physical space to another, allowing for display options to be updated accordingly. In doing so, process 2700 may sense (2730) one or more user devices in the new physical space.

Upon sensing movement, the display options may be automatically modified based on the presence of available presentation devices. Once user devices can be sensed process 2700 may modify (2740) the audiovisual presentation of content as the user moves between physical spaces. For example, users may start a call with a friend in her office, at which time content may be presented to the user on a screen in the office. Example content may include images related to the friend, to remind the user of recent experiences. Sound may be presented to the user's headset and/or a speaker in the office, based on users configuration and/or previous expression of preference. As the user exits her office and walks to the bathroom, the video feed of the user can be replaced with a still image of the user, and body sounds can be blocked from being conveyed in the call. As the user enters the kitchen, a speaker on the kitchen counter may be automatically connected. The one or more microphones used to obtain input from the user may be adjusted. This may be based on whether the user is holding a phone in her hand and/or places it in a pocket; whether there can be microphones in the environment, and whether one or more of the potential microphones is picking up background noise, such as from wind. As microphone sources can be changed and/or the environment changes, different filters may be applied to make the sound as uniform as possible. For example, this may involve filtering out traffic noise as users exit her building and walk down the street. A video feed from the user may be augmented. For example, this may enhance visual aspects according to an executable service, before such content is presented to other people on the call.

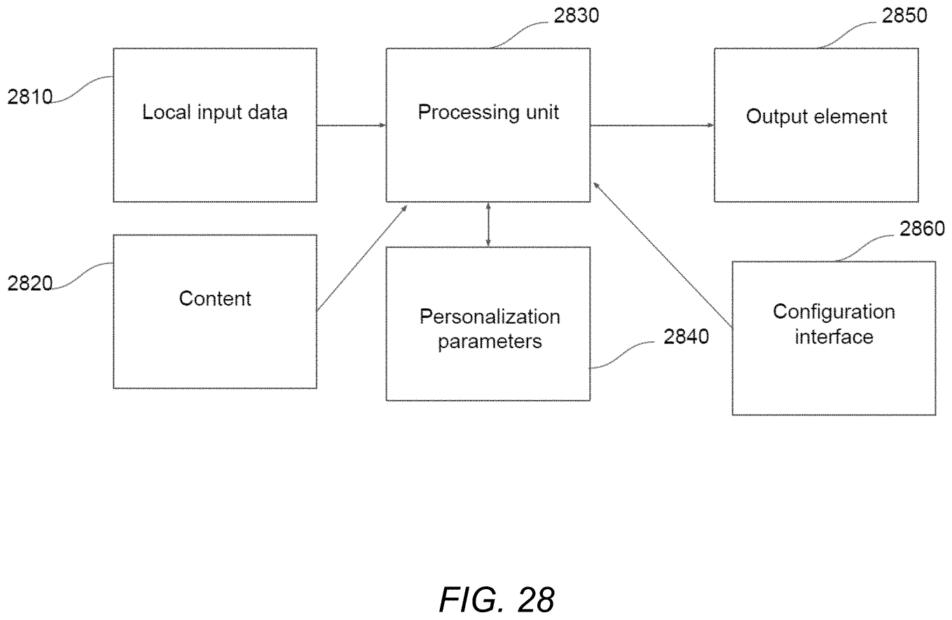

An example use of a presentation device in accordance with some embodiments of the invention, is depicted in FIG. 28. Processing unit 2830 may receive local input data 2810 from an associated one or more sensors. For example, a processing unit 2830 may be a part of a hearing aid and receive local input data 2810 in the form of audio from one or more microphones. Some of the sensors may be external to the presentation device. For example, a sensor may be part of a cell phone, mounted on a lapel pin, a pair of eyeglasses, etc. The use of multiple microphones may enable the determination of directionality and distance for sound sources. The processing unit can access a repository of personalization parameters such as information about an area of attention. The repository which may be configured using a configuration interface 2860. The configuration interface 2860 may be in the form of an app. Using the configuration interface 2860 can allow for the manipulation and/or assessment of the local input data 2810. For example, this may allow for the identification of a speaker for which to enhance emitted sound, and/or suppress sounds from other directions and/or of other bandwidths. The processing unit 2830 may then generate an output signal, altering the content 2820 which can be conveyed to the output element 2850. In some embodiments, the output signal may be in the form of an encoded audio signal, while the output element 2850 may be a speaker. If an encoded audio signal, the output signal may use an interface including but not limited to Bluetooth Low Energy (BLE) and a wired interface.

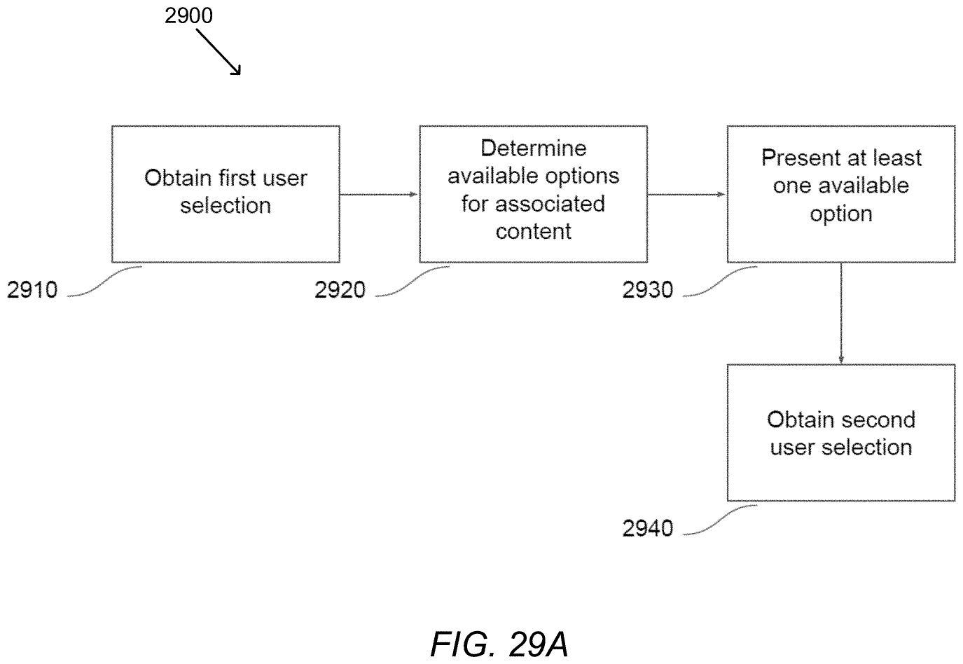

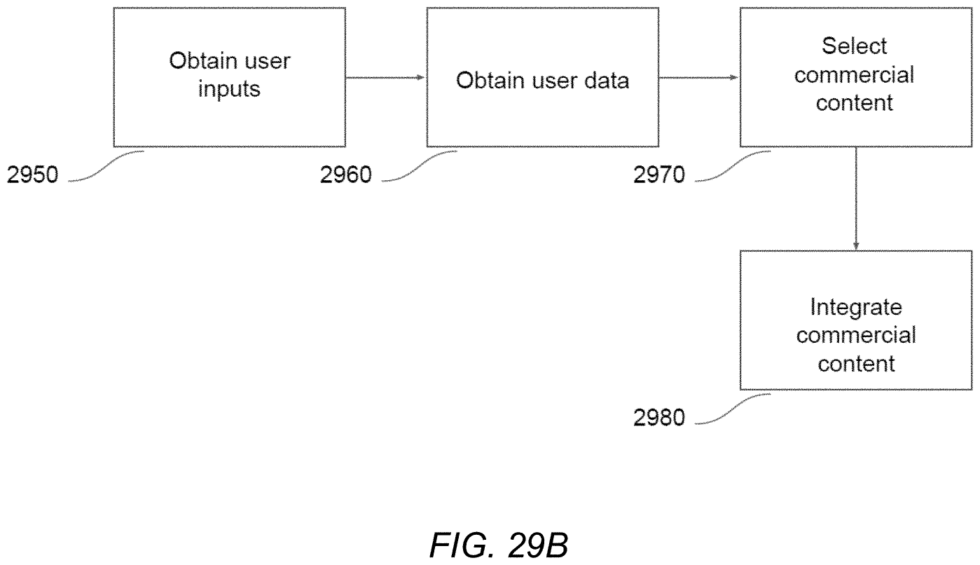

An example of a process followed by a user interface for selection of content, in accordance with numerous embodiments of the invention, is illustrated in FIG. 29A. In process 2900 obtains (2910) user selections from the system, using a user interface such as (but not limited to) a GUI and/or voice-driven interface. This selection may correspond to a first type of content. The first type of content may be an animated character for presentation of other content to the user. Process 2900 determines (2920) available options for associated content, in part on the basis of compatibility. Some of the associated content may have preferred content types that were specifically created to match with the first type of content. Some of the associated content may not have been intended for use with the first content but can be nevertheless compatible with the first content.

Compatibility in accordance with various embodiments of the invention can be determined based on an analysis of the relevant content. Compatibility may be influenced by evaluating policies associated with first content. In a number of embodiments, policies associated with candidate-compatible content may be relevant. To narrow down candidate compatible content, content recommendation mechanisms based on the selections of other users may be used. Content recommendation mechanisms in accordance with some embodiments of the invention may determine similarity weights associated with users, as described in U.S. Provisional Patent Application No. 63/210,040 titled “Content recommendation method”, which is incorporated by reference in its entirety. In various embodiments, similarity weights and alternative methods of determining user similarity can be used to assign a higher ranking to candidate content found to be compatible, when such content is more likely to be found desirable by the user based on past preferences, selections, and/or actions.

Process 2900 may present (2930) at least one available option to the user over a user interface. Process 2900 may then obtain (2940) a second user selection in the form of a second content, where the selected second content is one of the proposed contents presented in step 2930.

An example of a process for the selection and presentation of commercial content, in accordance with numerous embodiments of the invention, is illustrated in FIG. 29B. Process 2900 obtains (2950) user inputs. User inputs in accordance with certain embodiments of the invention may include, but are not limited to explicit user inputs, such as what may be provided by users using a GUI and/or voice-driven interface, and implicit user inputs, such as a geolocation associated with user devices and/or accelerometer data associated with user devices.

Process 2900 obtains (2960) user data as well. User data in accordance with a number of embodiments of the invention may include event data stored in a log such as event log 2630. In several embodiments, user data may include backend data indicating past user transactions, demographic data associated with the user and/or user account, an assessed age of users based on content selections, an assessed gender of users based on user preferences associated with the user, etc.

Process 2900 selects (2970) commercial content based on the obtained user inputs from step 2950, the obtained user data from step 2960, and placement requests by commercial content owners. Placement requests in accordance with various embodiments of the invention may be determined by bids for placement of commercial content to users with a specified interest, demographics, etc. In certain embodiments, commercial content may be associated with the obtained user inputs from step 2950 and the obtained user data from step 2960. Process 2900 integrates (2980) commercial content selected by the user with other content being presented to the user.

In accordance with several embodiments of the invention, content may come in a variety of forms, including (but not limited to) executable content. For example, executable content can include a script that selects sound elements to enhance versus suppress based on their location, directionality, timbre, continued presence, etc. One such script may suppress sources of sound that are not speakers within an 8-ft radius, and/or any sound source that has moved more than 1 ft in the last ten seconds. In a number of embodiments, emergency alerts can be presented, and ring signals from users' phones added to the sound stream to be output on output element 2850.

Different scripts may be of different quality, may have different pros and cons, may have different licensing requirements (such as costs), and may require different associated hardware contexts to execute. In many embodiments, an associated policy, which may correspond to a policy element, may capture limitations and requirements for whether a given script can execute on processing unit 2830.

Content in accordance with some embodiments of the invention may also include external signals, such as signals generated by a calendar application on an associated cellular phone, and where such signals may be audio signals indicating that it is time to leave in order to arrive at the next meeting location in time. Content 2820 may also be a newscast, music, a selected voice profile corresponding to the voice of a loved person and/or a celebrity, and/or signals corresponding to an audio book. In many embodiments, some of the content may be freely available, whereas other content may require a subscription, license, purchase, membership, etc.

In a variety of embodiments, the presentation of commercial content may include, but is not limited to, the form of responses to searches; mentions of the products in relevant contexts; and/or by presentation of the products with an animated character. The latter, for instance, may have the animated character take a drink of Acme sparkling water to quell a coughing attack of the animated character during a presentation of some user-selected content. This may be non-invasive to users, but can instead cause a feeling of natural engagement, and can be helpful to convey the benefits of associated products.

Another service, which may correspond to executable content, may enhance and/or hide some feature of the user according to the preferences of the user. This may make users appear in a preferred manner, whether this corresponds to a previous appearance of theirs and/or a preferred appearance (e.g., as generated by a service provider). Such a preferred appearance may be as an anime character, a famous person, and/or as the user herself but with perfect skin. Such example services can operate on the content produced by the user, where the content may be their video feed, before it is transmitted to others.

Other services may operate on content being produced by others, before being presented to the user, (on a screen, using other display devices, speakers, and/or presentation devices incorporating piezo-electric output elements that create sensations of touch, motion, etc.). This can allow two users wearing augmented reality equipment and/or virtual reality equipment to give each other a hug without being physically co-located.

In numerous embodiments, users may select one or more services corresponding to content types, content providers, and/or content configurations. They may do so using an interface describing the associated features. For example, users may purchase a first type of content, corresponding to a cartoon character that presents a first type of information. This may involve reading an SMS message received on the user's device to the user. In the context of this cartoon character, the user can review available augmentations and services, which can correspond to other content types. For example, one available type of enhancement is to use the same character for other types of content. This may require that the user “unlocks” the character by paying a fee to its originator, thereby enabling the cartoon character to convey other types of information, beyond contents of SMSs. For example, unlocking it may enable the user to have the cartoon character read audiobooks to the user.

Users can see what types of services may be enabled by unlocking specific characters, and then select which services can be of interest. Some services may be free and/or freemium. Others can be services that require a subscription and/or a one-time fee to be paid. Some users may purchase a book in audiobook format, then be offered the option of having it presented as an audio book. This may be included in the original purchase price and/or require a fee to be paid.

Users may also review the different types of presentation that may be available. A basic presentation may be free, whereas a presentation with the voice of a first famous person may require a subscription to that voice profile, which is a type of content, and the presentation by a given cartoon character also described above may require the selection of that character and the payment of a one-time fee. A user that selects the subscription to the content corresponding to a given movie star's voice, and optionally, appearance in the form of an on-screen character, may be able to have this character present material other than the given book. The material may include user alerts, the content of SMSs, directions from the GPS, and more. By upgrading a subscription, users may also be able to replace their own voice, in outgoing phone calls, with the voice of a character.

The originator of associated content and/or services may be reimbursed a flat fee per subscription, based on a metered approach in which a greater payment is due for a greater use of the content and/or service. This can be managed at least in part by the metering unit and the associated service, which can include part of what can be described as an operating system supporting the services disclosed herein.

As users select content, they may select the presentation formats of relevance, which may include, but is not limited to audio-only, audio-visual, with translation support, with support for wearable devices, etc. The format may also indicate whether presentation is user-facing and/or can be used to convey information to other people with whom the user interacts, e.g., in the format of augmenting the communications from the user. In a variety of embodiments, options can be conveyed to the user in the context of already-available services and content that the user has access to, and/or in a manner that is not specific to existing configurations.

Collections of configurations in accordance with several embodiments of the invention may be generated by third parties and provided as bundles for users to install, purchase and/or subscribe to. The party that bundles services may create a new type of content and/or service in doing so, and get reimbursed in response to providing this. Thus, this can enable a marketplace in which users and organizations can offer content and/or content improvement services by creating content (e.g., audio, visual, executable, instructions, etc.) and/or by combining and/or enhancing existing content.

In a variety of embodiments, users that select one type of content and/or combination of content, can be able to provide feedback of how they like the content. Feedback can also be implicitly obtained by the system by observing usage statistics. Based on such feedback, one or more other services can be recommended to the user, based on the preferences of the user and of other users with similar apparent preferences. The determination of what recommendations to provide can be based on the methods described in U.S. Provisional Patent Application No. 63/210,040 titled “Content recommendation method”, which is hereby incorporated by reference in its entirety.

In various embodiments, data used for the configuration of services can be obtained from the user device in addition to a collection of associated devices. For example, users can associate their user devices with a network, such as a WiFi network used at home and/or at work. Users may select to enable other devices associated with that network to provide data of relevance for the configuration of services. A printer, for example, may have a low-power Bluetooth (BLE) sensor that detects the close proximity of a phone, and determines who may be using the printer based on such information. This can be used to help send reminders to refill paper when supplies can be low, and can also be helpful to understand the preferences and actions of the user. Similarly, a refrigerator may have a sensor that detects the proximity of devices, and determines what devices can be in proximity when the door is opened. A user that has committed to going on a diet but still is very keen on opening the refrigerator may receive reminders not to, and be given behavioral rewards in the form of diet points in an application when stopping the behavior. In addition, movement sensors associated with a home alarm system may be configured to communicate with and/or detect a portable user device such as a phone and/or a wearable computer, and to respond differently to users who can be “residents” of the space than those that can be “new” to the space. Thus, a resident may be offered services such as automatic turning on and off of lights based on their location in the space, while a non-resident, who is new to the space, may cause an alarm to be generated and sent to a person who is a resident of the space. This can be a service that may correspond to executable content that users downloads on their devices, including sensors used for home intrusion detection.

Services may be performed by devices that originally were not intended for this purpose, such as the printer and/or refrigerator in the previous examples. The functionality of these devices can be augmented by the acquisition of services in the form of executable content.

This may enable service providers to provide content to computational devices, where such content may be adaptations of the content already provided by others. A script, for example, which is an executable content example, may take as input the output from another script. In various embodiments, scripts may communicate with each other using APIs that are exposed by their originators and/or imposed on them by an organization that facilitates the development of content. Similarly, other types of content may interact with each other, as described in the example of the anime character that reads bedtime stories, by the use of such APIs and/or associated connections enabling different content elements to interact with each other, based on associated policies permitting such interactions. These policies may be associated with the interfaces between the content elements, and be verified when two types of content can be first associated with each other, whether by users and/or by a configuration script.

In various embodiments, multiple content elements, each corresponding to proprietary content, can be combined with each other according to at least one set of associated policies, and governed by at least one user input signal, where the resulting output signal is generated based on at least one stored personalization parameter. Non-proprietary content may also be received and presented. This personalization parameter may be implicitly provided by users (e.g., learned by the system based on user inputs and user actions) and/or explicitly provided by users (e.g., using a customization interface in which the user makes selections, such as a display and/or through voice command).

Example user actions in accordance with a number of embodiments of the invention may be related to a change in location, increased and/or decreased physical activity, the engagement in a long phone call. Example user inputs include an increase of a volume setting, the use of a replay feature, etc. Example proprietary content elements include an anime character that the user has purchased rights to use, an executable program to select audio elements from one or more microphones, a voice profile that can be used to present information to users, an audio book, and/or a movie. Example non-proprietary content may include a broadcast radio show, an emergency notification urging users to leave a building on fire and providing guidance how to get out, and/or an advertisement.

In numerous embodiments, content may be associated with policies that require notification of presentation. Said notification may be made to a representative of content owners, an advertisement platform and/or a consumer ombudsman. Other policies may govern what content may be used in what types of contexts, including what computational environments, in combination with other types of content, and more.

In one example, a person buys an anime character, corresponding to, and/or represented by an NFT. Whereas there may be several similar-looking characters, the purchased character may have a unique appearance. It may also have a unique mannerism, as governed by one or more parameters that can be set in a way that is different, such as incorporating an English accent and/or wearing a cowboy hat, from that of other characters for sale. The mannerism may affect, for example, the manner in which the character moves, speaks, and/or its facial expressions. These parameters, which can be a form of personalization parameters, may be modified in response to experiences of the characters, including the type of content it presents, the inputs provided to the system by users, and more. Thus, the mannerisms may change over time. The anime character may be used to represent the user. Representation may be in social media contexts, as a conveyor of information such as instant messages, and/or as a representative of the user, e.g., in a context such as a ZOOM call in which the user video is replaced with a video of the anime character making movements related to the movements of the user, and wherein the user's voice may be replaced with the voice of the anime character and/or the facial movements of the anime character made consistent with those of the user and/or with the words spoken by the user. Thus, the character can become a representative of the user.

Users may have multiple representative characters, and select which one to use using a configuration interface. Communication interfaces in accordance with many embodiments of the invention may include (but are not limited to) a GUI and/or a voice-command driven user interface. The use of the character(s) may each be governed by one or more policies that determine the contexts in which it may be used, the manner in which it is to be used, and/or the manner in which billing is performed based on its use.

Policies associated with characters may also determine the manner in which its personalization parameters change. For instance, it may determine how much training data is required, and the consistency of the training data that is required in order for change to be made. Policies may also be used to assess what platforms can be used for processing of and/or presentation of the character. In many embodiments, policies can be managed by a DRM engine and/or by the operating system of the processing environment. In numerous embodiments, the policies of one content element may be accessed and evaluated by another content element.

In various embodiments, logs may be created based on the use of one or more types of content. Logs in accordance with certain embodiments of the invention may indicate the manner of use, including combinations of one or more types of content, presentation of content, and/or the manner of presentation. In several embodiments, logs may indicate the extent to which personalization parameters can be modified, and/or may include indications of what modifications can be made. In a variety of embodiments, some or all of the log data may be encrypted so that it is only accessible by one or more select entities, e.g., encrypted using the public key of a billing entity so that only this billing entity can access the log entry. Log data in accordance with numerous embodiments of the invention may be encrypted using more than one public key associated with more than one entity. Logs may be transmitted to a specific entity, such as an entity indicated in the content as being the originator of the content, and/or an entity responsible for receiving billing data and/or advertisement display data. In a variety of embodiments, logs may be recorded on a ledger of a blockchain, and/or otherwise be committed to ascertain that any modifications can be detectable. In several embodiments, Log entries and/or series of such may be authenticated. For instance, they may use a message authentication code generated using a symmetric key associated with the DRM unit associated with the processing entity that processed the associated content.

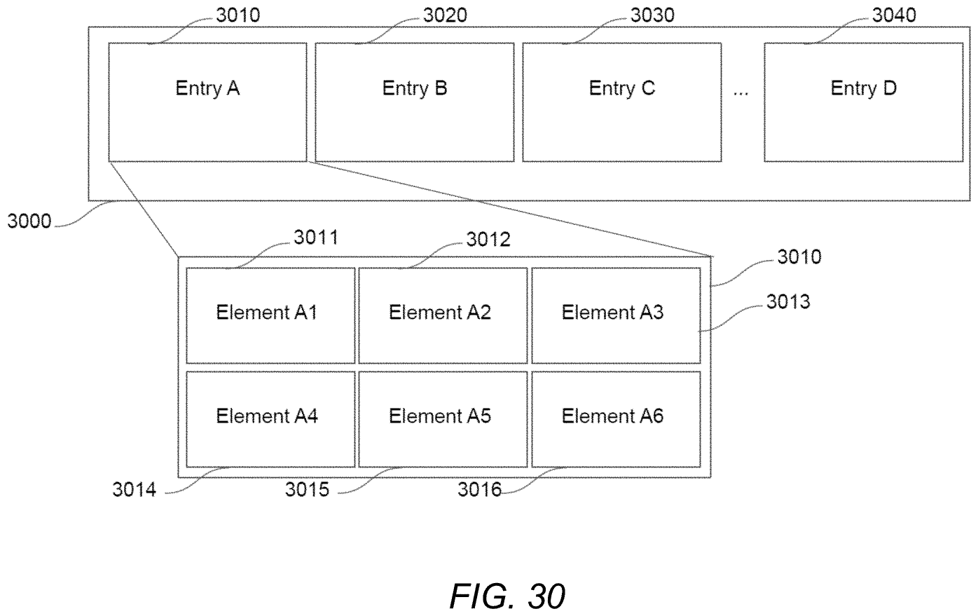

An example of a log associated with the processing of content in accordance with some embodiments of the invention, is illustrated in FIG. 30. Log entries may incorporate a plurality of elements for the facilitation of any modifications. Log 3000 includes log entries 3010, 3020, 3030, and 3040. Log entry 3020, log entry 3030 and log entry 3040 may have a similar structure to log entry 3010. Entry A 3010 may include elementA1 3011, elementA2 3012, elementA31213, elementA4 3014, elementA5 3015 and elementA6 3016. Some and/or all of the elements that can be part of the log entry 3010 may be encrypted. The encryption may be performed using a symmetric key known by processing unit; it may also be performed using a symmetric key known both by processing unit and one or more external entities, such as billing entity. Some elements may be encrypted using one key, whereas others can be encrypted using another key. Some elements may not be encrypted at all. Key distribution in accordance with certain embodiments of the invention may be performed by including symmetric keys, encrypted using public keys of receiving parties in one or more of the elements of log entry 3010.

Element A1 3011 can correspond to an originator indicator indicating what unit generated log entry 3010. The generation of a log entry 3010 may come from, but is not limited to, executable content and/or physical entities. For example, Element A1 3011 may indicate a piece of executable content such as content element, a physical entity such as a processing unit, and/or a routine that is part of an execution environment.

Element A2 3012 can correspond to an event descriptor. Example event descriptors in accordance with some embodiments of the invention may indicate various events, such as (but not limited) content element was requested, policy element was successfully evaluated, users' actions, such as a request to play content element was received, commercial content was integrated with other content, and/or specified sensor data from sensor was received within a certain amount of time of playing the content element.

Element A3 3013 may indicate a modification to a stored state that is associated with the user account and/or the user device. An example of such a state in accordance with many embodiments of the invention may include (but is not limited to) an assignment of personalization parameters. Element A3 3013 may specify what parameter was modified, as well as what the parameter was changed to.

Various other elements may be included in a log entry in accordance with numerous embodiments of the invention. Element A4 3014 can correspond to a time associated with the generation of log entry 3010. Element A5 3015 may include metering data to be reported to the billing entity. Element A6 3016 may be a variable content element that can be used to report unusual conditions. Such conditions may include crash-related data, anomalies, fraud-related data, etc.

In various embodiments, a character, which may be a representation of an anime character and/or a representation of a famous individual, organization, and/or team, may be designed to shadow users in real life through appearances in augmented and/or virtual reality systems, holograms, in conference calls, on personal device displays, on store-shelf displays, in hotel room systems, on dashboards, and in voice-only scenarios such as when driving. The shadowing character may serve as a personal assistant, imaginary pet, a best friend, a real-time interpreter, and/or even a deceased family member. The character may be enabled to interact with other uses and, and/or characters that shadow other users. These interactions may be simultaneously enabled and restricted in usage and customization by the policies set forth by the rightsholder.

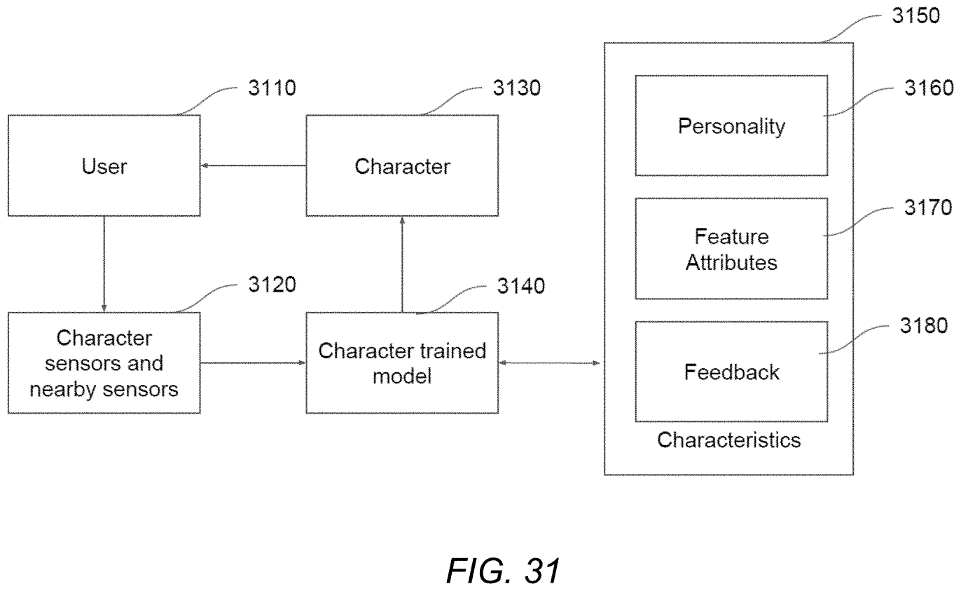

An interaction system between users and an animated character, in accordance with various embodiments of the invention, is depicted in FIG. 31. User 3110 may interact with the character 3130 while character sensors and nearby sensors 3120 capture information useful to the character trained model 3140. Character sensors may include (but are not limited to) sensors on a phone, microphone, accelerometer, etc., which may be associated with the application in which the character can be executed, evaluated, configured, parametrized and/or rendered. Character trained models 3140 may consist of various programmable functions and artificial intelligence to continue to evolve and personalize with user interaction. The system may store information about the character 3130 in a particular characteristics space 3150. Possible characteristics included in the characteristics space 3150 may include but are not limited to details and history regarding character personality 1311, feature attributes 1312, and/or details and history regarding feedback 1313.

One type of content can also be used to promote other types of content. For example, in various embodiments, a first type of content may be an animated character with an associated voice, presenting material to the user. Such material may be user-selected content. For instance, the material may include bedtime stories. In addition to user-selected content, the animated character may present material corresponding to commercial content such as (but not limited to) advertisements, product reviews, recommendations, endorsements, etc. The selection of what commercial content to present, in various embodiments, can be made based on one or more user actions, where example actions may be indicative of preferences and/or needs, such as search queries, selections of movies and/or music to play, and/or GPS locations associated with the user device. Such locations may indicate, along with the time of the presence, that users went to a particular business, and/or were in the company of another user based on co-location data. The data produced can be indicative of potential preferences of the users being related to those of the business and/or coincide with those of the co-located user.

In some embodiments, the character may reflect knowledge about the certain data streams that the user tracks. For example, the user could be an investor in the stock market and own certain stocks such as ACME (a supposed ticker symbol for Acme Water Products Inc.) The character's mood can visually change based on the stock price as it changes throughout the day. Similarly, the character may change its clothes into a rain jacket if it's raining outside and/or wearing sunglasses if it's sunny. The character may also be self-aware of its own NFT value, which can again have an effect on the mood of the virtual entity.

In various embodiments, the physical evolution of a character can change while interacting with users. As an example, a user purchases a BUMBLE BEE character, from the movie TRANSFORMERS. In the movie, the character cannot speak, and only talks by assembling radio words. As the user develops the character and begins to personalize it, the user purchases add-ons that allow the character to gain the ability to speak using the user's voice and/or a purchased sample pack. The character can continue to physically evolve with color schemes, weapon toolkits, and other accessories, so that each user's character has a personalized look and feel.

Applications and methods in accordance with various embodiments of the invention are not limited to use within NFT platforms. Accordingly, it should be appreciated that collaborative content creation mechanisms described herein can also be implemented outside the context of an NFT platform configuration unrelated to the storage of fungible tokens and/or NFTs. Moreover, any of the collaborative content creation mechanisms described herein with reference to FIGS. 16-31 can be utilized within any of configurations discussed above. Various systems and methods for implementing NFT platforms and applications in accordance with numerous embodiments of the invention are discussed further below.

While the above description contains many specific embodiments of the invention, these should not be construed as limitations on the scope of the invention, but rather as an example of one embodiment thereof. Accordingly, the scope of the invention should be determined not by the embodiments illustrated, but by the appended claims and their equivalents.

What is claimed is:

1. A method for facilitating engagement between two or more content creators, the method comprising:
receiving, at a collaboration system, a request from a first content creator, where the request is for second content creators to work on a first piece of content;
processing, at the collaboration system, the request in order to identify a set of one or more potential second content creators suitable for working on the first piece of content;
sending the received request to the set of potential second content creators;
receiving, at the collaboration system, an acceptance of the request from at least one of the set of potential second content creators;
receiving, at the collaboration system, a second piece of content from the at least one second content creator, wherein the second piece of content comprises a result of work that the at least one second content creator has performed on the first piece of content; and
generating a token comprising the second piece of content, wherein the token can be securely attributed to at least one of the first content creator and the second content creator.

2. The method of claim 1, wherein the received request from the first content creator comprises the first piece of content and information pertaining to the work intended to be performed on the first piece of content.

3. The method of claim 1, wherein processing the request comprises filtering potential second content creators based on at least one requirement indicated by the first content creator, selected from the group consisting of skillset, medium of operation, genre, availability, and budget.

4. The method of claim 1, further comprising indicating, to the first content creator, the identified second content creators.

5. The method of claim 4, wherein indicating the identified second content creators comprises providing a rating associated with the identified second content creators, wherein the rating is associated with previously performed work of the identified second content creators.

6. The method of claim 1, wherein indicating the identified second content creators comprises displaying their schedule and terms of collaboration.

7. The method of claim 1, further comprising receiving, from the first content creator, a subset of the set of potential second content creators to be sent the request.

8. The method of claim 7, further comprising, when a sufficient number of second content creators accept the request, no longer sending the received request to the potential second content creators.

9. The method of claim 1, further comprising processing payment and/or closure of the engagement between the first and the second content creator.

10. The method of claim 1, further comprising authenticating a received piece of content by:
performing a normalization of a received piece of content using one or more characterizations of the received piece of content, wherein a characterization comprises mapping one or more portions of the piece of content to one or more descriptors; and
determining digital signatures for the one or more characterizations to identify the creator of the received piece of content.

11. A network node for facilitating engagement between two or more content creators, the network node comprising:
a user interface;
memory; and
a processor, the processor configured to:
receive, from a first content creator, a request for second content creators to work on a first piece of content;
process the request in order to identify potential second content creators suitable for working on the first piece of content;
send the received request to the potential second content creators;
receive, from one or more second content creators of the potential second content creators, an acceptance of the request;
receive, from the second content creator, a second piece of content, wherein the second piece of content comprises a result of the work the one or more second content creators has performed on the first piece of content; and
generate a token comprising the second piece of content, wherein the token can be securely attributed to at least one of the first content creator and the second content creator.

12. The network node of claim 11, wherein the received request from the first content creator comprises the first piece of content and information pertaining to the work intended to be performed on the first piece of content.

13. The network node of claim 11, wherein processing the request comprises filtering potential second content creators based on at least one requirement indicated by the first content creator, selected from the group consisting of skillset, medium of operation, genre, availability, and budget.

14. The network node of claim 11, wherein the processor is further configured to indicate, to the first content creator, the identified second content creators.

15. The network node of claim 14, wherein indicating the identified second content creators comprises providing a rating associated with the identified second content creators, wherein the rating is associated with previously performed work of the identified second content creators.

16. The network node of claim 14, wherein indicating the identified second content creators comprises displaying their schedule and terms of collaboration.

17. The network node of claim 11, further comprising receiving, from the first content creator, a subset of the potential second content creators to be sent the request.

18. The network node of claim 17, wherein the processor is further configured to, when a sufficient number of second content creators accept the request, no longer send the received request to the potential second content creators.

19. The network node of claim 11, wherein the processor is further configured to process payment and/or closure of the engagement between the first and the second content creator.

20. The network node of claim 11, wherein the processor is further configured to authenticate a received piece of content by:
performing a normalization of a received piece of content using one or more characterizations of the received piece of content, wherein a characterization comprises mapping one or more portions of the received piece of content to one or more descriptors; and
determining digital signatures for the one or more characterizations to identify the creator of the received piece of content.
